(19) United States
(12) Patent Application Publication
(10) Pub. No.: US 2014/0036175 A1
(43) Pub. Date: Feb. 6, 2014

(54) OPTICAL FILM FOR 3D IMAGE DISPLAY, 3D IMAGE DISPLAY DEVICE, AND 3D IMAGE DISPLAY SYSTEM

(71) Applicant: FUJIFILM Corporation, Tokyo (JP)

(72) Inventors: Shinichi MORISHIMA, Kanagawa (JP); Makoto ISHIGURO, Kanagawa (JP); Keita TAKAHASHI, Kanagawa (JP); Ryoji GOTO, Kanagawa (JP)

(73) Assignee: FUJIFILM Corporation, Tokyo (JP)

(21) Appl. No.: 14/012,541

(22) Filed: Aug. 28, 2013

Related U.S. Application Data
(63) Continuation of application No. PCT/JP2012/059120, filed on Mar. 28, 2012.

(30) Foreign Application Priority Data
Mar. 29, 2011 (JP) 2011-072007
Sep. 7, 2011 (JP) 2011-194687

(51) Int. Cl. G02B 27/26; G02F 1/13363

(52) U.S. Cl. CPC G02B 27/26; G02F 1/13363
USPC 349/15; 349/96

(57) ABSTRACT

Disclosed is an optical film for 3D image display devices, including at least an optically-anisotropic layer formed of a composition that includes, as the main ingredient thereof, a discotic liquid crystal having at least one polymerizable group, wherein the optically-anisotropic layer is a patterned optically-anisotropic layer which includes a first retardation domain and a second retardation domain differing from each other in at least one of the in-plane slow axis direction and retardation in-plane thereof and in which the first and second retardation domains are alternately arranged in plane.

### CROSS-REFERENCE TO RELATED APPLICATIONS

The present application is a continuation of PCT/JP2012/059120 filed on Mar. 28, 2012 and claims priority under 35 U.S.C. §119 of Japanese Patent Application No. 072007/2011, filed on Mar. 29, 2011, and Japanese Patent Application No. 194687/2011, filed on Sep. 7, 2011, the content of which are herein incorporated by reference in their entirety.

### BACKGROUND OF THE INVENTION

1. Field of the Invention

The present invention relates to an optical film for 3D image display, a 3D image display device and a 3D image display system, having an optically-anisotropic layer with high-definition orientation patterns, easy to produce and improved in display performance free from trouble of brightness reduction and in lightfastness.

2. Description of the Related Art

A 3D image display device of displaying a 3D image requires an optical member that converts a right-eye image and a left-eye image, for example, into circularly-polarized images in the opposite directions. For example, as the optical member, used is a patterned retardation film in which multiple domains differing from each other in slow axis and retardation are regularly arranged in plane.

Heretofore proposed are patterned optical compensation films or the like to be formed by using a liquid-crystal compound (for example, JP-A 2006-276849 and JP-A 2007-71952). These are so-called in-cell type optical compensation films to be arranged inside a liquid-crystal cell, and are members for accurately compensating liquid-crystal cells. Therefore, the orientation state of the liquid-crystal compound to be used is suitable for optical compensation, but not suitable for the above-mentioned optical member in 3D image display devices.

JP-A 2004-302409 discloses a 2D/3D switchable liquid-crystal display device having a patterned retardation plate, and discloses use of a UV-curable liquid-crystal solution as the material for the patterned retardation plate. However, the document does not describe the details of the liquid-crystal material and does not disclose use of a discotic liquid crystal. In addition, in JP-A 2004-302409, the patterned retardation plate is used as a parallax barrier, but is not used as the above-mentioned optical member for forming right-eye and left-eye circularly-polarized images, etc. JP-A 2007-163722 discloses a liquid-crystal display device having an optically-anisotropic layer formed by the use of first and second alignment layers differing in the alignment controlling force. Use of a liquid-crystal polymer material in forming the optically-anisotropic layer is disclosed, however, its details are not described, and use of a discotic liquid crystal is not disclosed. WO2010/090429A2 proposes a production method, in which is used an optical alignment layer of an optical filter for 3D image display devices. In Examples, a rod-shaped liquid crystal is used in carrying out the production method.

### SUMMARY OF THE INVENTION

However, we found that when the patterned retardation plate produced by the use of a liquid-crystal material was actually used in a 3D image display device, the brightness in oblique directions lowers, or that is, the viewing angle characteristics worsen.

An object of the invention is to provide a novel optical film for 3D image display devices that contributes toward improving the viewing angle characteristics of 3D image display devices, and to provide a 3D image display device and a 3D image display device system using the film.

The means for achieving the above-described object are as follows:

<1> An optical film for 3D image display devices, comprising

at least an optically-anisotropic layer formed of a composition that comprises, as the main ingredient thereof, a discotic liquid crystal having at least one polymerizable group, wherein:

the optically-anisotropic layer is a patterned optically-anisotropic layer which comprises a first retardation domain and a second retardation domain differing from each other in at least one of the in-plane slow axis direction and retardation in-plane thereof and in which the first and second retardation domains are alternately arranged in plane.

<2> The optical film according to <1>, wherein the discotic liquid crystal is fixed in a vertically aligned state.
<3> The optical film according to <1> or <2>, further comprising a polarizing film, wherein the in-plane axes of the first and second retardation domains and the absorption axis of the polarizing film are at an angle of ±45° respectively.
<4> The optical film according to any one of <1> to <3>, wherein the total value of retardation in-plane at a wavelength of 550 nm, Re(550), of all of the members including the optically-anisotropic layer disposed on one face of the polarizing film is from 110 to 160 nm.
<5> The optical film according to <3> or <4>, wherein the total value of retardation along the thickness direction at a wavelength of 550 nm, Rth(550), of all of the members including the optically-anisotropic layer disposed on one face of the polarizing film is from −140 to 140 nm.
<6> The optical film according to <3> or <4>, wherein the total value of retardation along the thickness direction Rth(550) at a wavelength of 550 nm of the optically-anisotropic layer and all the members disposed on the surface of the optically-anisotropic layer opposite to the surface on which the polarizing film is disposed is from −104 to 104 nm.
<7>. The optical film according to any one of <1> to <6>, comprising a transparent support containing an UV absorbent on one surface of the optically-anisotropic layer.
<8> The optical film according to any one of <1> to <7>, further comprising a hard coat layer.
<9> The optical film according to <8>, wherein the hard coat layer comprises a UV absorbent.
<10> The optical film according to any one of <1> to <9>, further comprising an antireflection layer.
<11> The optical film according to any one of <1> to <10>, further comprising an antiglare layer.
<12> A 3D image display device comprising at least:

a display panel to be driven on the basis of an image signal, and

an optical film of any one of <1> to <11> disposed on the viewing side of the display panel.

<13> The 3D image display device according to <12>, wherein the display panel comprises a liquid-crystal cell.
<14> The 3D image display device according to <13>, wherein the optical film is an optical film of claim 5, and the liquid-crystal cell is a TN-mode cell.
<15> The 3D image display device according to <13>, wherein the optical film is an optical film of claim 6, and the liquid-crystal cell is a VA-mode or IPS-mode cell.
<16> A 3D image display system comprises at least:

a 3D image display device of any one of <12> to <15>, and

a polarizer disposed on the viewing side of the 3D image display device, which visualizes a 3D image through the polarizer.

According to the invention, it is possible to provide a novel optical film for 3D image display devices that contributes toward improving the viewing angle characteristics of 3D image display devices, and to provide a 3D image display device and a 3D image display device system using the film.

### BRIEF DESCRIPTION OF THE DRAWINGS

FIG. 1 is a schematic cross-sectional view of one example of the optical film for 3D image display devices of the invention.

FIG. 2 is a schematic view of one example of the relationship between a polarizer film and an optically-anisotropic layer.

FIG. 3 is a schematic view of one example of the relationship between a polarizer film and an optically-anisotropic layer.

FIG. 4 is a schematic top view of one example of the patterned optically-anisotropic layer in the invention.

FIG. 5 shows schematic cross-sectional views of other examples of the optical film of the invention.

FIG. 6 shows schematic cross-sectional views of some constitutional examples of the 3D image display device of the invention.

FIG. 7 is a schematic view showing one example of the cross section of a flexographic plate for use for patterning.

FIG. 8 is a schematic view showing one example of a method of flexographic printing.

FIG. 9 is a view showing the optical characteristics evaluation result of the optical film produced in Examples.

FIG. 10 shows schematic views of examples of an exposure mask.

In the drawings, the meanings of the reference numerals are as follows:
10 Retardation Plate
12 Patterned Optically-Anisotropic Layer
12a First Retardation Domain
12b Second Retardation Domain
a In-Plane Slow Axis
b In-Plane Slow Axis
14 Transparent Support
16 Polarizing Film
31 Flexographic Plate
32 Parallel Alignment layer (or Vertical Alignment layer)
33 Vertical Alignment layer Liquid for Patterning (or parallel alignment layer liquid for patterning)
40 Flexographic Printer
41 Impression Cylinder
42 Printing Pressure Roller
43 Anilox Roller
44 Doctor Blade

### BEST MODE FOR CARRYING OUT THE INVENTION

The invention is described in detail hereinunder. In this description, the numerical range expressed by the wording “a number to another number” means the range that falls between the former number indicating the lowermost limit of the range and the latter number indicating the uppermost limit thereof. First described are the terms used in this description.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program. When a film to be analyzed is expressed by a monoaxial or biaxial index ellipsoid, Rth(λ) of the film is calculated as follows. This measuring method may be used for measuring the mean tilt angles at the alignment layer interface and at the opposite interface of discotic liquid crystal molecules in an optically anisotropic layer.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film. In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR. Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (B):

$$Re ( θ ) = [ nx - \frac{ny \times n 2}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} \qquad ( A )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (B)

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR. In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below: cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx-nz)/(nx-ny) is further calculated.

In this description, “visible light” means from 380 nm to 780 nm. Unless otherwise specifically defined in point of the wavelength in measurement in this description, the wavelength in measurement is 550 nm.

In this description, the angle (for example, “90°”, etc.) and the relational expressions thereto (for example, “perpendicular”, “parallel”, “crossing at 45°”, etc.) should be so interpreted as to include the error range generally acceptable in the technical field to which the invention belongs. For example, this means within a range of a strict angle±less than 10°, and the error from the string angle is preferably at most 5°, more preferably at most 3°.

### 1. Optical Film for 3D Image Display Device:

The invention relates to an optical film for 3D image display devices, containing at least an optically-anisotropic layer formed of a composition that comprises, as the main ingredient thereof, a discotic liquid crystal having at least one polymerizable group, wherein:

the optically-anisotropic layer is a patterned optically-anisotropic layer which contains a first retardation domain and a second retardation domain differing from each other in at least one of the in-plane slow axis direction and retardation in-plane thereof and in which the first and second retardation domains are alternately arranged in plane.

The patterned optically-anisotropic layer formed of a liquid-crystal composition is generally used in such a condition that the layer is stacked on a support such as a polymer film or the like to support it and with a protective film or the like to protect it. The polymer film or the like to be used as the support has some retardation, and it may be necessary to adjust Re of the laminate as a whole to a suitable Re range for forming circularly-polarized images, etc. It is difficult to form the optically-anisotropic layer, the polymer film or the like having some Re but having no Rth, and therefore, in general, they have some Rth. The optically-anisotropic layer formed of a liquid-crystal composition and the polymer film to be laminated thereon have some Rth, and Rth of the laminate may often be large as a whole. In actually using the patterned retardation plate formed of an already-existing liquid-crystal composition, the problem of the viewing angle characteristics such as low brightness in oblique directions may occur; and it may be said that one reason for the problem could be that Rth. For example, the rod-shaped liquid crystal used in WO2010/090429A2 is a liquid crystal showing positive birefringence. If an optically-anisotropic layer having Re capable of forming circularly-polarized images is formed of such the rod-like liquid crystal, Rth of the optically-anisotropic layer becomes positive, and Rth of the polymer film to be stacked on the layer may be added thereto, and the total Rth of the whole laminate may be increased, which may result in worsening the viewing angle characteristics such as lowering the brightness in oblique directions. It may be possible to reduce Rth by reducing the number of the members such as the polymer film and others to be stacked; however, the patterned retardation plate is a member to be disposed outside on the viewing side of a display panel, and therefore requires a protective member for protecting the panel from being deteriorated through exposure to outside light and also an antireflection member or the like for preventing outside light from reflecting on the panel, and in fact, it is inevitable to stack one or more polymer films on the plate.

According to the invention, it is possible to solve the above-described problem by using a discotic liquid crystal for forming the patterned optically-anisotropic layer. The discotic liquid crystal is a liquid crystal having negative birefringence, and by using the discotic liquid crystal, it is possible to prepare an optically-anisotropic layer with negative Rth and Re capable of forming circularly-polarized images, etc. Rth of the optically-anisotropic layer formed of such a discotic liquid-crystal composition can counterbalance the positive Rth of the member such as the polymer film or the like to be stacked thereon, and as a result, Rth of the whole laminate may be reduced to such a degree that it could not have any influence on the viewing angle characteristics.

The optical film for 3D image display devices of the invention is disposed outside on the viewing side of a display panel along with a polarizing film (in case where the display panel has a polarizing film on the viewing side, the optical film is disposed further outside the polarizing film on the viewing side of the display panel), and the polarized image having passed through the first and second retardation domains of the optical film is visualized as a right-eye or left-eye image via polarized glasses. Accordingly, it is desirable that the first and second retardation domains both have the same shape so that the right and left images could not be unequal, and it is also desirable that their configurations are equal and symmetric.

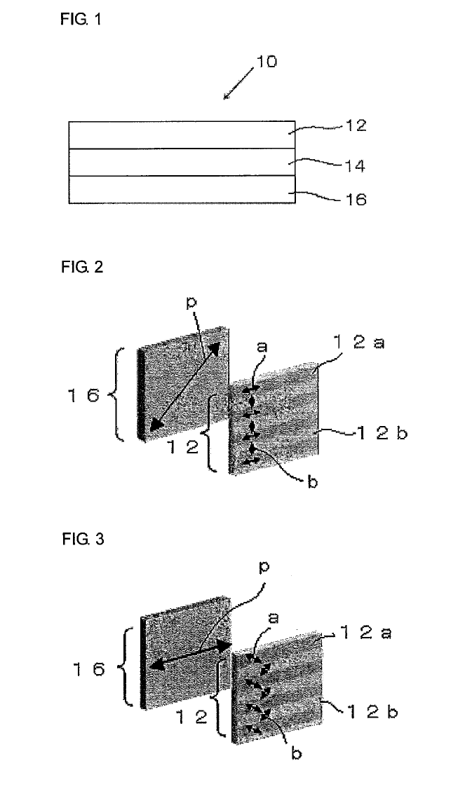

FIG. 1 shows a schematic cross-sectional view of one example of the optical film for 3D image display devices of the invention. The optical film 10 shown in FIG. 1 comprises a polarizing film 16, a transparent support 14 and an optically-anisotropic layer 12, and the optically-anisotropic layer 12 is a patterned optically-anisotropic layer of which the first and second retardation domains 12a and 12b are equally and symmetrically arranged in an image display device. In one example of the optically-anisotropic layer, retardation in-plane of the first and second retardation domains 12a and 12b is around λ/4 each, and the two domains have in-plane slow axes a and b, respectively, perpendicular to each other. In this example, the optically-anisotropic layer 12 is disposed so that the in-plane slow axes a and b of the first and second retardation domains 12a and 12b intersect with the absorption axis P of the polarizing film 16 at ±45°, as shown in FIG. 2 and FIG. 3. The configuration makes it possible to separate right-eye and left-eye circularly-polarized images from each other. Further stacking a λ/2 plate may widen the viewing angle.

Using an optically-anisotropic layer where retardation in-plane of one of the first and second retardation domains 12a and 12b is λ/4 and retardation in-plane of the other is 3λ/4 also makes it possible to separate those circularly-polarized images from each other. Further, right-eye and left-eye linearly-polarized images may be separated from each other by using an optically-anisotropic layer where retardation in-plane of one of the first and second retardation domains 12a and 12b is λ/4 and retardation in-plane of the other is 3λ/4.

Using an optically-anisotropic layer where retardation in-plane of one of the first and second retardation domains 12a and 12b is λ/2 and retardation in-plane of the other is 0 followed by stacking it on a support of which retardation in-plane is λ/4, in a manner so that their slow axes are parallel to or perpendicular to each other also makes it possible to separate circularly-polarized images from each other.

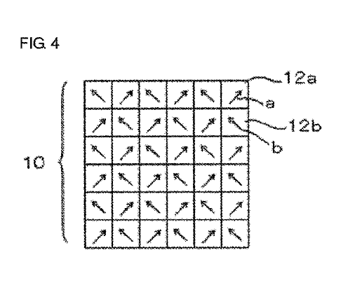

The shape and the configuration pattern of the first and second retardation domains 12a and 12b are not limited to the embodiments shown in FIG. 2 and FIG. 3 where stripe-like patterns are alternately arranged. As in FIG. 4, rectangular patterns may be arranged like a lattice.

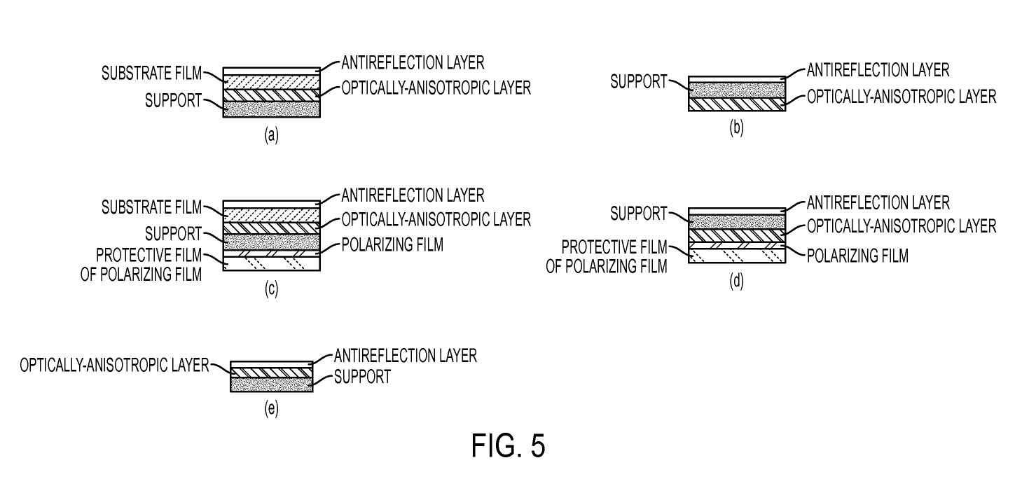

The optical film may contain any other member. In the example shown in FIG. 1, an alignment layer may be disposed between the transparent support 14 and the optically-anisotropic layer 12, and a surface film containing an antireflection layer may be disposed further outside the optically-anisotropic layer 12. A protective film for the polarizing film 16 may be disposed between the transparent support 14 and the polarizing film 16. On the back of the polarizing film 16, a protective film may be further disposed. As described above, in case where the display panel has a polarizing film on the surface thereof on the viewing side, the optical film of the invention may not have a polarizing film, and may be in such an embodiment where the optical film is combined with the polarizing film of the display panel to thereby exhibit the function of separating circularly-polarized images, etc. The details of these members usable here are described hereinunder. FIGS. 5(a) to (e) show schematic cross-sectional views of other examples of the optical film of the invention.

The optically-anisotropic layer 12 is formed of a composition comprising, as the main ingredient thereof, a discotic liquid crystal having at least one polymerizable group, and preferably, the discotic liquid crystal is aligned vertically. In this description, “vertical alignment” means that the discotic plane of the discotic liquid crystal is vertical to the layer plane. The configuration does not require a strict vertical state, and in this description, the vertical alignment means that the tilt angle to the horizontal plane is at least 70 degrees. The tilt angle is preferably from 85 to 90 degrees, more preferably from 87 to 90 degrees, even more preferably from 88 to 90 degrees, most preferably from 89 to 90 degrees. The above-mentioned composition may contain an alignment-controlling agent for controlling the alignment of discotic liquid crystal. The details of the discotic liquid crystal and the alignment-controlling agent are described hereinunder.

In an embodiment where retardation in-plane of the first and second retardation domains 12a and 12b is around λ/4 each, preferably, the in-plane slow axes a and b are at an angle of ±45° to the absorption axis of the polarizing film. In this description, the configuration does not require a state of strictly ±45°, but preferably, any one of the first and second retardation domains 12a and 12b is at from 40 to 50° and the other is preferably at from −50 to −40°.

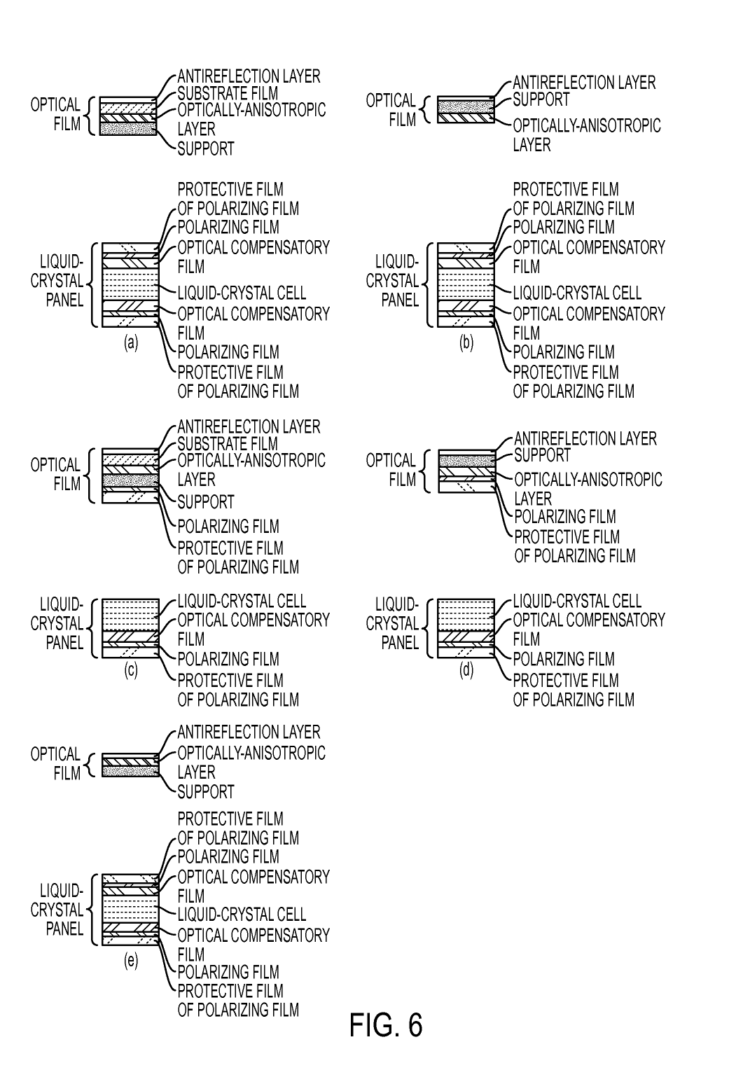

It is unnecessary that Re of the optically-anisotropic layer 12 is λ/4 by itself, but preferably, the sum total of Re of all the members including the optically-anisotropic layer 12 disposed on one surface of the polarizing film 16, for example, in the embodiment of FIG. 6(a), the sum total of Re of all the polarizer protective film, the support, the optically-anisotropic layer and the substrate film, in the embodiment of FIG. 6(b), the sum total of Re of all the polarizer protective film, the optically-anisotropic layer and the support, in the embodiment of FIG. 6(c), the sum total of Re of all the support, the optically-anisotropic layer and the substrate film, in the embodiment of FIG. 6(d), the sum total of Re of the optically-anisotropic layer and the support, and in the embodiment of FIG. 6(e), the sum total of Re of the polarizer protective film, the support and the optically-anisotropic layer, is from 110 nm to 160 nm, more preferably from 120 nm to 150 nm, even more preferably from 125 nm to 145 nm. It is to be noted that the term “the sum total of Re” means Re obtained by measuring Re of all of the target members as a whole at the same time.

On the other hand, when the optical film is arranged on a display panel, Rth of the member disposed outside on the viewing side than the polarizing film has some influence on the viewing angle characteristics of the panel, and therefore, the absolute value of Rth is preferably smaller; and concretely, Rth is preferably from −140 nm to 140 nm, more preferably from −100 nm to 100 nm, even more preferably from −60 nm to 60 nm, especially preferably from −60 nm to 20 nm. One possible example is the optical film wherein Rth thereof is from −140 nm to 140 nm provided that the range of from −100 nm to 100 nm is excluded. Other possible example is the optical film wherein Rth thereof is from −140 nm to 140 nm provided that the range of from −20 nm to 20 nm is excluded. Other possible example is the optical film wherein Rth thereof is from −100 nm to 100 nm provided that the range of from −20 nm to 20 nm is excluded. However, as a result of assiduous studies made by the present inventors, it was found that, even when the same members were disposed to have the same level of Rth, the degree of influence thereof on the viewing angle characteristics varied depending on the absorption axis direction of the polarizing film. Concretely, it was found that, in the embodiment shown in FIG. 2 (the embodiment wherein the absorption axis of the polarizing film was along the 45°- or 135°-direction with respect to the horizontal direction of the display panel face, 0°), Rth of all of the members, which were disposed outside on the viewing side than the polarizing film, affected the viewing angle characteristics of the panel; and on the other hand, in the embodiment shown in FIG. 3 (or the embodiment wherein the absorption axis of the polarizing film was along the 0°- or 90°-direction with respect to the horizontal direction of the display panel, 0°), Rth of the member(s), which was disposed between the polarizing film and the optically-anisotropic layer, hardly affected but Rth of all of the members including, the optically-anisotropic layer and any member(s) which was disposed further outside of the layer on the viewing side, affected the viewing angle characteristics.

Examples of the embodiments of FIGS. 6(a) to (e) are described with reference to the configuration of FIG. 2. In the embodiment of FIG. 6(a), the sum total of Rth of all the polarizer protective film, the support, the optically-anisotropic layer and the substrate film, in the embodiment of FIG. 6(b), the sum total of Rth of all the polarizer protective film, the optically-anisotropic layer and the support, in the embodiment of FIG. 6(c), the sum total of Rth of all the support, the optically-anisotropic layer and the substrate film, in the embodiment of FIG. 6(d), the sum total of Rth of the optically-anisotropic layer and the support, and in the embodiment of FIG. 6(e), the sum total of Rth of the polarizer protective film, the support and the optically-anisotropic layer is preferably from −104 nm to 104 nm, more preferably from −100 nm to 100 nm, even more preferably from −60 nm to 60 nm, or especially preferably from −60 nm to 20 nm (one possible example is the optical film wherein the sum total of Rth is from −104 nm to 104 nm provided that the range of from −100 nm to 100 nm is excluded; other possible example is the optical film wherein the sum total of Rth is from −104 nm to 104 nm provided that the range of from −20 nm to 20 nm is excluded; and other possible example is the optical film wherein the sum total of Rth is from −100 nm to 100 nm provided that the range of from −20 nm to 20 nm is excluded); and with reference to the configuration of FIG. 3, in the embodiments of FIGS. 6(a) and (c), the sum total of Rth of all the optically-anisotropic layer and the substrate film, in the embodiments of FIGS. 6(b) and (d), the sum total of Rth of the optically-anisotropic layer and the support, and in the embodiment of FIG. 6(e), Rth of the optically-anisotropic layer is preferably from −104 nm to 104 nm, more preferably from −100 nm to 100 nm, even more preferably from −60 nm to 60 nm, or especially preferably from −60 nm to 20 nm (one possible example is the optical film wherein the sum total of Rth is from −104 nm to 104 nm provided that the range of from −100 nm to 100 nm is excluded; other possible example is the optical film wherein the sum total of Rth is from −104 nm to 104 nm provided that the range of from −20 nm to 20 nm is excluded; and other possible example is the optical film wherein the sum total of Rth is from −100 nm to 100 nm provided that the range of from −20 nm to 20 nm is excluded). It is to be noted that the term “the sum total of Rth” means Rth obtained by measuring Re of all of the target members as a whole at the same time.

### 2. 3D Image Display Device and 3D Image Display System:

The invention also relates to a 3D image display device and a 3D image display system having the optical film of the invention. The optical film of the invention is disposed on the viewing side of a display panel, and may have the function of converting the image that the display panel displays into polarized images such as right-eye and left-eye circularly-polarized images or linearly-polarized images, etc. The viewers view these images via polarizer such as circularly-polarized or linearly-polarized glasses or the like to recognize them as a 3D image.

In the invention, no limitation is given to the display panel. For example, the display panel may be a liquid-crystal display panel containing a liquid-crystal layer, or an organic EL display panel containing an organic EL layer, or a plasma display panel. In any embodiment, various possible configurations may be employed. In an embodiment of a transmission-mode liquid-crystal panel or the like that has a polarizing film for image display on the surface thereof on the viewing side, the optical film of the invention may be combined with the polarizing film to attain the above-mentioned function. Needless-to-say, the optical film of the invention may have a polarizing film separately from the liquid-crystal panel, but in such a case, the optical film is preferably disposed so that the absorption axis of the polarizing film of the polarizer contained in the optical film former is parallel to the absorption axis of the polarizing film of the liquid-crystal panel.

FIGS. 6(a) to (e) show schematic cross-sectional views of configuration examples of 3D image display devices having the optical film of the invention shown in FIGS. 5(a) to (e), respectively, and a liquid-crystal panel as the display panel; however, the invention is not limited to these configurations. In the drawings, the relative relationship of the thickness between the layers does not always correspond to the relative relationship of the thickness between the layers of actual liquid-crystal display devices. The embodiments of FIGS. 6(a) to (e) are transmission-mode configurations, in which a backlight is disposed on the rear side of the liquid-crystal cell and a polarizing film is disposed between the backlight and the liquid-crystal cell.

The configuration of the liquid-crystal cell is not specifically defined. Here, any liquid-crystal cell having an ordinary configuration may be employed. For example, the liquid-crystal cell contains a pair of substrates placed opposite to each other but not shown, and a liquid-crystal cell sandwiched between the pair of substrates, and may optionally contain a color filter layer, etc. The driving mode of the liquid-crystal cell is not also specifically defined, and various modes are employable here, including twisted nematic (TN), super-twisted nematic (STN), vertical alignment (VA), in-plane switching (IPS), optically compensated bend cell (OCB) and the like modes. In the TN mode, in general, the polarizing film is disposed so that the absorption axis thereof is at 45° or 135° relative to the horizontal direction, 0° on the panel surface, and therefore preferably, the TN-mode liquid-crystal panel is combined with the optical film of the embodiment shown in FIG. 2. In the VA-mode and IPS-mode, in general, the polarizing film is disposed so that the absorption axis thereof is at 0° or 90° relative to the horizontal direction 0° on the panel surface, and therefore preferably, the VA-mode or IPS-mode liquid-crystal panel is combined with the optical film of the embodiment shown in FIG. 3.

Various members used in the optical film for 3D image display devices of the invention are described in detail hereinunder.

### Optically-Anisotropic Layer:

The optically-anisotropic layer in the invention is a patterned optically-anisotropic layer which contains a first retardation domain and a second retardation domain differing from each other in at least one of the in-plane slow axis direction and retardation in-plane thereof and in which the first and second retardation domains are alternately arranged in plane. One example is an optically-anisotropic layer in which the first and second retardation domains each have Re of around λ/4, and the in-plane slow axes of those domains are perpendicular to each other. Various methods may be employable for forming the optically-anisotropic layer of the type. In the invention, preferably, the layer is formed by polymerizing and fixing a discotic liquid crystal having at least one polymerizable group in a vertically-aligned state. The optically-anisotropic layer may be a single layer or may have a lamination of plural layers. According to the embodiment having the lamination of plural layers, if at least one of the plural layers is formed by fixing the alignment of the composition containing the discotic liquid crystal compound, the effect of the invention may be obtained. One example of the optically-anisotropic layer, having a lamination of plural layers, is a lamination comprising a patterned optically-anisotropic layer and an un-patterned optically-anisotropic layer. According to the example thereof, the optically anisotropic layer formed of the composition containing the discotic liquid crystal compound may be the patterned optically-anisotropic layer or the un-patterned optically-anisotropic layer, or may be both of the patterned and un-patterned optically-anisotropic layers. The example may comprise other optically-anisotropic layer(s) along with the optically-anisotropic layer formed of the composition containing the discotic liquid crystal compound. Examples of the other optically-anisotropic layer(s) include any optically-anisotropic layers formed of a composition containing a rod-like liquid crystal compound, and any birefringent films formed of a high-molecular weight compounds such as polymers and resins. According to the example, any one of the first and second retardation domains may have Re (e.g., Re=λ/2) which is made by the addition of Re of all the plural layers, and another thereof may have Re (e.g., Re=0) which is made by the subtraction of Re of all the plural layers.

The optically-anisotropic layer may have Re of around λ/4 by itself, and in such a case, Re(550) of the layer is preferably from 110 to 165 nm, more preferably from 120 to 150 nm, even more preferably from 125 to 145 nm. Preferably, Rth(550) of the optically-anisotropic layer is negative, more preferably falling from −80 to −50 nm, even more preferably from −75 to −60 nm. When Rth(550) of the optically-anisotropic layer is negative, then it can counterbalance the positive Rth of the other members, thereby preventing the reduction in brightness in oblique directions.

[Discotic Liquid Crystal Compound Having at Least One Polymerizable Group]

The discotic liquid crystal which can be used in the present invention as a main ingredient of the optically anisotropic layer is preferably selected from the discotic liquid crystal compounds having a polymerizable group as describe above.

The discotic liquid crystal is preferably selected from the compounds represented by formula (I).

D(-L-H-Q)ₙ (I)

In the formula, D represents a disc-like core; L represents a divalent linking group; H represents a divalent aromatic ring or a heterocyclic ring; Q is a group containing a polymerizable group; and n is an integer of from 3 to 12.

The disc-like core (D) is preferably a benzene ring, naphthalene ring, triphenylene ring, anthraquinone ring, truxene ring, pyridine ring, pyrimidine ring, or triazine ring, or especially preferably a benzene ring, triphenylene ring, pyridine ring, pyrimidine ring or triazine ring.

L is preferably selected from the divalent liking group consisting of *—O—CO—, *—CO—O—, *—CH═CH—, *—C═C— and any combinations thereof, or is especially preferably a divalent linking group containing at least one of *—CH═CH— and *—C≡C—. The symbol of “*” is a site bonding to D of the formula (I).

The aromatic ring represented by H is preferably a benzene ring or a naphthalene ring, or is more preferably a benzene ring. The heterocyclic ring represented by H is preferably a pyridine ring or pyrimidine ring, or is more preferably a pyridine ring. Preferably, H is an aromatic ring.

The polymerization of the polymerizable group in the group Q is an addition polymerization (including ring-opening polymerization) or a condensation polymerization. In other words, the polymerizable group is preferably a functional group capable of addition polymerization or condensation polymerization. Among them, a (meth)acrylate or epoxy group is preferable.

The discotic liquid crystal represented by the formula (I) is preferably selected from the formula (II) or (III).

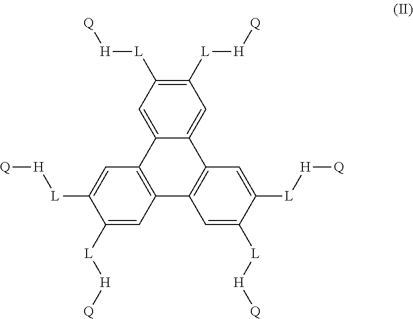

In the formula, the definitions of L, H and Q are same as those of L, H and Q in the formula (I) respectively; and the preferable examples thereof are same as those of L, H and Q in the formula (I) respectively.

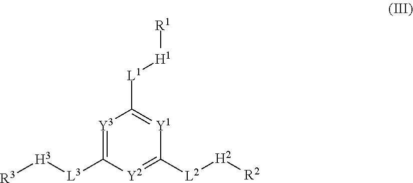

In the formula, the definitions of Y¹, Y² and Y³ are same as those of Y¹¹, Y¹² and Y¹³ in the formula (IV) described later respectively, and the preferable examples thereof are same as those of Y¹¹, Y¹² and Y¹³ in the formula (IV) respectively. Or the definitions of L¹, L², L³, H¹, H², H³, R¹, R² and R³ are same as those of L¹, L², L³, H¹, H², H³, R¹, R² and R³ in the formula (IV) described later respectively, and the preferable examples thereof are same as those of L¹, L², L³, H¹, H², H³, R¹, R² and R³ in the formula (IV) described later respectively.

As described later, the discotic liquid crystal having plural aromatic rings such as the compounds represented by formula (I), (II) or (III) may interact with the onium salt such as pyridium or imidazolium compound to be used as an alignment controlling agent by the π-π molecular interaction, thereby to achieve the vertical alignment. Especially, for example, the compound represented by the formula (II) in which L represents a divalent linking group containing at least one selected from *—CH═CH— and *—C≡C—, or the compound represented by formula (III) in which plural aromatic rings or heterocyclic rings are connected via a single bond to each other may keep the linearity of the molecule thereof since the free rotation of the bonding may be restricted strongly by the linking group. Therefore, the liquid crystallinity of the compound may be improved and the compound may achieve the more stable vertical alignment by the stronger intermolecular π-π interaction.

The discotic liquid crystal is preferably selected from the compounds represented by formula (IV)

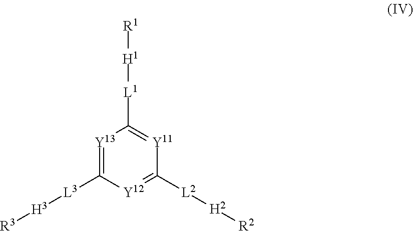

In the formula, Y¹¹, Y¹² and Y¹³ each independently represent a methine group or a nitrogen atom; L¹, L² and L³ each independently represent a single bond or a bivalent linking group; H¹, H² and H³ each independently represent the following formula (IV-A) or (IV-B); R¹, R² and R³ each independently represent the following formula (IV-R);

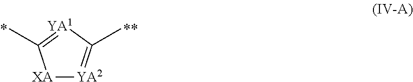

in formula (IV-A), YA¹ and YA² each independently represent a methine group or a nitrogen atom; XA represents an oxygen atom, a sulfur atom, a methylene group or an imino group; * indicates the position at which the formula bonds to any of L¹ to L³; and ** indicates the position at which the formula bonds to any of R¹ to R³;

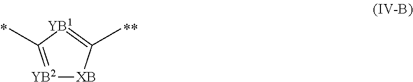

in formula (IV-B), YB¹ and YB² each independently represent a methine group or a nitrogen atom; XB represents an oxygen atom, a sulfur atom, a methylene group or an imino group; * indicates the position at which the formula bonds to any of L¹ to L³; and ** indicates the position at which the formula bonds to any of R¹ to R³;

*-(-L²¹-Q²)ₙ₁-L²²-L²³-Q¹ (IV-R)

in formula (IV-R), * indicates the position at which the formula bonds to H¹, H² or H³ in formula (IV); L²¹ represents a single bond or a bivalent linking group; Q² represents a bivalent cyclic linking group having at least one cyclic structure; n1 indicates an integer of from 0 to 4; L²² represents **—O—, **—O—CO—, **—CO—O—, **—O—CO—O—, **—S—, **—NH—, **—SO₂—, **—CH₂—, **—CH═CH— or **—C≡C—; L²³ represents a bivalent linking group selected from —O—, —S—, —C(═O)—, —SO₂—, —NH—, —CH₂—, —CH═CH— and —C≡C—, and a group formed by linking two or more of these; and Q¹ represents a polymerizable group or a hydrogen atom.

Preferable ranges of the symbols in formula (IV) and Examples of the three-substituted benzene base discotic liquid crystal compound represented by formula (IV) are described in JP-A-2010-244038, [0013]-[0077, and the same may be applied to the invention. However, the discotic liquid crystal compound to be used in the invention is not limited to the compound represented by formula (IV).

Examples of the triphenylene compound which can be used in the invention include, but are not limited to, those described in JP-A-2007-108732, [0062]-[0067].

The discotic liquid crystal represented by formula (IV) having plural aromatic rings may interact with the pyridinium or imidazolium compound described later via the intermolecular π-π interaction, which may increase the tilt angle of the discotic liquid crystal in the area neighboring to the alignment layer. Especially, the discotic liquid crystal represented by formula (IV) in which plural aromatic rings or heterocyclic rings are connected via a single bond to each other may keep the linearity of the molecule thereof since the free rotation of the bonding may be restricted strongly by the linking group. Therefore, the discotic liquid crystal represented by formula (IV) having plural aromatic rings may interact with the pyridinium or imidazolium compound via the stronger intermolecular π-π interaction, which may increase the tilt angle of the discotic liquid crystal more remarkably in the area neighboring to the alignment layer to achieve the vertical alignment.

According to the invention, it is preferable that the discotic liquid crystal is aligned vertically. It is to be understood that the term “vertical alignment” in the specification means that the discotic plane of the discotic liquid crystal is vertical to the layer plane, wherein strict verticalness is not always necessary; and means, in this specification, that a tilt angle of liquid crystalline molecules with respect to the horizontal plane is equal to or larger than 70°. The tilt angle is preferably from 85 to 90°, more preferably from 87 to 90°, even more preferably from 88 to 90°, or most preferably from 89 to 90°.

The composition preferably contains any additive(s) capable of promoting the vertical alignment, and examples of the additive include those described in JP-A-2009-223001, [0055]-[0063].

It is difficult to accurately and directly measure θ1, which is a tilt angle at a surface of an optically-anisotropic film (an angle between the physical symmetric axis of a discotic or rod-like liquid-crystal molecule in the optically-anisotropic film and an interface of the layer), and θ2, which is a tilt angle at another surface of the optically-anisotropic film. Therefore, in this description, θ1 and θ2 are calculated as follows: This method could not accurately express the actual alignment state, but may be helpful as a means for indicating the relative relationship of some optical characteristics of an optical film.

In this method, the following two points are assumed for facilitating the calculation, and the tilt angles at two interfaces of an optically-anisotropic film are determined.

1. It is assumed that an optically-anisotropic film is a multi-layered structure that comprises a layer containing discotic or rod-like compound(s). It is further assumed that the minimum unit layer constituting the structure (on the assumption that the tilt angle of the liquid crystal compound molecule is uniform inside the layer) is an optically-monoaxial layer.

2. It is assumed that the tilt angle in each layer varies monotonously as a linear function in the direction of the thickness of an optically-anisotropic layer.

A concrete method for calculation is as follows:

(1) In a plane in which the tilt angle in each layer monotonously varies as a linear function in the direction of the thickness of an optically-anisotropic film, the incident angle of light to be applied to the optically-anisotropic film is varied, and the retardation is measured at three or more angles. For simplifying the measurement and the calculation, it is desirable that the retardation is measured at three angles of -40°, 0° and +40° relative to the normal direction to the optically-anisotropic film of being at an angle of 0°. For the measurement, for example, used are KOBRA-21ADH and KOBRA-WR (by Oji Scientific Instruments), and transmission ellipsometers AEP-100 (by Shimadzu), M150 and M520 (by Nippon Bunko) and ABR10A (by Uniopto).

(2) In the above model, the refractive index of each layer for normal light is represented by n0; the refractive index thereof for abnormal light is by ne (ne is the same in all layers as well as n0); and the overall thickness of the multi-layer structure is represented by d. On the assumption that the tilting direction in each layer and the monoaxial optical axis direction of the layer are the same, the tilt angle θ1 in one face of the optically-anisotropic layer and the tilt angle θ2 in the other face thereof are fitted as variables in order that the calculated data of the angle dependence of the retardation of the optically-anisotropic layer could be the same as the found data thereof, and θ1 and θ2 are thus calculated.

In this, n0 and ne may be those known in literature and catalogues. When they are unknown, they may be measured with an Abbe's refractiometer. The thickness of the optically-anisotropic film may be measured with an optical interference thickness gauge or on a photograph showing the cross section of the layer taken by a scanning electronic microscope.

[Onium Salt Compound (Agent for Controlling Alignment at Alignment Layer)]

According to the present invention, any onium salt compound is preferably added for achieving the vertical alignment of the liquid crystal compound having the polymerizable group, or especially, the discotic liquid crystal having the polymerizable group. The onium salt may localize at the alignment layer interface, and may function to increase the tilt angles of the liquid crystal molecules in the area neighboring to the alignment layer

As the onium salt compound, the compound represented by formula (1) is preferable.

Z—(Y-L-)ₙCy⁺.X⁻ Formula (1)

In the formula, Cy represents a 5-membered or 6-membered cyclic onium group; the definitions of L, Y, Z and X are same as those of L²³, L²⁴, Y²², Y²³, Z²¹ and X in formula (2a) or (2b) described later, and these preferable examples are same as those of them in formula (2a) or (2b); and n represents an integer of equal to or more than 2.

The 5-membered or 6-membered onium group (Cy) is preferably pyrazolium ring, imidazolium ring, triazolium ring, tetrazolium ring, pyridium ring, pyrimidinium ring or triazinium ring, or more preferably imidazolium ring or pyridinium ring.

The 5- or 6-membered onium group (Cy) preferably has a group affinity with the material of the alignment layer. Preferably, the onium salt compound exhibits the high affinity with the material of the alignment layer at a temperature of T₁ degrees Celsius, and the onium salt compound exhibits the low affinity with the material of the alignment layer at a temperature of T₂ degrees Celsius. The hydrogen bonding can become both of the bonding state and the non-bonding state within the temperature range (room temperature to 150 degrees Celsius) within which the liquid crystal may be aligned, and therefore, the affinity due to the hydrogen bonding is preferably used. However, the invention is not limited to the embodiment using the affinity due to the hydrogen bonding.

For example, according to the embodiment employing the polyvinyl alcohol as a material of the alignment layer, the onium salt preferably has the group which is capable of forming the hydrogen bonding to form the hydrogen bonding with a hydroxy group of the polyvinyl alcohol. The theoretical interpretation of the hydrogen bonding is reported, for example, in Journal of American Chemical Society, vol. 99, pp. 1316-1332, 1977, H. Uneyama and K. Morokuma. The concrete modes of the hydrogen bonding are exemplified in FIG. 17 on page 98 described in “Intermolecular and Surface Forces (Bunshikanryoku to Hyoumenn Chohryoku)” written by Jacob Nissim Israelachvili, translated in Japanese by Tamotsu Kondoh and Hiroyuki Ohshima, and published by McGraw-Hill Company in 1991. Examples of the hydrogen bonding include those described in Angewante Chemistry International Edition English, col. 34, 00.2311, 1955, G. R. Desiraju.

The 5-membered or 6-membered cyclic onium group having a hydrogen bonding group may increase the localization at the alignment layer interface and promote the orthogonal alignment with respect to the main chain of the polyvinyl alcohol by the hydrogen bonding with the polyvinyl alcohol along with the affinity effect of the onium group. Preferable examples of the hydrogen bonding group include an amino group, carbamide group, sulfonamide group, acid amide group, ureido group, carbamoyl group, carboxyl group, sulfo group, nitrogen-containing heterocyclic group (such as imidazolyl group, benzimidazolyl group pyrazolyl group, pyridyl group, 1,3,5-triazyl group, pyrimidyl group, pyridazyl group, quinonyl group, benzoimidazolyl group, benzothiazolyl, succinimide group, phthalimide group, maleimide group, uracil group, thiouracil group, barbituric acid group, hydantoin group, maleic hydrazide group, isatin group, and uramil group). More preferable examples of the hydrogen bonding include an amino group and pyridyl group.

For example, as well as an imidazolium ring in which a nitrogen atom having a group capable of forming the hydrogen bonding is embedded, the 5-membered or 6-membered onium ring in which any atom(s) having a group capable of forming the hydrogen bonding is embedded is also preferable

In the formula, n is preferably an integer of from 2 to 5, more preferably 3 or 4, or most preferably 3. Plural L and Y may be same or different from each other respectively. The onium salt represented by formula (1) in which n is not smaller than 3 has 3 or more numbers of the 5-membered or 6-membered rings, may interact with the discotic liquid crystal by the intermolecular π-π interaction, and, especially on the polyvinyl-alcohol alignment layer, can achieve the orthogonal-vertical alignment with respect to the polyvinyl-alcohol main chain.

The onium salt represented by formula (1) is preferably selected from the pyridinium compounds represented by formula (2a) or the imidazolium compounds represented by formula (2b).

The compound represented by formula (2a) or (2b) may mainly be added to the discotic liquid crystal represented by any one of the formulas (I)-(IV) for controlling the alignment of the liquid crystal compound at the alignment layer interface, and may have a function of increasing the tilt angles of the discotic liquid crystal molecules in the area neighboring to the alignment layer interface.

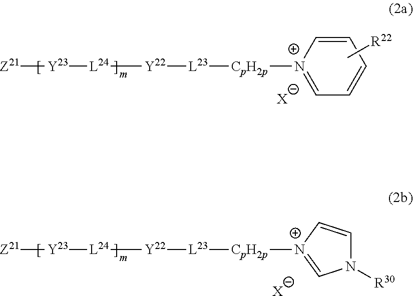

In the formula, L²³ and L²⁴ represent a divalent linking group respectively.

L²³ is preferably a single bond, —O—, —O—CO—, —CO—O—, —C≡C—, —CH═CH—, —CH═N—, —N═CH—, —N═N—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO— or —O—CO-AL-CO—O—, and AL is a C₁₋₁₀ alkylene group. L²³ is more preferably a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO— or —O—CO-AL-CO—O—, even more preferably a single bond or —O—, or most preferably —O—.

L²⁴ is preferably a single bond, —O—, —O—CO—, —CO—O—, —C≡C—, —CH═CH—, —CH═N—, —N═CH— or —N═N—, or more preferably —O—CO— or —CO—O—. If n is equal to or larger than 2, a plurality of L²⁴ preferably represents —O—CO-or —CO—O— alternately.

R²² represents a hydrogen atom, unsubstituted amino group or substituted C₁₋₂₀ amino group.

If R²² is a dialkyl-substituted amino group, the two alkyls may connect to each other to form a nitrogen-containing heterocyclic ring. The nitrogen-containing heterocyclic ring is preferably a 5-membered or 6-membered ring. R²² preferably represents a hydrogen atom, non-substituted amino group or C₂₋₁₂ dialkyl substituted amino group, or even more preferably, a hydrogen atom, non-substituted amino group or C₂₋₈ dialkyl substituted amino group. If R²² is a non-substituted or substituted amino group, the 4-position of the pyridinium is preferably substituted.

X represents an anion.

X preferably represents a monovalent anion. Examples of the anion include halide ion (such as fluorine ion, chlorine ion, bromine ion and iodide ion) and sulfonic acid ions (such as methane sulfonate ion, p-toluene sulfonate ion and benzene sulfonate ion).

Y²² and Y²³ represent a divalent linking group having a 5-membered or 6-membered ring as a part structure respectively.

The 5-membered or 6-membered ring may have at least one substituent. Preferably, at least one of Y²² and Y²³ is a divalent linking group having a 5-membered or 6-membered ring with at least one substituent as a part structure. Preferably, Y²² and Y²³ each independently represent a divalent linking group having a 6-membered ring, which may have at least one substituent, as a part structure. The 6-membered ring includes an alicyclic ring, aromatic ring (benzene ring) and heterocyclic ring. Examples of the 6-membered alicyclic ring include a cyclohexane ring, cyclohexane ring and cyclohexadiene ring. Examples of the 6-membered heterocyclic ring include pyrane ring, dioxane ring, dithiane ring, thiin ring, pyridine ring, piperidine ring, oxazine ring, morpholino ring, thiazine ring, pyridazine ring, pyrimidine ring, pyrazine ring, piperazine ring and triazine ring. Other 6-membered or 5-membered ring(s) may be condensed with the 6-membered ring.

Examples of the substituent include halogen atoms, cyano, C₁₋₁₂ alkyls and C₁₋₁₂ alkoxys. The alkyl or alkoxy may have at least one C₂₋₁₂ acyl or C₂₋₁₂ acyloxy. The substituent is preferably selected from C₁₋₁₂ (more preferably C₁₋₆, even more preferably C₁₋₃) alkyls. The 5-membered or 6-membered ring may have two or more substituents. For example, if Y²² and Y²³ are phenyls, they may have from 1 to 4 C₁₋₁₂ (more preferably C₁₋₆, or even more preferably C₁₋₃) alkyls.

In the formula, m is 1 or 2, or is preferably 2. If m is 2, plural Y²³ and L²⁴ may be same or different from each other respectively.

In the formula, Z²¹ is a monovalent group selected from the group consisting of a halogen-substituted phenyl, nitro-substituted phenyl, cyano-substituted phenyl, C₁₋₁₀ alkyl-substituted phenyl, C₂₋₁₀ alkoxy-substituted phenyl, C₁₋₁₂ alkyl, C₂₋₂₀ alkynyl, C₁₋₁₂ alkoxy, C₂₋₁₃ alkoxycarbonyl, C₇₋₂₆ aryloxycarbonyl and C₇₋₂₆ arylcarbonyloxy.

If m is 2, Z²¹ is preferably cyano, a C₁₋₁₀ alkyl or a C₁₋₁₀ alkoxy, or more preferably a C₄₋₁₀ alkoxy.

If m is 1, Z²¹ is preferably a C₇₋₁₂ alkyl, C₇₋₁₂ alkoxy, C₇₋₁₂ acyl-substituted alkyl, C₇₋₁₂ acyl-substituted alkoxy, C₇₋₁₂ acyloxy-substituted alkyl or C₇₋₁₂ acyloxy-substituted alkoxy.

The acyl is represented by —CO—R, the acyloxy is represented by —O—CO—R, and R represents an aliphatic group (including alkyl, substituted alkyl, alkenyl, substituted alkenyl, alkynyl and substituted alkynyl), or an aromatic group (including aryl and substituted aryl). R is preferably an aliphatic group, or more preferably an alkyl or alkenyl.

In the formula, p is an integer of from 1 to 10, or preferably 1 or 2. CₚH₂ₚ represents an alkylene chain which may have a branched structure. CₚH₂ₚ is preferably a linear alkylene chain (—(CH₂)ₚ—).

In formula (2b), R³⁰ represents a hydrogen atom or a C₁₋₁₂ (preferably C₁₋₆, or more preferably C₁₋₃) alkyl group.

Among the compounds represented by formula (2a) or (2b), the compound represented by formula (2a′) or (2′) is preferable.

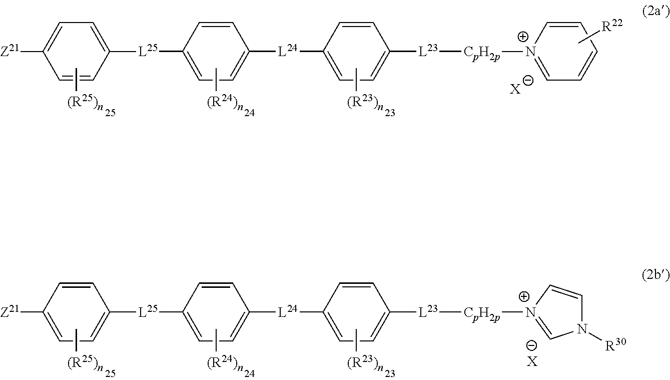

Among the symbols in the formula (2a′) or (2b′), the same symbols have the same definition as those found in formula (2), and preferable examples thereof are same as those in formula (2). Preferably, L²⁴ and L²⁵ represent —O—CO-or —CO—O—; or more preferably, L²⁴ is —O—CO— and L²⁵ is —CO—O—.

R²³, R²⁴ and R²⁵ represent a C₁₋₁₂ (more preferably C₁₋₆, or even more preferably C₁₋₃) alkyl respectively. In the formula, n₂₃ is from 0 to 4, n₂₄ is from 1 to 4, and n₂₅ is from 0 to 4. Preferably, n₂₃ and n₂₅ are 0, and n₂₄ is from 1 to 4 (more preferably from 1 to 3).

Preferably, R³⁰ represents a C₁₋₁₂ (more preferably C₁₋₆, or even more preferably C₁₋₃) alkyl.

Examples of the compound represented by formula (1) include those described in JP-A-2006-113500, columns [0058]-[0061].

Specific examples of the compound represented by formula (1) include, but are not limited to, those shown below.

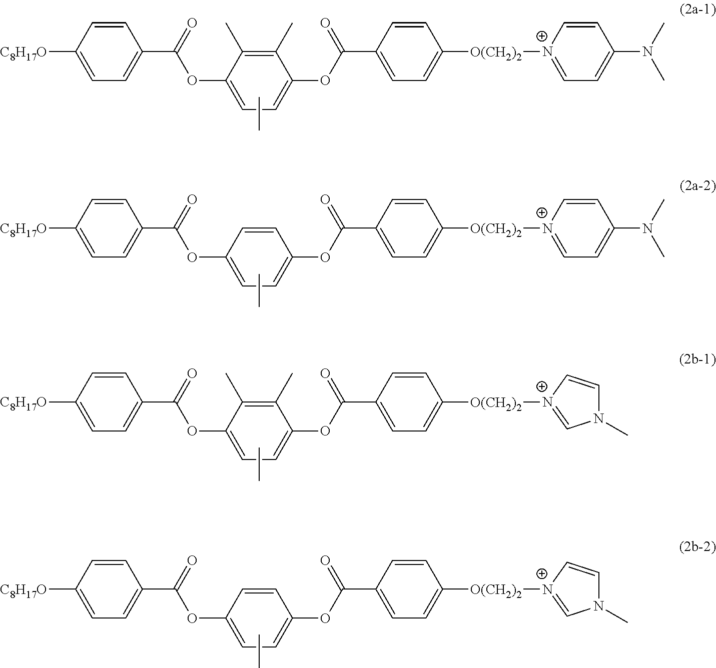

The compound represented by formula (2a) or (2b) may be prepared according to a usual method. For example, usually, the pyridinium derivative may be prepared according to the method wherein a pyridine ring is subjected to an alkylation (Menschutkin reaction).

An amount of the onium salt may be not more than 5% by mass, or preferably about 0.1 to about 2% by mass, with respect to an amount of the liquid crystal compound.

The onium salt represented by formula (2a) or (2b) may localize at the surface of the hydrophilic polyvinyl alcohol alignment layer since the pyridinium or imidazolium group is hydrophilic. Especially, the pyridinium group, or the pyridinium group, having an amino which is an acceptor of a hydrogen atom (in formula (2a) or (2a′), R²² is a non-substituted amino or C₁₋₂₀ substituted amino), may form an intermolecular hydrogen bonding with the polyvinyl alcohol, may localize at the surface of the alignment layer densely, and may promote the orthogonal alignment of the liquid crystal with respect to the rubbing direction along with the pyridinium derivative, which is aligned along the direction orthogonal to the polyvinyl alcohol main chain, by the effect of the hydrogen bonding. The pyridinium derivative having plural aromatic rings may interact with the liquid crystal, especially discotic liquid crystal, by the strong intermolecular π-π interaction, and may induce the orthogonal alignment of the discotic liquid crystal in the area neighboring to the alignment layer. Especially, as represented by formula (2a′), the compound in which the hydrophilic pyridinium group is connected with the hydrophobic aromatic ring may have an effect of inducing the vertical alignment by the hydrophobic property.

Furthermore, in the embodiment using also the onium salt represented by formula (2a) or (2b), the horizontal alignment state in which the liquid crystal is aligned so that the slow axis thereof is parallel to the rubbing direction may be promoted when being applied with heat over a certain temperature. This may be because the hydrogen bonding with the polyvinyl alcohol would be broken by the thermal energy caused by heating, the onium salt would be dispersed uniformly, the density of the onium salt at the surface of the alignment layer would be lowered, and the liquid crystal would be aligned by the alignment controlling force of the rubbed alignment layer itself

[Fluoroaliphatic Group-Containing Copolymer (Agent for Controlling Alignment at Air-Interface)]

The fluoroaliphatic group-containing copolymer may be added to the liquid crystal for controlling the alignment of the discotic liquid crystal represented by formula (I) at the air-interface, and may have a function of increasing the tilt angles of the liquid crystal molecules in the area neighboring to the air interface. And the copolymer may also have a function of improving the coating properties such as unevenness or repelling.

Examples of the fluoroaliphatic group-containing copolymer which can be used in the present invention include those described in JP-A-2004-333852, JP-A-2004-333861, JP-A-2005-134884, JP-A-2005-179636, and JP-A-2005-181977. The polymers having a fluoroaliphatic group and at least a hydrophilic group selected from the group consisting of carboxyl (—COOH), sulfo (—SO₃H), phosphonoxy {—OP(═O)(OH)₂}} and any salts thereof, described in JP-A-2005-179636 and JP-A-2005-181977 are preferable.

An amount of the fluoroaliphatic group-containing copolymer is less than 2% by mass, or preferably from 0.1 to 1% by mass with respect to an amount of the liquid crystal compound.

The fluoroaliphatic group-containing copolymer may localize at the air-interface by the hydrophobic effect of the fluoroaliphatic group, and may provide the low-surface energy area at the air-interface, and the tilt angle of the liquid crystal compound, especially discotic liquid crystal compound, in the area may be increased. Furthermore, by using the copolymer having the hydrophilic group selected from the group consisting of carboxyl (—COOH), sulfo (—SO₃H), phosphonoxy {—OP(═O)(OH)₂}} and any salts thereof, the vertical alignment of the liquid crystal may be achieved by the charge repulsion between the anion of the copolymer and the u electrons of the liquid crystal.

[Solvent]

The composition to be used for preparing the optically anisotropic layer is preferably prepared as a coating liquid. Organic solvents are preferably used as the solvent used for preparing the coating liquid. Examples of the organic solvents include amides (e.g., N,N-dimethylformamide), sulfoxides (e.g., dimethylsulfoxide), heterocyclic compounds (e.g., pyridine), hydrocarbons (e.g., benzene, hexane), alkyl halide (e.g., chloroform, dichloromethane), esters (e.g., methyl acetate, butyl acetate), ketones (e.g., acetone, methyl ethyl ketone), and ethers (e.g., tetrahydrofuran, 1,2-dimethoxyethane). Alkyl halides and ketones are preferable. Two or more species of organic solvent can be combined.

[Polymerization Initiator]

The composition (for example coating liquid) containing the liquid crystal having the polymerizable group(s) is aligned in any alignment state, and then, the alignment state is preferably fixed via the polymerization thereof (the 5) step in the above-described process). The fixation is preferably carried out by polymerization reaction between the polymerizable groups introduced into the liquid crystalline compound. Examples of the polymerization reaction include thermal polymerization reaction using a thermal polymerization initiator, and photo-polymerization reaction using a photo-polymerization initiator, wherein photo-polymerization reaction is more preferable. Examples of the photo-polymerization initiator include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in Japanese Laid-Open Patent Publication No. S60-105667 and U.S. Pat. No. 4,239,850), and oxadiazole compounds (those described in U.S. Pat. No. 4,212,970). Examples of the cationic photo-polymerization initiator include organic sulfonium salts, iodonium salts and phosphonium salts, organic solfonium salts are preferable, and triphenyl sulfonium salts are especially preferable. Preferable examples of the counter ion thereof include hexafluoro antimonate and hexafluoro phosphate.

An amount of the photo-polymerization initiator to be used is preferably from 0.01 to 20% by mass, or more preferable from 0.5 to 5% by mass, with respect to the solid content of the coating liquid.

[Sensitizer]

For enhancing the sensitivity, any sensitizer may be used along with the polymerization initiator. Examples of the sensitizer include n-butyl amine, triethyl amine, tri-n-butyl phosphine and thioxanthone. The photo-polymerization initiator may be used in combination with other photo-polymerization initiator(s). An amount of the photo-polymerization initiator is preferably from 0.01 to 20% by mass, or more preferably from 0.5 to 5% by mass, with respect to the solid content of the coating liquid. For carrying out the polymerization of the liquid crystal compound, an irradiation with UV light is preferably performed.

[Other Additives]

The composition may contain any polymerizable non-liquid-crystal monomer(s) along with the polymerizable liquid crystal compound. Preferable examples of the polymerizable monomer include any compounds having vinyl, vinyloxy, acryloyl or methacryloyl. Using any multi-functional monomer, having two or more polymerizable groups, such as ethylene oxide modified trimethylolpropane acrylate may contribute to improving the durability, which is preferable. An amount of the non-liquid-crystal polymerizable monomer to be used is preferably less than 40% by mass, or more preferably from 0 to 20% by mass, with respect to the amount of the liquid crystal compound.

The thickness of the optically anisotropic layer is not limited, and preferably from 0.1 to 10 micro meters, or more preferably from 0.5 to 5 micro meters.

### Transparent Support:

The optical film of the invention has a transparent support that supports the above-mentioned optically-anisotropic layer. As the transparent support, preferred is use of a polymer film having positive Rth. As the transparent support, also preferred is use of a polymer film having low Re and low Rth.

The material for forming the transparent support usable in the invention includes, for example, polycarbonate polymers; polyester polymers such as polyethylene terephthalate, polyethylene naphthalate, etc.; acrylic polymers such as polymethyl methacrylate, etc.; styrenic polymers such as polystyrene, acrylonitrile/styrene copolymer (AS resin), etc. As other examples of the material usable herein, also mentioned are polyolefins such as polyethylene, polypropylene, etc.; polyolefinic polymers such as ethylene/propylene copolymer, etc.; vinyl chloride polymers; amide polymers such as nylon, aromatic polyamides, etc.; imide polymers; sulfone polymers; polyether sulfone polymers; polyether ether ketone polymers; polyphenylene sulfide polymers; vinylidene chloride polymers; vinyl alcohol polymers; vinylbutyral polymers; arylate polymers, polyoxymethylene polymers; epoxy polymers; mixed polymers prepared by mixing the above-mentioned polymers. The polymer film in the invention may be formed as a cured layer of a UV-curable or thermocurable resin such as acrylic, urethane, acrylurethane, epoxy, silicone or the like resins.

As the material for forming the transparent support, also preferred is use of thermoplastic norbornene resins. As the thermoplastic norbornene resins, there are mentioned Nippon Zeon's Zeonex and Zeonoa; JSR's Arton, etc.

As the material for forming the transparent support, also preferred is use cellulose polymer (hereinafter this may be referred to as cellulose acylate) such as typically triacetylcellulose, which has heretofore been used as a transparent protective film for polarizer.

[UV Absorbent]

Preferably, a UV absorbent is added to the transparent support such as cellulose acylate film or the like mentioned above, for the purpose of enhancing the lightfastness of the film itself, or for preventing the deterioration of image display members such as polarizer as well as liquid-crystal compound in liquid-crystal display devices, etc.

As the UV absorbent, preferred is use of those excellent in UV absorbability at a wavelength of 370 nm or less from the viewpoint of preventing the deterioration of liquid crystal, and absorbing as little as possible the visible light at a wavelength of 400 nm or more from the viewpoint of good image display performance. In particular, preferred are those having a transmittance at a wavelength of 370 nm of at most 20%, more preferably at most 10%, even more preferably at most 5%. The UV absorbent of the type includes, for example, oxybenzophenone compounds, benzotriazole compounds, salicylate compounds, benzophenone compounds, cyanoacrylate compounds, nickel complex compounds, as well as polymer UV-absorbent compounds having the above-mentioned UV-absorbing group, etc. However, the invention is not limited to these. Two or more different types of UV absorbents may be used here as combined.

Regarding the method of adding the UV absorbent to a dope, the UV absorbent may be first dissolved in an organic solvent such as alcohol, methylene chloride, dioxolan or the like and then added thereto, or the UV absorbent may be directly added to a dope composition. Those not dissolving in organic solvent such as inorganic powder may be dispersed in cellulose acylate, using a dissolver or a sand mill, and then added to a dope.

In the invention, the amount of the UV absorbent to be used is from 0.1 to 5.0 parts by mass relative to 100 parts by mass of cellulose acylate, preferably from 0.5 to 2.0 parts by mass, more preferably from 0.8 to 2.0 parts by mass.

### Alignment Layer:

Between the optically-anisotropic layer and the transparent support, an alignment layer capable of realizing the intended, patterned optically-anisotropic layer may be formed. As the alignment layer, preferred is use of a rubbed alignment layer.

The “rubbed alignment layer” usable in the invention means a layer processed by rubbing so as to have the ability to control the alignment of liquid-crystal molecules. The rubbed alignment layer has an alignment axis of controlling the alignment of liquid-crystal molecules; and according to the alignment axis, liquid-crystal molecules are aligned. Liquid-crystal molecules are so aligned that the slow axis of the liquid-crystal molecules is parallel to the rubbing direction in the UV-irradiated part of the alignment layer, but are so aligned that the slow axis of the liquid-crystal molecules is aligned perpendicularly to the rubbing direction in the non-irradiated part of the film; and for that purpose, the material of the alignment layer, the acid generator, the liquid crystal and the alignment-controlling agent are suitably selected.

The rubbed alignment layer generally comprises a polymer as the main ingredient thereof. Regarding the polymer material for the alignment layer, a large number of substances are described in literature, and a large number of commercial products are available. The polymer material for use in the invention is preferably polyvinyl alcohol or polyimide, and their derivatives. Especially preferred are modified or unmodified polyvinyl alcohols. Polyvinyl alcohols having a different degree of saponification are known. In the invention, preferred is use of those having a degree of saponification of from 85 to 99 or so. Commercial products are usable here, and for example, “PVA103”, “PVA203” (by Kuraray) and others are PVAs having the above-mentioned degree of saponification. Regarding the rubbed alignment layer, referred to are the modified polyvinyl alcohols described in WO01/88574A1, from page 43, line 24 to page 49, line 8, and Japanese Patent 3907735, paragraphs [0071] to [0095]. Preferably, the thickness of the rubbed alignment layer is from 0.01 to 10 micro meters, more preferably from 0.01 to 1 micro meters.

The rubbing treatment may be attained generally by rubbing the surface of a film formed mainly of a polymer, a few times with paper or cloth in a predetermined direction. A general method of rubbing treatment is described, for example, in “Liquid Crystal Handbook” (published by Maruzen, Oct. 30, 2000).

Regarding the method of changing the rubbing density, employable is the method described in “Liquid Crystal Handbook” (published by Maruzen). The rubbing density (L) is quantified by the following (A):

L=N1(l+2πrn/60v) (A)

wherein N means the rubbing frequency, I means the contact length of the rubbing roller, r means the radius of the roller, n is the rotation number of the roller (rpm), and v means the stage moving speed (per second).

For increasing the rubbing density, the rubbing frequency is increased, the contact length of the rubbing roller is prolonged, the radius of the roller is increased, the rotation number of the roller is increased, the stage moving speed is lowered; but on the contrary, for decreasing the rubbing density, the above are reversed.

The relationship between the rubbing density and the pretilt angle of the alignment layer is that, when the rubbing density is higher, then the pretilt angle is smaller, but when the rubbing density is lower, then the pretilt angle is larger.

For sticking an alignment layer to a long polarizing film of which the absorption axis is in the lengthwise direction thereof, preferably, an alignment layer is formed on a long support of polymer film, and then continuously rubbed in the direction at 45° relative to the lengthwise direction, thereby forming the intended rubbed alignment layer.

If possible, a photo-alignment layer may be used.

The alignment layer may contain at least one photo-acid-generating agent. The photo-acid-generating agent is a compound capable of generating an acid compound through decomposition by photoirradiation with UV rays or the like. When the photo-acid-generating agent generates an acid compound through decomposition by photoirradiation, then the alignment controlling function of the alignment layer is thereby changed. The change in the alignment controlling function as referred to herein may be one to be identified as the change in the alignment controlling function of the alignment layer alone, or may be one to be identified as the change in the alignment controlling function to be attained by the alignment layer and the additives and others contained in the composition for the optically-anisotropic layer to be disposed on the film, or may also be one to be identified as a combination of the above.

When an onium salt is added thereto, a discotic liquid crystal may be aligned in an orthogonal-vertical alignment state. When the acid generated through decomposition and the onium salt undergo anionic exchange, then the locality of the onium salt in the alignment layer interface may lower to thereby lower the orthogonal-vertical alignment performance to form a parallel-vertical alignment state. In addition, for example, in case where the alignment layer is a polyvinyl alcohol alignment layer, the ester moiety thereof may be decomposed by the generated acid and, as a result, the alignment layer interface locality of the onium salt may be thereby changed.

The optically-anisotropic layer may be formed in various methods of using an alignment layer, and the method for forming the layer is not specifically defined here.

A first embodiment is a method of using multiple functions that have some influences on the alignment control of discotic liquid crystal, and then removing any of those functions through external stimulation (heat treatment, etc.) to thereby make the predetermined alignment controlling function predominant. For example, the discotic liquid crystal may be aligned in a predetermined alignment state under the combined function of the alignment controlling function of the alignment layer and the alignment controlling function of the alignment controlling agent(s) which are added to a liquid-crystal composition, and then the alignment state is fixed to form one retardation domain. After that, by being applied with some external stimulation (heat treatment, etc.), any of the functions (for example, the function of the alignment controlling agent) may be lost while the other alignment control function (for example, the function of the alignment layer) may become predominant. The other alignment state may be formed and fixed to thereby form the other retardation domain. For example, in the pyridinium compound represented by the above-mentioned formula (2a) or the imidazolium compound represented by the above-mentioned formula (2b), the pyridinium group or the imidazolium group is hydrophilic, and therefore the compound is localized in the surface of the hydrophilic polyvinyl alcohol alignment layer. In particular, if the pyridinium group has an amino group (in the formulae (2a) and (2a′), if R²² represents the unsubstituted amino group or the substituted amino group having from 1 to 20 carbon atoms) that is the substituent for the acceptor of hydrogen atom, the intermolecular hydrogen bonding may occur between the pyridinium compound and polyvinyl alcohol, therefore the compound may localize in the surface of the alignment layer at a higher density, and in addition, owing to the effect of the hydrogen bonding, the pyridinium compound may be aligned along the direction orthogonal to the main chain of polyvinyl alcohol, which may result in promoting the orthogonal alignment of liquid crystal with respect to the rubbing direction. The pyridinium derivative has multiple aromatic rings in the molecule and therefore provides a strong intermolecular π-π interaction with liquid crystal, especially with discotic liquid crystal, thereby inducing orthogonal alignment of discotic liquid crystal in the vicinity of the alignment layer interface. In particular, in case where a hydrophilic pyridinium group bonds to the hydrophobic aromatic ring, as in the general formula (2a′), the compound additionally have the effect of inducing vertical alignment owing to the hydrophilic effect of the ring therein. However, when the compound is heated higher than a certain temperature, then the hydrogen bonding may be broken and the density of the pyridinium compound in the surface of the alignment layer may lower, and the above-mentioned effect is thereby lost. As a result, the liquid crystal is aligned owing to the controlling force of the rubbed alignment layer itself, and the liquid crystal is thereby in a parallel alignment state. The details of the method are described in Japanese Patent Application No. 2010-141346 (JP-A-2012-008170), and the content thereof is incorporated herein by reference.

A second embodiment is an embodiment employing a patterned alignment layer. In this embodiment, a patterned alignment layer having different alignment controlling capabilities is formed, and a liquid-crystal composition is disposed thereon so that the liquid crystal is aligned on the alignment layer. The liquid crystal is controlled for the alignment thereof owing to the different alignment controlling capabilities of the patterned alignment layer, therefore attaining different alignment states. By fixing the alignment states, a pattern of first and second retardation domains is formed according to the pattern of the patterned alignment layer. The patterned alignment layer may be formed according to a printing method, a mask rubbing method of rubbing an alignment layer, or a method of using mask exposure for a photo-alignment layer. The patterned alignment layer may also be formed as follows: First, an alignment layer is formed uniformly, and then an additive having an influence on the alignment controlling capability (for example, the above-mentioned onium salt, etc.) is printed on the layer to thereby form the intended patterned alignment layer. The printing method is preferred as not requiring any large-scale equipment and capable of forming the intended patterned alignment layer. The details of the method are described in Japanese Patent Application No. 2010-173077 (JP-A-2012-032661), and the content thereof is incorporated herein by reference.

The first and second embodiments may be combined. One example is adding a photo-acid-generating agent to the alignment layer. In this example, a photo-acid-generating agent is added to the alignment layer, and then pattern-exposed to give a domain where the photo-acid-generating agent is decomposed to generate an acid compound and a domain where an acid compound is not generated. In the non-photoirradiated domain, the photo-acid-generating agent is kept almost undecomposed, and in the domain, therefore, the interaction between the alignment layer material, the liquid crystal, and the alignment controlling agent optionally added thereto governs the alignment state, whereby the liquid crystal is aligned so that its slow axis is along the direction orthogonal to the rubbing direction. In case where the alignment layer is photoirradiated and an acidic compound is thereby generated therein, the above-mentioned interaction is no more predominant, and the rubbing direction for the rubbed alignment layer governs the alignment state, whereby the liquid crystal is aligned in parallel alignment so that the slow axis thereof is parallel to the rubbing direction. The photo-acid-generating agent to be used in the alignment layer is preferably a water-soluble compound. Examples of the photo-acid-generating agent usable here include the compounds described in Prog. Polym. Sci., Vol. 23, p. 1485 (1998). As the photo-acid-generating agent, especially preferred for use herein are pyridinium salts, iodonium salts and sulfonium salts. The details of the method are described in Japanese Patent Application No. 2010-289360, and the content thereof is incorporated herein by reference.

A third embodiment is a method using a discotic liquid crystal that has polymerizable groups differing from each other in terms of the polymerizability thereof (for example, oxetanyl group and polymerizing ethylenic unsaturated group). In this embodiment, the discotic liquid crystal is aligned in a predetermined alignment state, and then under the condition under which only one polymerizable group could be polymerized, the liquid crystal layer is photoirradiated to give a pre-optically anisotropic layer. Next, under the condition under which the other polymerizable group could be polymerized (for example, in the presence of a polymerization initiator for initiating the polymerization of the other polymerizable group), the layer is mask-exposed. The alignment state in the exposed area is completely fixed to form one retardation domain having predetermined Re. In the non-exposed domain, the reaction of the other reactive group has gone on, but the other reactive group is kept unreacted. Accordingly, when this is heated at a temperature higher than the isotropic phase temperature and up to the temperature at which the reaction of the other reactive group could go on, then the non-exposed domain is fixed in the isotropic phase state, or that is, its Re is 0 nm.

### Polarizing Film:

As the polarizing film, any ordinary polarizing film is usable here. For example, a polarizing film of a polyvinyl alcohol or the like dyed with iodine or a dichroic dye can be used here.

### Adhesive Layer:

An adhesive layer may be arranged between the optically-anisotropic layer and the polarizing film. The adhesive layer to be used for laminating the optically-anisotropic layer and the polarizing film is, for example, a substance having a ratio of G′/G″ (tan δ=G″/G′), as measured with a dynamic viscoelastometer, of from 0.001 to 1.5, and includes so-called adhesives, easily creeping substances, etc. The adhesives are not specifically defined, and for example, polyvinyl alcohol adhesives are usable here.

### Layer Configuration of Optical Film:

The optical film of the invention may have one or more functional layers necessary in accordance with the object thereof. Preferred embodiments include an embodiment where a hard coat layer is laminated on the optically-anisotropic layer; an embodiment where an antireflection layer is laminated on the optically-anisotropic layer; an embodiment where a hard coat layer is laminated on the optically-anisotropic layer, and an antireflection layer is further laminated thereon; an embodiment where an antiglare layer is laminated on the optically-anisotropic layer, etc. The antireflection layer comprises at least one or more layers which are so designed that the reflectivity can reduce owing to optical interference, in consideration of the refractive index, the thickness, the number of the constituent layers, the order of the layers, etc.

The simplest configuration of the antireflection layer is a configuration where a low refractive index layer alone is formed on the outermost surface of the film by coating. For further lowering the refractive index thereof, preferably, the antireflection layer is formed by combining a high refractive index layer having a high refractive index and a low refractive index layer having a low refractive index. Configuration examples include a two-layer configuration of high refractive index layer/low refractive index layer in that order from the lower side; a three-layer configuration composed of three layers each having a different refractive index, in which the constituent layers are laminated in an order of middle refractive index layer (having a higher refractive index than the lower layer but having a lower refractive index than the high refractive index layer)/high refractive index layer/low refractive index layer, etc. In addition, also proposed is a multilayer laminate composed of further more antireflection layers.

Above all, from the viewpoint of the durability, the optical properties, the cost and the producibility, preferred is a lamination of middle refractive index layer/high refractive index layer/low refractive index layer in that order on a hard coat layer; and for example, there are mentioned the configurations described in JP-A 8-122504, 8-110401, 10-300902, 2002-243906, 2000-111706, etc. In addition, any other functions may be given to the constituent layers, and for example, there are mentioned an antifouling low refractive index layer, an antistatic high refractive index layer, an antistatic hard coat layer (for example, as in JP-A 10-206603, 2002-243906, etc.).

Examples of the layer configuration including a hard coat layer of an anti-reflective layer are shown below.

Support/Optically anisotropic layer

Support/Optically anisotropic layer/Support/Hard coat layer

Support/Optically anisotropic layer/Support/Low-refractive index layer

Support/Optically anisotropic layer/Support/Hard coat layer/Low-refractive index layer

Support/Optically anisotropic layer/Support/Hard coat layer/Middle-refractive index layer/High-refractive index layer/Low-refractive index layer

Support/Optically anisotropic layer/Support/Antiglare layer

Support/Optically anisotropic layer/Support/Antiglare layer/Low-refractive index layer

Support/Optically anisotropic layer/Support/Antiglare layer/Middle-refractive index layer/High-refractive index layer/Low-refractive index layer

Support/Optically anisotropic layer/Support/Hard coat layer/Antiglare layer

Support/Optically anisotropic layer/Support/Hard coat layer/Antiglare layer/Low-refractive index layer

Support/Optically anisotropic layer/Support/Hard coat layer/Antiglare layer/Middle-refractive index layer/High-refractive index layer/Low-refractive index layer

Optically anisotropic layer/Support

Optically anisotropic layer/Support/Support/Hard coat layer

Optically anisotropic layer/Support/Support/Low-refractive index layer

Optically anisotropic layer/Support/Support/Hard coat layer/Low-refractive index layer

Optically anisotropic layer/Support/Support/Hard coat layer/Middle-refractive index layer/High-refractive index layer/Low-refractive index layer

Optically anisotropic layer/Support/Support/Antiglare layer

Optically anisotropic layer/Support/Support/Antiglare layer/Low-refractive index layer

Optically anisotropic layer/Support/Support/Antiglare layer/Middle-refractive index layer/High-refractive index layer/Low-refractive index layer

Optically anisotropic layer/Support/Hard coat layer

Optically anisotropic layer/Support/Support/Hard coat layer/Antiglare layer

Optically anisotropic layer/Support/Support/Hard coat layer/Antiglare layer/Low-refractive index layer

Optically anisotropic layer/Support/Support/Hard coat layer/Antiglare layer/Middle-refractive index layer/High-refractive index layer/Low-refractive index layer

Optically anisotropic layer/Support/Hard coat layer

Optically anisotropic layer/Support/Low-refractive index layer

Optically anisotropic layer/Support/Hard coat layer/Low-refractive index layer

Optically anisotropic layer/Support/Hard coat layer/Middle-refractive index layer/High-refractive index layer/Low-refractive index layer

Optically anisotropic layer/Support/Antiglare layer

Optically anisotropic layer/Support/Antiglare layer/Low-refractive index layer

Optically anisotropic layer/Support/Antiglare layer/Middle-refractive index layer/High-refractive index layer/Low-refractive index layer

Optically anisotropic layer/Support/Hard coat layer/Antiglare layer

Optically anisotropic layer/Support/Hard coat layer/Antiglare layer/Low-refractive index layer

Optically anisotropic layer/Support/Hard coat layer/Antiglare layer/Middle-refractive index layer/High-refractive index layer/Low-refractive index layer

Support/Optically anisotropic layer/Hard coat layer

Support/Optically anisotropic layer/Low-refractive index layer

Support/Optically anisotropic layer/Hard coat layer/Low-refractive index layer

Support/Optically anisotropic layer/Hard coat layer/Middle-refractive index layer/High-refractive index layer/Low-refractive index layer

Support/Optically anisotropic layer/Antiglare layer

Support/Optically anisotropic layer/Antiglare layer/Low-refractive index layer

Support/Optically anisotropic layer/Antiglare layer/Middle-refractive index layer/High-refractive index layer/Low-refractive index layer

Support/Optically anisotropic layer/Hard coat layer/Antiglare layer

Support/Optically anisotropic layer/Hard coat layer/Antiglare layer/Low-refractive index layer

Support/Optically anisotropic layer/Hard coat layer/Antiglare layer/Middle-refractive index layer/High-refractive index layer/Low-refractive index layer

Among the above described constructions, the constructions having a hard coat layer, antiglare layer, anti-reflective layer or the like disposed on the optically anisotropic layer directly are preferable. An optical film having the optically anisotropic layer and an optical film having a hard coat layer, antiglare layer, antireflective layer or the like disposed on a support film may be prepared respectively, and then bonded to each other.

One preferred embodiment of the optical film of the invention has an antireflection layer that comprises a middle refractive index layer, a high refractive index layer and a low refractive index layer as laminated in that order from the side of the optically-anisotropic layer therein. Preferably, the refractive index at a wavelength of 550 nm of the middle refractive index layer is from 1.60 to 1.65, the thickness of the middle refractive index layer is from 50.0 nm to 70.0 nm, the refractive index at a wavelength of 550 nm of the high refractive index layer is from 1.70 to 1.74, the thickness of the high refractive index layer is from 90.0 nm to 115.0 nm, the refractive index at a wavelength of 550 nm of the low refractive index layer is from 1.33 to 1.38, and the thickness of the low refractive index layer is from 85.0 nm to 95.0 nm.

Of the above-mentioned configurations, more preferred is the configuration (1) or the configuration (2) mentioned below.

Configuration (1): An antireflection layer in which the refractive index at a wavelength of 550 nm of the middle refractive index layer is from 1.60 to 1.64, the thickness of the middle refractive index layer is from 55.0 nm to 65.0 nm, the refractive index at a wavelength of 550 nm of the high refractive index layer is from 1.70 to 1.74, the thickness of the high refractive index layer is from 105.0 nm to 115.0 nm, the refractive index at a wavelength of 550 nm of the low refractive index layer is from 1.33 to 1.38, and the thickness of the low refractive index layer is from 85.0 nm to 95.0 nm.
Configuration (2): An antireflection layer in which the refractive index at a wavelength of 550 nm of the middle refractive index layer is from 1.60 to 1.65, the thickness of the middle refractive index layer is from 55.0 nm to 65.0 nm, the refractive index at a wavelength of 550 nm of the high refractive index layer is from 1.70 to 1.74, the thickness of the high refractive index layer is from 90.0 nm to 100.0 nm, the refractive index at a wavelength of 550 nm of the low refractive index layer is from 1.33 to 1.38, and the thickness of the low refractive index layer is from 85.0 nm to 95.0 nm.

Having the refractive index and the thickness of each layer falling within the above-mentioned ranges, the antireflection layer can more reduce the fluctuation of the reflected color. The configuration (1) is more preferred, as capable of reducing the fluctuation of the reflected color and capable of significantly reducing the refractive index of the layer. The configuration (2) is even more preferred, as capable of more reducing the fluctuation of the refractive index of the layer the configuration (1) and excellent in robustness against thickness fluctuation.

In the invention, preferably, the above-mentioned middle refractive index layer satisfies the following formula (I), the above-mentioned high refractive index layer satisfies the following formula (II) and the above-mentioned low refractive index layer satisfies the following formula (III), at the design wavelength λ (=550 nm, a typical wavelength at which the visibility is the highest):

λ/4×0.68<n1d1<λ/4×0.74 (I)

λ/2×0.66<n2d2<λ/2×0.72 (II)

λ/4×0.84<n3d3<λ/4×0.92 (III)

In these formulae, n1 means the refractive index of the middle refractive index layer, d1 means the thickness (nm) of the middle refractive index layer, n2 means the refractive index of the high refractive index layer, d2 means the thickness (nm) of the high refractive index layer, n3 means the refractive index of the low refractive index layer, d3 means the thickness (nm) of the low refractive index layer, and n3<n1<n2.

The layer satisfying the above-mentioned formulae (I), (II) and (III) is preferred as having a low reflectivity and capable preventing the change of the reflected color. Another advantage of the layer is that, when oily and fatty matters such as fingerprints, sebum and the like adhere to the layer, the contaminants are hardly visualized since the color change of the layer is small.

In case where the color of the normal-reflected light to a 5-degree incident light of a CIE standard light source D65 in a wavelength region of from 380 nm to 780 nm falls within a range of 0≦a*≦8 and −10≦b*≦0 in which a* and b* are the values in a CIE1976L*a*b* color space, and further, within the above-mentioned color fluctuation range, in case where the color difference ΔE in 2.5% fluctuation of the thickness of a layer of the above-mentioned layers falls within the range of the following formula (5), the layer is favorable since the neutrality of the reflected color is good and there occurs no difference in the reflected color among different products and, in addition, when oily and fatty matters such as fingerprints, sebum and the like adhere to the layer, the contaminants are not so much remarkable. When a low refractive index layer that contains a polymerizing unsaturated group-having fluorine-containing antifouling agent and a fluorine-containing polyfunctional acrylate is combined with the above-mentioned layer configuration, then oily and fatty matters such as, oily marker inks, fingerprints, sebum and the like hardly adhere to the layer, and even though having adhered thereto, the contaminants can be readily wiped away and become unremarkable.

ΔE={(L*−L*′)2+(a*−a*′)2+(b*−b*′)2}1/2≦3 (5)

wherein L*′, a*′ and b*′ each are the color of the reflected light on the layer having the design thickness.

In case where the optical film is arranged on the surface of an image display device, preferably, the mean value of the mirror reflectivity thereof is at most 0.5% as capable of significantly reducing the background reflection on the panel.

The mirror reflectivity and the color can be determined as follows: An adaptor “ARV-474” is attached to a spectrophotometer “V-550” (by JASCO), and in a wavelength region of from 380 to 780 nm, the mirror reflectivity at an angle of (output angle—θ) where θ is the incident angle (θ is from 5 to 45° at intervals of 5°) is determined. A mean reflectivity within a range of from 450 to 650 nm is computed, and the antireflectivity is evaluated from the data. Further, from the measured reflection spectrum, the L*value, the a* value and the b* value in a CIE1976L*a*b* color space that indicates the color of the normal-reflected light of the incident light at each incident angle from a CIE standard light source D65 is computed, and the color of the reflected light can be thereby evaluated.

For the measurement of the refractive index of each layer, the coating liquid for each layer is applied onto a glass plate to have a thickness of from 3 to 5 micro meters, and the formed layer is analyzed with a multiwavelength Abbe's refractiometer DR-M2 (by Atago). In this description, the refractive index measured using a filter of “interference filter 546(e) nm for DR-M2 and M4, Lot No. RE-3523” is taken as the refractive index at a wavelength of 550 nm. The thickness of each layer can be measured with a reflection-spectrometric thickness gauge “FE-3000” (by Otsuka Electronics) using light interference or through observation of the cross section of the layer with TEM (transmission electromicroscope). Using the reflection-spectrometric thickness gauge, the thickness and also the refractive index of the layer can be measured, but for the purpose of enhancing the measurement accuracy in measuring the thickness, it is desirable to use the refractive index of each layer measured by the use of a different means. In case where the refractive index of each layer could not be measured, it is desirable to measure the thickness of the layer with TEM. In such a case, at least 10 points are analyzed, and the found data are averaged to give a mean value.

Preferably, the optical film of the invention is in the form of a roll made by winding up the produced film. In such a case, for obtaining the neutrality of the reflected color, the value of the layer thickness distribution, as computed according to the following formula (6) where the mean value d (mean value), the minimum value d (minimum value) and the maximum value d (maximum value) of the layer thickness in an arbitrary 1000-meter length range are the parameters, is at most 5% for each thin layer, more preferably at most 4%, even more preferably at most 3%, still more preferably at most 2.5%, further more preferably at most 2%.

(maximum value d−minimum value d)×100/mean value d. (6)

(Hard Coat Layer)

According to the invention, the protective member may have a hard coat layer in the antireflective film (surface film) thereof. Although the protective member may not have any hard coat layer, the protective member preferably has a hard coat layer since it may become strong in terms of abrasion-resistance according to the pencil-scratch test or the like.

Preferably, the antireflective film comprises a hard coat layer and a low-refractive index layer which is disposed on the hard coat layer, or more preferably, further comprises a middle-refractive index layer and a high-refractive index layer which are disposed between the hard coat layer and the low-refractive index layer. The hard coat layer may be constituted by two or more layers.

The refractive index of the hard coat layer is preferably from 1.48 to 2.00, or more preferably from 1.48 to 1.70 in terms of the optical design for obtaining the antireflective film. According to the embodiment having at least one low-refractive index layer disposed on the hard coat layer, if the refractive index is smaller than the above described range, the antireflection property may be lowered, and if the refractive index is larger than the above described range, the coloration of the reflective light may become strong.

In terms of obtaining sufficient durability and impact resistance, the thickness of the hard coat layer is generally from about 0.5 to about 50 micro meters, preferably from about 1 to about 20 micro meters, or more preferably from about 5 to about 20 micro meters.

The strength of the hard coat layer is preferably H or more, more preferably 2H or more, even more preferably 3H or more, in a pencil hardness test. Further, regarding the amount of abrasion of a test piece after Taber abrasion test according to JIS K5400, a hard coat layer having a smaller abrasion amount is more preferred.

The hard coat layer is formed preferably by cross-linking reaction of polymerization reaction of a compound curable with ionization radiation. For example, it may be formed by coating on a transparent support a coating composition containing a multi-functional monomer or multi-functional oligomer which can be cured by ionization radiation, and performing cross-linking reaction or polymerization reaction of the multi-functional monomer or multi-functional oligomer. As the functional group of the ionization radiation-curable, multi-functional monomer or multi-functional oligomer, those functional groups which can be polymerized by light, electron beams or radiation are preferred, with photo-polymerizable functional groups being particularly preferred. As the photo-polymerizable functional groups, there are illustrated polymerizable functional groups such as a (meth)acryloyl group, a vinyl group, a styryl group and an allyl group. Of these, a (meth)acryloyl group is preferred.

The hard coat layer may contain matting particles having a mean diameter of from 1.0 to 10.0 micro meters, or more preferably from 1.5 to 7.0 micro meters, such as particles of any inorganic compound or any polymer, for the purpose of imparting internal scattering.

The binder of the hard coat layer may contain both of inorganic particles and a monomer having any refractive index, for the purpose of controlling the refractive index thereof. The inorganic particles may have not only a function capable of controlling the refractive index but also a function capable of preventing the curing-shrinkage via the cross-linking reaction. According to the invention, the term “binder” means a polymer, in which inorganic particles are dispersed, formed by polymerization of the multi-function monomer and/or the high-refractive index monomer, in which inorganic particles are dispersed.

The hard coat layer may contain any UV absorbent along with inorganic compound particles.

(UV Absorbent)

Preferably, a UV absorbent is added to the layer to be arranged further outside the patterned optically-anisotropic layer, such as the above-mentioned hard coat layer and others. The UV absorbent usable here is any known one capable of expressing UV absorbability. Of the UV absorbents, preferred are benzotriazole-type or hydroxyphenyltriazine-type UV absorbents having high UV absorbability (UV-ray shielding capability) and capable of being used in electronic image display devices. For broadening the UV absorption range, preferred is combined use of two or more UV absorbents.

The benzotriazole-type UV absorbents include 2-[2′-hydroxy-5′-(methacryloyloxymethyl)phenyl]-2H-benzotriazole, 2-[2′-hydroxy-5′-(methacryloyloxyethyl)phenyl]-2H-benzotriazole, 2-[2′-hydroxy-5′-(methacryloyloxypropyl)phenyl]-2H-benzotriazole, 2-[2′-hydroxy-5′-(methacryloylmhexyl)phenyl]-2H-benzotriazole, 2-[2′-hydroxy-3′-tert-butyl-5′-(methacryloyloxyethyl)phenyl]-2H-benzotriazole, 2-[2′-hydroxy-5′-tert-butyl-3′-(methacryloyloxyethyl)phenyl]-2H-benzotriazole, 2-[2′-hydroxy-5′-(methacryloyloxyethyl)phenyl]-5-chloro-2H-benzotriazole, 2-[2′-hydroxy-5′-(methacryloyloxyethyl)phenyl]-5-methoxy-2H-benzotriazole, 2-[2′-hydroxy-5′-(methacryloyloxyethyl)phenyl]-5-cyano-2H-benzotriazole, 2-[2′-hydroxy-5′-(methacryloyloxyethyl)phenyl]-5-tert-butyl-2H-benzotriazole, 2-[2′-hydroxy-5′-(methacryloyloxyethyl)phenyl]-5-nitro-2H-benzotriazole, 2-(2-hydroxy-5-tert-butylphenyl)-2H-benzotriazole, 3-(2H-benzotriazol-2-yl)-5-(1,1-dimethylethyl)-4-hydroxy-C7-9-branched linear alkyl benzenepropanoate, 2-(2H-benzotriazol-2-yl)-4,6-bis(1-methyl-1-phenylethyl)phenol, 2-(2H-benzotriazol-2-yl)-6-(1-methyl-1-phenylethyl)-4-(1,1,3,3-tetramethylbutyl)phenol, etc.

The hydroxyphenyltriazine-type UV absorbents include 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2,4-bis(2-hydroxy-4-butyloxyphenyl)-6-(2,4-bis-butyloxyphenyl)-1,3,5-triazine, 2-(2-hydroxy-4-[1-octyloxycarbonylethoxy]phenyl)-4,6-bis(4-phenylphenyl)-1,3,5-triazine, 2,2′,4,4′-tetrahydroxybenzophenone, 2,2′-dihydroxy-4,4′-dimethoxybenzophenone, 2,2′-dihydroxy-4-methoxybenzophenone, 2,4-dihydroxybenzophenone, 2-hydroxy-4-acetoxyethoxybenzophenone, 2-hydroxy-4-methoxybenzophenone, 2,2′-dihydroxy-4-methoxybenzophenone, 2,2′-dihydroxy-4,4′-dimethoxybenzophenone, 2-hydroxy-4-n-octoxybenzophenone, 2,2′-dihydroxy-4,4′-dimethoxy-5,5′-disulfobenzophenone disodium salt, etc.

The content of the UV absorbent is, though depending on the desired UV transmittance and the absorbance of the UV absorbent, generally at most 20 parts by mass relative to 100 parts by mass of the hard coat layer forming composition (provided that when the composition is prepared as a coating liquid, this is relative to the solid content of the liquid except the solvent), preferably from 1 to 20 parts by mass. In case where the UV absorbent content is more than 20 parts by mass, then the curability of the curable composition with UV rays may lower, and in addition the visible light transmittance of the hard coat layer may also lower. On the other hand, when the content is less than 1 part by mass, then the hard coat layer could not fully exhibit the UV absorbability.

(Antiglare Layer)

An antiglare layer may be formed so that antiglare property due to surface scattering and preferably hard coat property for enhancing the hardness and scratch resistance of the film can be imparted to the film.

The antiglare layer is described in paragraphs [0178] to [0189] of JP-A-2009-98658 and the same applies to the present invention.

(High-Refractive Index Layer and Middle-Refractive Index Layer)

The refractive index of the high-refractive index layer is preferably from 1.70 to 1.74, or more preferably from 1.71 to 1.73. The refractive index of the middle-refractive index layer is adjusted to have a value between the refractive index of the low-refractive index layer and the refractive index of the high-refractive index layer. The refractive index of the middle refractive index layer is preferably from 1.60 to 1.64, or more preferably from 1.61 to 1.63.

As for the method of forming the high-refractive index layer and the middle-refractive index layer, a transparent inorganic oxide thin film formed by a chemical vapor deposition (CVD) method or a physical vapor deposition (PVD) method, particularly, a vacuum deposition method or a sputtering method, which are a kind of physical vapor deposition method, may be used, but a method by all-wet coating is preferred.

The middle-refractive index layer and the high-refractive layer may be prepared according to a same method using same materials as long as the refractive indexes are different from each other. Therefore, only the method for preparing the high-refractive index layer is described in detail below.

The high-refractive index layer may be prepared as follows. A coating composition containing inorganic particles, a curable compound having three or more polymerizable groups (occasionally referred to as “binder”), a solvent and a polymerization initiator is prepared, applied to a surface, dried so that the solvent is removed, and then cured under irradiation with heat and/or ionization radiation. According to the method employing the curable compound and polymerization initiator, it is possible to prepare the high-refractive index layer or the middle-refractive index layer, which is excellent in scratch resistance and adhesion, by carrying out the polymerization under irradiation with heat and/or ionization radiation after coating.

[Inorganic Fine Particles]

The inorganic fine particles are preferably selected from inorganic fine particles containing any metal oxide, or more preferably selected from inorganic fine particles containing oxide of at least one metal selected from the group consisting of Ti, Zr, In, Zn, Sn, Al and Sb. Or at least one of the middle-refractive index layer and the high-refractive index layer may contain any conductive inorganic fine particles.

In terms of the refractive index, fine particles of zirconium oxide are preferable. In terms of the conductivity, inorganic fine particles containing, as a main ingredient, at least one metal oxide selected from the group consisting of Sb, In and Sn are preferable. Preferable examples of the conductive fine particles include metal fine oxide selected from the group consisting of indium oxide doped with tin (ITO), tin oxide doped with antimony (ATO), tin oxide doped with fluorine (FTO), tin oxide doped with phosphorus (PTO), zinc oxide doped with aluminum (AZO), indium oxide doped with zinc (IZO), zinc oxide, ruthenium oxide, rhenium oxide, silver oxide, nickel oxide and cupper oxide.

It may be possible to control the refractive index to the prescribed range by varying an amount of inorganic fine particles. In the embodiment containing zirconium oxide as a main ingredient, the mean diameter of the inorganic fine particles is preferably from 1 to 120 nm, more preferably from 1 to 60 nm, or even more preferably from 2 to 40 nm. By adjusting the amount to the above described range, it may be possible to prevent the increase of haze and improve the dispersion stability and the adhesiveness with the upper layer due to the appropriate asperity in the surface.

The mean refractive index of inorganic fine particles containing zirconium oxide as a main ingredient is preferably from 1.90 to 2.80, more preferably from 2.00 to 2.40, or even more preferably from 2.00 to 2.20.

And amount of inorganic fine particles to be added may be varied depending on the layer to which they are added. If being added to the middle-refractive index layer, an amount thereof is preferably from 20 to 60% by mass, more preferably from 25 to 55% by mass, or even more preferably from 30 to 50% by mass with respect to the solid content of all the middle-refractive index layer. If being added to the high-refractive index layer, an amount thereof is preferably from 40 to 90% by mass, more preferably from 50 to 85% by mass, or even more preferably from 60 to 80% by mass with respect to the solid content of all the high-refractive index layer.

The mean diameter of inorganic fine particles may be measured according to a light-scattering method or an electron microscope photograph. The mean specific surface area of inorganic fine particles is preferably from 10 to 400 m²/g, more preferably from 20 to 200 m²/g, or even more preferably from 30 to 150 m²/g.

The inorganic fine particles may be subjected to a physical surface treatment, such as a plasma discharge treatment or a corona discharge treatment, or a chemical surface treatment with a surfactant, a coupling agent, or the like to stabilize dispersion thereof in a dispersion or a coating solution or to enhance affinity or adhesion to a binder component. The use of a coupling agent is particularly preferable. As the coupling agent, an alkoxymetal compound (e.g., a titanium coupling agent, a silane coupling agent) is preferably used. A treatment with a silane coupling agent having an acryloyl group or a methacryloyl group is particularly effective. Examples of the surface treatment agent, solvent, catalyst, and dispersion stabilizer which can be used for chemical treatment of inorganic fine particles are described in JP-A-2006-17870, [0058]-[0083].

Inorganic fine particles may be dispersed using a disperser. Examples of the disperser include a sand grinder mill (e.g., a bead mill with pin), a high-speed impeller mill, a pebble mill, a roller mill, an attritor, and a colloid mill. A sand grinder mill and a high-speed impeller mill are particularly preferable. A preliminary dispersion treatment may be carried out. Examples of a disperser for use in the preliminary dispersion treatment include a ball mill, a three-roller mill, a kneader, and an extruder.

The inorganic fine particles are preferably as small as possible in the dispersive medium. The mass average diameter thereof is preferably from 10 to 120 nm, more preferably 20 to 100 nm, even more preferably from 30 to 90 nm, or especially preferably from 30 to 80 nm. By adjusting the average diameter of inorganic fine particles to be as small as 200 nm or less, it is possible to form a high refractive index or middle refractive index layer without loss of transparency.

[Curable Compound]

The curable compound is preferably selected from polymerizable compounds, and preferable examples of the polymerizable compound to be used include ionizing-radiation curable polyfunctional monomers and polyfunctional oligomers. Examples of the functional group of the polymerizable compound include photo-, electron ray- and radiation ray-polymerizable groups, and among these, photo-polymerizable groups are preferable. Examples of the photo-polymerizable group include unsaturated polymerizable groups such as (meth)acryloyl, vinyl, styryl and allyl groups; and among these, (meth)acryloyl groups are preferable.

In addition to the above-described components (the inorganic fine particles, the curable compound, the polymerization initiator, the photosensitizer, etc.), the high refractive index or middle index layer may contain other additives, such as a surfactant, an antistatic agent, a coupling agent, a thickener, an anti-coloring agent, a coloring agent (a pigment, a dye), a defoaming agent, a leveling agent, a flame retardant, an ultraviolet absorbing agent, an infrared absorbing agent, an adhesion promoter, a polymerization-inhibitor, an antioxidant, a surface modifier, conductive metal fine particles, and the like.

The high refractive index layer and the medium refractive index layer to be used in the invention are formed preferably as follows. Namely, after dispersing the inorganic fine particles in the dispersion medium as discussed above, a binder precursor required in matrix formation (for example, a polyfunctional monomer or a polyfunctional oligomer hardening under ionizing radiation as will be described above), a photo polymerization initiator and so on are added to the dispersion to give a coating composition for forming high refractive index layer and medium refractive index layer. Then this coating composition for forming high refractive index layer and medium refractive index layer is applied to a transparent support and hardened by the crosslinkage or polymerization of the ionizing radiation-hardening compound.

It is also preferable that the binder in the high refractive index layer and the medium refractive index layer undergoes crosslinkage or polymerization with the dispersing agent simultaneously with the application or thereafter. In the binder in the high refractive index layer and the medium refractive index layer thus formed, the preferable dispersing agent as described above undergoes crosslinkage or polymerization with the ionizing radiation-hardening (curing) polyfunctional monomer or polyfunctional oligomer and thus the anionic group of the dispersing agent is incorporated into the binder. In the binder in the high refractive index layer and the medium refractive index layer, moreover, the anionic group has a function of sustaining the inorganic fine particles in the dispersed state. The crosslinked or polymerized structure imparts a film-forming ability to the binder so as to improve the mechanical strength, chemical resistance and weatherability of the high refractive index layer and the medium refractive index layer.

In the formation of the high-refractive index, it is preferable to perform the crosslinkage or polymerization of the hardening compound in an atmosphere with an oxygen concentration of 10% by volume or less. By forming the layer in an atmosphere with an oxygen concentration of 10% by volume or less, the mechanical strength, chemical resistance and weatherability of the layer can be improved and, furthermore, the adhesiveness of the high refractive index layer to the layer adjacent to the high refractive index layer can be improved. It is preferable to form the layer by performing the crosslinkage or polymerization of the ionizing radiation-hardening compound in an atmosphere with an oxygen concentration of 6% by volume or less, still preferably 4% by volume or less, particularly preferably 2% by volume or less and most desirably 1% by volume or less.

As described above, the middle-refractive index layer may be prepared according to a same method by using the materials similar to those used in preparing the high-refractive index layer.

More specifically, the high-refractive or middle-refractive index layer may be prepared by selecting the types of fine particles and resins and deciding the ratio thereof and the main formulation so that the layers satisfy the relations between the thickness and the refractive index defined as the above-described formulas (I) and (II) respectively.

(Low-Refractive Index Layer)

The refractive index of the low-refractive index layer is preferably from 1.30 to 1.47. According to the embodiment wherein the surface film is constructed by a multilayer thin-film interference-type antireflective film (middle-refractive index layer/high-refractive index layer/low-refractive index layer), the refractive index of the low-refractive index layer is preferably is preferably from 1.33 to 1.38, or more preferably from 1.35 to 1.37. The refractive index in this range is preferred, because the reflectance can be reduced and the film strength can be maintained. As for the method of forming the low refractive index layer, a transparent inorganic oxide thin film formed by a chemical vapor deposition (CVD) method or a physical vapor deposition (PVD) method, particularly, a vacuum deposition method or a sputtering method, which are a kind of physical vapor deposition method, may be used, but a method by all-wet coating using a composition for the low refractive index layer is preferably employed.

Haze of the low-refractive index layer is preferably equal to less than 3%, more preferably equal to or less than 2%, or even more preferably equal to or less than 1%.

The strength of the antireflective film prepared by finally forming the low-refractive index layer is preferably H or more, more preferably 2H or more, or even more preferably 3H or more, in a pencil hardness test with a 500 g load.

The contact angle against water of the surface is 95° or more, in terms of improving the antifouling property of the antireflective film. More preferably, the contact angle is 102° or more. The contact angle of equal to or more than 105° may improve the antifouling property against finger-patterns remarkably, which is especially preferable. According to the preferable embodiment, the water contact angle is equal to or more than 102° and the surface free energy is equal to or less than 25 dyne/cm, more preferably equal to or less than 23 dyne/cm, or even more preferably equal to or less than 20 dyne/cm. According to the most preferable embodiment, the water contact angle is equal to or more than 105° and the surface free energy is equal to or less than 20 dyne/cm.

[Preparation of Low-Refractive Index Layer]

The low-refractive index layer may be prepared as follows: a coating liquid is prepared by dissolving or dispersing fluorine-containing antifouling agent having at least one polymerizable unsaturated group, fluorine-containing copolymer having at least one polymerizable unsaturated group, inorganic fine particles, and any desired ingredient(s), and is coated to a surface. At the same time of coating or after coating and drying, the crosslinking reaction or polymerization thereof is carried out under irradiation of an ionizing radiation (e.g., light and electron beam) or heat thereby to be hardened.

Especially, if the low-refractive index layer is prepared by the crosslinking reaction or polymerization of the ionizing-radiation curable compound, it is preferable to perform the crosslinkage or polymerization in an atmosphere with an oxygen concentration of 10% by volume or less. By forming the layer in an atmosphere with an oxygen concentration of 1% by volume or less, the mechanical strength and chemical resistance of the layer can be improved. It is more preferable to form the layer by performing the crosslinkage or polymerization in an atmosphere with an oxygen concentration of 0.5% by volume or less, still preferably 0.1% by volume or less, particularly preferably 0.05% by volume or less and most desirably 0.02% by volume or less.

For making oxygen concentration 1 vol % or less, it is preferred to replace the atmosphere (nitrogen concentration: about 79 vol %, oxygen concentration: about 21 vol %) with other gas, particularly preferably to replace with nitrogen (nitrogen purge).

For preparing a coating liquid to be used for preparing any of the above-described layers, any solvents similar to those to be used for preparing the coating liquid of the low-refractive layer may be used.

[Adhesive Layer]

The adhesive to be used for adhering the constituent layers may be a sticking agent or a UV adhesive, or the layers may be adhered to each other via a sticking agent layer or an adhesive layer with no specific limitation thereon. The sticking agent may be used, for example, for sticking a laminate of a patterned optically-anisotropic layer formed on a transparent support, and a laminate of a hard coat layer formed on a support. The adhesive may be used, for example, for adhering the patterned optically-anisotropic layer to the back of the support of the hard coat layer or the like, or may also be used for adhering the above-mentioned laminated via the back of the respective supports.

As the case may be, the above-mentioned, hard coat layer-forming coating composition may be applied to the surface of the patterned optically-anisotropic layer or to the back of the transparent support that supports the patterned optically-anisotropic layer, thereby directly forming the hard coat layer; and in this case, the adhesive is unnecessary.

For forming the adhesive layer, usable is a suitable adhesive; and the type of the adhesive is not specifically defined. The adhesive includes rubber adhesives, acrylic adhesives, silicone adhesives, urethane adhesives, vinyl alkyl ether adhesives, polyvinyl alcohol adhesives, polyvinylpyrrolidone adhesives, polyacrylamide adhesives, cellulose adhesives, etc.

In the adhesive layer, for example, the type and the amount of the base monomer and the copolymerizing monomer, the type and the amount of the crosslinking agent, and the type and the amount of other additives may be varied and controlled. For example, the molecular weight of the adhesive base polymer may be controlled, or monomers differing in the glass transition temperature and the coagulability may be copolymerized, and the amount of the crosslinking agent may be controlled to change the crosslinking degree of the formed layer; and such techniques are favorably applied to the invention.

Of the adhesives, preferred are those excellent in optical transparency, having suitable adhesive characteristics of wettability, coagulability and adhesiveness, and excellent in weather resistance and heat resistance. As those having such characteristics, preferred are acrylic adhesives. In particular, preferred are those formed of an adhesive that comprises an acrylic polymer and a crosslinking agent.

The acrylic adhesive comprises, as the base polymer therein, an acrylic polymer having a monomer unit of an alkyl(meth)acrylate as the main skeleton thereof. Alkyl(meth)acrylate means alkyl acrylate and/or alkyl methacrylate, and the same shall apply to the wording “(meth)” in the invention. As the alkyl(meth)acrylate to constitute the main skeleton of the acrylic polymer, exemplified are those with a linear or branched alkyl group having from 1 to 20 carbon atoms. For example, there are mentioned methyl(meth)acrylate, ethyl(meth)acrylate, propyl(meth)acrylate, butyl(meth)acrylate, 2-ethylhexyl(meth)acrylate, isooctyl(meth)acrylate, isononyl(meth)acrylate, isomyristyl(meth)acrylate, lauryl(meth)acrylate, etc. These may be used either singly or as combined. Preferably, the mean carbon number of these alkyl groups is from 3 to 9.

Of the above-mentioned acrylic polymers, preferred for the base polymer are acrylic polymers having a monomer unit of an alkyl(meth)acrylate as the main skeleton thereof, from the viewpoint of lowering the equilibrium moisture regain of the adhesive. In general, in the alkyl(meth)acrylate, the alkyl group is preferably a linear or branched alkyl group having from 3 to 9 carbon atoms, more preferably from 4 to 8 carbon atoms for the practicability of the adhesive and from the viewpoint of the above-mentioned optical transparency, the suitable wettability, coagulability and adhesiveness, the weather resistance and the heat resistance thereof. Of those alkyl groups, more preferred is an alkyl group having a larger carbon number as the adhesive could be more hydrophobic and the equilibrium moisture regain thereof could be lowered. The alkyl(meth)acrylate of the type includes, for example, butyl(meth)acrylate, isooctyl(meth)acrylate. Of those, more preferred is isooctyl(meth)acrylate having higher hydrophobicity.

One or more copolymerizing monomers may be introduced into the acrylic polymer for the purpose of enhancing the adhesiveness and the heat resistance of the adhesive. Specific examples of the comonomers include, for example, hydroxyl group-containing monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, 4-(hydroxymethylcyclohexyl)(meth)acrylate, etc.; carboxyl group-containing monomers such as (meth)acrylic acid, carbon/ethyl(meth)acrylate, carboxypentyl(meth)acrylate, itaconic acid, maleic acid, fumaric acid, crotonic acid, etc.; acid anhydride group-containing monomers such as maleic anhydride, itaconic anhydride, etc.; acrylic acid-caprolactone adduct; sulfonic acid group-containing monomers such as styrenesulfonic acid, allylsulfonic acid, 2-(meth)acrylamide-2-methylpropanesulfonic acid, (meth)acrylamide-propanesulfonic acid, sulfopropyl(meth)acrylate, (meth)acryloyloxynaphthalenesulfonic acid, etc.; phosphoric acid group-containing monomers such as 2-hydroxyethylacryloyl phosphate, etc.

As examples of monomers for property modification, there are also mentioned (N-substituted)amide monomers such s (meth)acrylamide, N,N-dimethyl(meth)acrylamide, N-butyl(meth)acrylamide, N-methylol(meth)acrylamide, N-methylolpropane(meth)acrylamide, etc.; alkylaminoalkyl(meth)acrylate monomers such as aminoethyl(meth)acrylate, N,N-dimethylaminoethyl(meth)acrylate, tert-butylaminoethyl(meth)acrylate, etc.; alkoxyalkyl(meth)acrylate monomers such as methoxyethyl(meth)acrylate, ethoxyethyl(meth)acrylate, etc.; succinimide monomers such as N-(meth)acryloyloxymethylsuccinimide, N-(meth)acryloyl-6-oxyhexamethylenesuccinimide, N-(meth)acryloyl-8-oxyoctamethylenesuccinimide, N-acryloylmorpholine, etc.; maleimide monomers such as N-cyclohexylmaleimide, N-isopropylmaleimide, N-laurylmaleimide, N-phenylmaleimide, etc.; itaconimide monomers such as N-methylitaconimide, N-ethylitaconimide, N-butylitaconimide, N-octylitaconimide, N-2-ethylhexylitaconimide, N-cyclohexylitaconimide, N-laurylitaconimide, etc.

Further, as monomers for modification, also usable here are vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarbonamides, styrene, α-methylstyrene, N-vinylcaprolactam, etc.; cyanoacrylate monomers such as acrylonitrile, methacrylonitrile, etc.; epoxy group-containing acrylic monomers such as glycidyl(meth)acrylate, etc.; glycolic acryl ester monomers such as polyethylene glycol(meth)acrylate, polypropylene glycol(meth)acrylate, methoxyethylene glycol(meth)acrylate, methoxypolypropylene glycol(meth)acrylate, etc.; acrylate monomers such as tetrahydrofurfuryl(meth)acrylate, fluoro(meth)acrylates, silicone(meth)acrylate, 2-methoxyethyl acrylate, etc.

Not specifically defined, the proportion of the comonomer in the acrylic polymer is preferably from 0 to 30% or so in terms of the ratio by weight to all the constituent monomers, more preferably from 0.1 to 15% or so.

Of those comonomers, preferred for use herein are hydroxyl group-containing monomers, carboxyl group-containing monomers and acid anhydride group-containing monomers, from the viewpoint of the adhesiveness to liquid-crystal cell and the durability of the adhesive for use in optical films. These monomers are to be the starting point with a crosslinking agent. Hydroxyl group-containing monomers, carboxyl group-containing monomers and acid anhydride group-containing monomers are rich in the reactivity with an intermolecular crosslinking agent and are therefore preferably used here for enhancing the coagulability and the heat resistance of the adhesive layer to be formed. For example, as the hydroxyl group-containing monomer for use herein, 4-hydroxybutyl(meth)acrylate is preferred to 2-hydroxyethyl(meth)acrylate and 6-hydroxyhexyl(meth)acrylate is more preferred thereto, since in the former, the alkyl group of the hydroxyalkyl group is higher. In case where a hydroxyl group-containing monomer is used as a comonomer, the ratio by weight thereof is preferably from 0.01 to 5% relative to all the constituent monomers, more preferably from 0.01 to 3%. In case where a carboxyl group-containing monomer is used as the comonomer, the ratio by weight thereof is preferably from 0.01 to 10% relative to all the constituent monomers, more preferably from 0.01 to 7%.

The mean molecular weight of the acrylic polymer is not specifically defined. Preferably, the weight-average molecular weight of the polymer is from 100,000 to 2,500,000 or so. The acrylic polymer may be produced according to various known methods, for which, for example, suitably employed are radical polymerization methods of a bulk polymerization method, a solution polymerization method, a suspension polymerization method, etc. As the radical polymerization initiator, usable here are any known, azo-type or peroxide-type ones. The reaction temperature is generally from 50 to 80 degrees Celsius or so, and the reaction time may be from 1 to 8 hours. Of the above-mentioned production methods, preferred is a solution polymerization method. As the solvent for the acrylic polymer, in general, ethyl acetate, toluene or the like may be sued. The solution concentration is generally from 20 to 80% by weight.

Preferably, the adhesive is in the form of an adhesive composition containing a crosslinking agent. As the polyfunctional compound capable of being incorporated in the adhesive, there are mentioned an organic crosslinking agent and a polyfunctional metal chelate. The organic crosslinking agent includes epoxy-type crosslinking agents, isocyanate-type crosslinking agents, imine-type crosslinking agents, peroxide-type crosslinking agents, etc. One or more of these crosslinking agents may be used here either singly or as combined. As the organic crosslinking agent, preferred are isocyanate-type crosslinking agents. Preferably, the isocyanate-type crosslinking agent is combined with a peroxide-type crosslinking agent. The polyfunctional metal chelate has a structure where a polyvalent metal bonds to an organic compound in a mode of covalent bonding or coordinate bonding. The polyvalent metal atom includes Al, Cr, Zr, Co, Cu, Fe, Ni, V, Zn, In, Ca, Mg, Mn, Y, Ce, Sr, Ba, Mo, La, Sn, Ti, etc. The atom in the organic compound to bond to the metal via covalent bonding or coordinate bonding includes an oxygen atom, etc.; and the organic compound includes alkyl esters, alcohol compounds, carboxylic acid compounds, ether compounds, ketone compounds, etc.

Not specifically defined, the blend ratio of the base polymer such as acrylic polymer or the like and the crosslinking agent may be generally such that the amount of the crosslinking agent (as solid content) is preferably from 0.001 to 20 parts by weight or so, relative to 100 parts by weight of the base polymer (as solid content), more preferably from 0.01 to 15 parts by weight. As the crosslinking agent, preferred are isocyanate-type crosslinking agents and peroxide-type crosslinking agents. The amount of the peroxide-type crosslinking agent to be used here is preferably from 0.01 to 3 parts by weight or so relative to 100 parts by weight of the base polymer (as solid content), more preferably from 0.02 to 2.5 parts by weight or so, even more preferably from 0.05 to 2.0 parts by weight. Also preferably the amount of the isocyanate-type crosslinking agent to be used here is preferably from 0.001 to 2 parts by weight or so relative to 100 parts by weight of the base polymer (as solid content), more preferably from 0.01 to 1.5 parts by weight or so. Preferably, the isocyanate-type crosslinking agent and the peroxide-type crosslinking agent that can be used here each within the range defined in the above are combined for use herein.

If desired, various additives such as a silane coupling agent, a tackifier, a plasticizer, glass fibers, glass beads, an antioxidant, a UV absorbent, transparent fine particles and the like may be added to the adhesive, not overstepping the scope and the spirit of the invention.

As the additive, preferred is a silane coupling agent. Preferably, the amount of the silane coupling agent to be added (as solid content) is from 0.001 to 10 parts by weight or so relative to 100 parts by weight of the base polymer (as solid content), more preferably from 0.005 to 5 parts by weight or so. As the silane coupling agent, herein usable is any known one with no specific limitation. For example, there are exemplified epoxy group-containing silane coupling agents such as γ-glycidoxypropyltrimethoxysilane, γ-glycidoxypropyltriethoxysilane, γ-glycidoxypropylmethyldiethoxysilane, 2-(3,4-epoxycyclohexyl)ethyltrimethoxysilane, etc.; amino group-containing silane coupling agents such as 3-aminopropyltrimethoxysilane, N-2-(aminoethyl)-3-aminopropylmethyldimethoxysilane, 3-triethoxysilyl-N-(1,3-dimethylbutylidene)propylamine, etc.; (meth)acryl group-containing silane coupling agents such as 3-acryloxypropyltrimethoxysilane, 3-methacryloxypropyltriethoxysilane, etc.; isocyanate group-containing silane coupling agents such as 3-isocyanatopropyltriethoxysilane, etc.

As the base polymer for rubber-type adhesives, for example, there are mentioned natural rubber, isoprene rubber, styrene-butadiene rubber, regenerated rubber, polyisobutylene rubber, styrene-isoprene-styrene rubber, styrene-butadiene-styrene rubber, etc. As the base polymer for silicone-type adhesives, for example, there are mentioned dimethylpolysiloxane, diphenylpolysiloxane, etc. These base polymers may be modified to have a functional group such as a carboxyl group or the like introduced thereinto, and such modified base polymers are also usable here.

Apart from those mentioned above, also usable in the invention are other types of sticking agents and adhesives, such as UV-curable adhesives or the like that are cured at a specific functional group therein.

The substrate film (support) may also serve as a transparent support for the optically-anisotropic layer formed thereon. Examples of the polymer film usable as the substrate film are the same as those of the transparent support for the optically-anisotropic layer mentioned above, and the preferred range thereof is also the same as that of the latter.

### Liquid-Crystal Cell:

The liquid-crystal cell for use in the 3D image display device to be used in the 3D image display system of the invention is preferably a VA-mode, OCB-mode, IPS-mode or TN-mode cell, to which, however, the invention is not limited.

In the TN-mode liquid-crystal cell, rod-shaped liquid-crystal molecules are aligned substantially horizontally and are further twisted at from 60 to 120° under the condition of no voltage application thereto. The TN-mode liquid-crystal cell is most used in color TFT liquid-crystal display devices, and is described in many publications.

In the VA-mode liquid-crystal cell, rod-shaped liquid-crystal molecules are aligned substantially vertically under the condition of no voltage application thereto. The VA-mode liquid-crystal cell includes (1) a narrowly-defined VA-mode liquid-crystal cell where rod-shaped liquid-crystal molecules are aligned substantially vertically under the condition of no voltage application thereto but are aligned substantially horizontally under the condition of voltage application thereto (as described in JP-A 2-176625), and in addition thereto, further includes (2) an MVA-mode liquid-crystal cell in which the VA-mode has been multidomained (as described in SID97, Digest of Tech. Papers (preprints) 28 (1997) 845), (3) an n-ASM mode liquid-crystal cell in which rod-shaped liquid-crystal molecules are aligned substantially vertically under the condition of no voltage application thereto and are aligned in a twisted multidomain alignment under the condition of voltage application thereto (as described in preprints of Discussion in Japanese Liquid Crystal Society, 58-59 (1998)), and (4) a SURVIVAL-mode liquid-crystal cell (as announced in LCD International 98). In addition, the liquid-crystal cell may be in any mode of a PVA (patterned vertical alignment)-mode cell, an OP (optical alignment)-mode cell or a PSA (polymer-sustained alignment)-mode cell. The details of these modes are described in JP-A 2006-215326 and JP-T 2008-538819.

In the IPS-mode liquid-crystal cell, rod-shaped liquid-crystal molecules are aligned substantially horizontally to the substrate, and when an electric field parallel to the substrate face is given thereto, the liquid-crystal molecules respond planarly thereto. In the IPS-mode liquid-crystal cell, the panel is in a black display state under the condition of no electric field application thereto, and the absorption axes of the pair of upper and lower polarizers are perpendicular to each other. A method of using an optical compensatory sheet to reduce the light leakage in oblique directions at the time of black level of display to thereby expand the viewing angle is disclosed in JP-A 10-54982, 11-202323, 9-292522, 11-133408, 11-305217, 10-307291, etc.

### 3. Polarizing Plate for 3D Image Display System:

In the 3D image display system of the invention, stereoscopic images of so-called 3D visions are recognized by viewers through a polarizer. One embodiment of the polarizer is polarized glasses. In the above-mentioned embodiment where right-eye and left-eye circularly-polarized images are formed via a retardation plate, used are circularly-polarized glasses; and in the embodiment where linearly-polarized images are formed, used are linearly-polarized glasses. Of these embodiments, the system is preferably so designed that the right-eye image light outputted from any of the first and second retardation domains of the optically-anisotropic layer runs into the right-eye glass but is blocked by the left-eye glass while the left-eye image light outputted from the other of the first and second retardation domains runs through the left-eye glass but is blocked by the right-eye glass.

The polarized glasses each contain a retardation function layer and a linear polarizing element. In these, any other member having the same function as that of the linear polarizing element may also be used.

The concrete configurations of the 3D image display system of the invention, including polarized glasses, are described below. First, the retardation plate is so designed as to have the above-mentioned first retardation domain and the above-mentioned second retardation domain that differ in the polarized light conversion function on multiple first lines and multiple second lines alternately repeated in the image display panel (for example, when the lines run in the horizontal direction, the domains may be on the odd-numbered lines and even-numbered lines in the horizontal direction, and when the lines run in the vertical direction, the domains may be on the odd-numbered lines and the even-numbered lines in the vertical direction). In case where a circularly-polarized light is used for display, the retardation of the above-mentioned first retardation domain and that of the second retardation domain are preferably both λ/4, and more preferably, the slow axes of the first retardation domain and the second retardation domain are perpendicular to each other.

In case where a circularly-polarized light is used for display, preferably, the retardation of the above-mentioned first retardation domain and that of the second retardation domain are both λ/4, the right-eye image is displayed on the odd-numbered lines of the image display panel, and when the slow axis in the odd-lined retardation domain is in the direction of 45 degrees, a λ/4 plate is arranged in both the right-eye glass and the left-eye glass of the polarized glasses, and the λ/4 plate of the right-eye glass of the polarized glasses may be fixed concretely at about 45 degrees. In the above-mentioned situation, similarly, the left-eye image is displayed on the even-numbered lines of the image display panel, and when the slow axis of the even-numbered line retardation domain is in the direction of 135 degrees, then the slow axis of the left-eye glass of the polarized glasses may be fixed concretely at about 135 degrees.

Further, from the viewpoint that a circularly-polarized image light is once outputted via the patterned retardation film and its polarization state is returned to the original state through the polarized eyeglasses, the angle of the slow axis to be fixed of the right-eye glass in the above-mentioned case is preferably nearer to accurately 45 degrees in the horizontal direction. Also preferably, the angle of the slow axis to be fixed of the left-eye glass is nearer to accurately 135 degrees (or -45 degrees) in the horizontal direction.

For example, in a case where the image display panel is a liquid-crystal display panel, in general, it is desirable that the absorption axis direction of the panel front-side polarizer is in the horizontal direction and the absorption axis of the linear polarizing element of the polarized glasses is in the direction perpendicular to the absorption axis direction of the front-side polarizer, and more preferably, the absorption axis of the linear polarizing element of the polarized glasses is in the vertical direction.

Also preferably, the absorption axis direction of the liquid-crystal display panel front-side polarizer is at an angle of 45 degrees to each slow axis of the odd-numbered line retardation domain and the even-numbered line retardation domain of the patterned retardation film from the viewpoint of the polarized light conversion efficiency of the system.

Preferred configurations of the polarized glasses as well as those of the patterned retardation film and the liquid-crystal display device are disclosed in, for example, JP-A 2004-170693.

As examples of polarized glasses usable here, there are mentioned those described in JP-A 2004-170693, and as commercial products thereof, there are mentioned accessories to Zalman's ZM-M220 W.

### EXAMPLES

The invention is described in more detail with reference to the following Examples. In the following Examples, the material used, its amount and ratio, the details of the treatment and the treatment process may be suitably modified or changed not overstepping the spirit and the scope of the invention. Accordingly, the invention should not be limitatively interpreted by the Examples mentioned below.

### Example 1

### Production of Transparent Support A

The following ingredients were put into a mixing tank and dissolved by stirring under heat, thereby preparing a cellulose acylate solution A.

Formulation of Cellulose Acylate Solution A

| | |
|---|---|
| Cellulose acylate having a degree of | 100 parts by mass |
| substitution of 2.86 | |
| Triphenyl phosphate (plasticizer) | 7.8 parts by mass |
| Biphenyldiphenyl phosphate (plasticizer) | 3.9 parts by mass |
| Methylene chloride (first solvent) | 300 parts by mass |
| Methanol (second solvent) | 54 parts by mass |
| 1-Butanol | 11 parts by mass |

The following ingredients were put into a different mixing tank and dissolved by stirring under heat, thereby preparing an additive solution B.

Formulation of Additive Solution B

| | | |
|---|---|---|
| Compound B1 mentioned below (Re reducer) | 40 | parts by mass |
| Compound B2 mentioned below (wavelength dispersion | 4 | parts by mass |
| characteristics-controlling agent) | | |
| Methylene chloride (first solvent) | 80 | parts by mass |
| Methanol (second solvent) | 20 | parts by mass |

Compound B1: 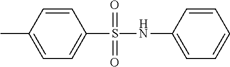 [SMILES: Cc1ccc(S(=O)(=O)Nc2ccccc2)cc1]
Compound B2:

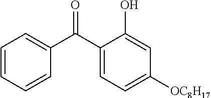

### <<Production of Cellulose Acetate Transparent Support>>

40 parts by mass of the additive solution B was added to 477 parts by mass of the cellulose acylate solution A, and fully stirred to prepare a dope. The dope was cast onto a drum cooled at 0 degrees Celsius, via a casting mouth. When the solvent content therein reached 70% by mass, the formed film was peeled, and both sides in the width direction thereof were fixed with a pin tenter (described in FIG. 3 in JP-A 4-1009). When the solvent content in the film was from 3 to 5% by mass and while the distance of the pin tenter was so controlled that the draw ratio of the film could be 3% in the transverse direction (in the direction transverse to the machine direction), the film was dried. Subsequently, the film was conveyed between rolls of a heat treatment apparatus and was thus further dried, thereby giving a cellulose acetate protective film (transparent support A) having a thickness of 60 micro meters. The transparent support A does not contain a UV absorbent, and Re(550) thereof was 0 nm and Rth(550) thereof was 12.3 nm.

### <<Alkali Saponification Treatment>>

The cellulose acetate transparent support A was made to pass through dielectric heating rolls at a temperature of 60 degrees Celsius to thereby elevate the film surface temperature up to 40 degrees Celsius, and then using a bar coater, an alkali solution having the formulation mentioned below was applied onto one surface of the film in a coating amount of 14 ml/m². Then, this was heated at 110 degrees Celsius and conveyed below a steam-type far IR heater made by Noritake Company Ltd., for 10 seconds. Subsequently, also using a bar coater, pure water was applied to the film in an amount of 3 ml/m². Next, this was washed with water using a fountain coater, and then dewatered using an air knife, and this operation was repeated three times. Subsequently, the film was conveyed in a drying zone at 70 degrees Celsius for 10 seconds, and dried therein thereby giving an alkali-saponified cellulose acetate transparent support A.

Formulation of Alkali Solution (part by mass)

| | |
|---|---|
| Potassium hydroxide | 4.7 parts by mass |
| Water | 15.8 parts by mass |
| Isopropanol | 63.7 parts by mass |
| Surfactant SF-1: C₁₄H₂₉O(CH₂CH₂O)₂₀H | 1.0 part by mass |
| Propylene glycol | 14.8 parts by mass |

<Production of Transparent Support with Rubbed Alignment Layer>

Using a wire bar #8, a rubbing alignment layer coating liquid having the formulation mentioned below was continuously applied onto the saponified surface of the previously-produced support. This was dried with hot air at 60 degrees Celsius for 60 seconds and then with hot air at 100 degrees Celsius for 120 seconds, thereby forming an alignment layer. Next, a stripe mask, in which the lateral stripe width of the transmitting part is 285 micro meters and the lateral stripe width of the blocking part is 285 micro meters, was set on the rubbing alignment layer, and in air at room temperature, this was exposed to UV rays for 4 seconds, using an air-cooled metal halide lamp (by Eye Graphics), of which the lighting intensity in a UV-C region is 2.5 mW/cm², to thereby decompose the photo-acid-generating agent to generate an acid compound, thereby forming an alignment for first retardation domain. Subsequently, this was rubbed once back and force in one direction at 500 rpm, kept at an angle of 45° relative to the stripe of the stripe mask, thereby producing a transparent support with rubbed alignment layer. The thickness of the alignment layer was 0.5 micro meters.

Formulation for Alignment layer Forming Coating Liquid

| | | |
|---|---|---|
| Polymer material for alignment layer (PVA103, | 3.9 | parts by mass |
| polyvinyl alcohol by Kuraray) | | |
| Photo-acid-generating agent (S-2) | 0.1 | parts by mass |
| Methanol | 36 | parts by mass |
| Water | 60 | parts by mass |

Photo-acid-generating agent S-2:

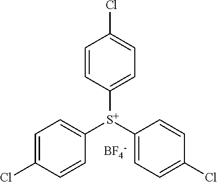

### <Formation of Patterned Optically-Anisotropic Layer A>

Using a bar coater, the coating liquid for optically-anisotropic layer mentioned below was applied onto the support in a coating amount of 4 ml/m². Next, this was heated and ripened at a surface temperature of 110 degrees Celsius for 2 minutes, then cooled to 80 degrees Celsius, and using an air-cooled metal halide lamp of 20 mW/cm² (by Eye Graphics) in air, this was irradiated with UV rays for 20 seconds to fix the alignment state, thereby forming a patterned optically-anisotropic layer A. In the mask-exposed area (first retardation domain), the discotic liquid crystal was vertically aligned with the slow axis direction kept parallel to the rubbing direction, and in the non-exposed area (second retardation domain), the liquid crystal was aligned vertically with the slow axis direction kept perpendicular to the rubbing direction. The thickness of the optically-anisotropic layer was 0.9 micro meters.

Formulation of Coating Liquid for Optically-Anisotropic Layer

| | | |
|---|---|---|
| Discotic liquid crystal E-1 | 100 | parts by mass |
| Alignment layer-side interface aligning agent (II-1) | 3.0 | parts by mass |
| Air-side interface aligning agent (P-1) | 0.4 | parts by mass |
| Photopolymerization initiator (Irgacure 907, by Ciba Specialty Chemicals) | 3.0 | parts by mass |
| Sensitizer (Kayacure DETX, by Nippon Kayaku) | 1.0 | part by mass |
| Methyl ethyl ketone | 400 | parts by mass |

Discotic Liquid Crystal E-1: 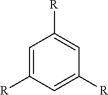 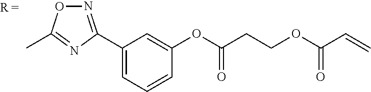 [SMILES: C=CC(=O)OCCC(=O)Oc1cccc(-c2noc(C)n2)c1]
Alignment layer-Side Interface Aligning Agent (II-1): 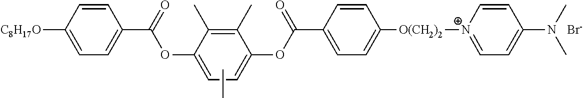
Air-Side Interface Aligning Agent (P-1):

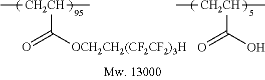

The first retardation domain and the second retardation domain of the thus-formed, patterned optically-anisotropic layer A were analyzed according to TOF-SIMS (time-of-flight secondary ion mass spectrometry with ION-TOF's TOF-SIMS V), which confirmed that the abundance ratio of the photo-acid-generating agent S-2 in the alignment layer corresponding to the first retardation domain and the second retardation domain was 8/92, or that is, in the first retardation domain, S-2 was almost decomposed. In addition, in the optically-anisotropic layer, it was also confirmed that the cation of II-1 and the anion BF₄⁻ of the acid HBF₄ generated from the photo-acid-generating agent S-2 existed in the air-side interface of the first retardation domain. In the air-side interface of the second retardation domain, these ions were not almost observed, from which it was found that the cation of II-1 and Br⁻ existed in the vicinity of the interface of the alignment layer. Regarding the abundance ratio of the ions in the air-side interface, the cation of II-1 was in a ratio of 93/7 and BF₄⁻ was in a ratio of 90/10. From this, it is understood that, in the second retardation domain, the alignment layer-side interface aligning agent (II-1) was localized in the alignment layer interface, but in the first retardation domain, the locality reduced and the aligning agent diffused also in the air-side interface, and that, through anion exchange between the generated acid HBF₄ and II-1, the diffusion of the II-1 cation was promoted in the first retardation domain.

The patterned optically-anisotropic layer A was put between two polarizers that had been combined orthogonally in a manner so that the slow axis of any one of the first retardation domain or the second retardation domain of the layer was parallel to the polarization axis of any one of the polarizers, and further, a sensitive color plate having a retardation of 530 nm was put on the optically-anisotropic layer in a manner so that the slow axis of the plate was at an angle of 45° relative to the polarization axis of the polarizers. Next, the optically-anisotropic layer was rotated by +45°, and the condition was observed with a polarizing microscope (Nikon's ECLIPE E600 W POL). As obvious from the observed result shown in FIG. 9, when the layer was rotated by +45°, the slow axis of the first retardation domain became parallel to the slow axis of the sensitive color plate, and therefore the retardation was larger than 530 nm and the color changed to blue (the dark part in the black and white illustration). On the other hand, since the slow axis of the second retardation domain was perpendicular to the slow axis of the sensitive color plate, the retardation became smaller than 530 nm and the color changed to white (the pale part in the black and white illustration).

(Evaluation of Optically-Anisotropic Layer)

The formed optically-anisotropic layer was peeled from the transparent support, and then, using KOBRA-21ADH (by Oji Scientific Instruments) and according to the above-mentioned method, the tilt angle of the discotic liquid crystal in the alignment layer interface, the tilt angle of the discotic liquid crystal in the air-side interface, the direction of the slow axis, Re and Rth of the layer were measured. The results are shown in Table 1. In the following Table, “vertical” means a tilt angle of from 70° to 90°.

The results shown in Table 1 confirm the following: When a PVA-base rubbing alignment layer containing a photo-acid-generating agent is mask-photoexposed in the presence of a pyridinium salt compound and a fluoroaliphatic group-containing copolymer, and then rubbed in one direction, and when a discotic liquid crystal is aligned on the thus-rubbed alignment layer, then a patterned optically-anisotropic layer is formed in which the liquid crystal is vertically aligned and which has a first retardation domain and a second retardation domain with their slow axes kept perpendicular to each other.

### <Production of Surface Film A>

### <<Formation of Antireflection Layer>>

### [Preparation of Coating Liquid A for Hard Coat Layer]

The following ingredients were put into a mixing tank and stirred to prepare a hard coat layer coating liquid A.

100 parts by mass of cyclohexanone, 750 parts by mass of a partially caprolactone-modified polyfunctional acrylate (DPCA-20, by Nippon Kayaku), 200 parts by mass of silica sol (MIBK-ST, by Nissan Chemical), and 50 parts by mass of a photopolymerization initiator (Irgacure 184, by Ciba Specialty Chemicals) were added to 900 parts by mass of methyl ethyl ketone, and stirred. The mixture was filtered through a polypropylene filter having a pore size of 0.4 micro meters to prepare a coating liquid for hard coat layer.

[Preparation of Coating Liquid A for Middle Refractive Index Layer]

1.5 parts by mass of a mixture of dipentaerythritol pentaacrylate and dipentaerythritol hexaacrylate (DPHA), 0.05 parts by mass of a photopolymerization initiator (Irgacure 907, by Ciba Specialty Chemicals), 66.6 parts by mass of methyl ethyl ketone, 7.7 parts by mass of methyl isobutyl ketone and 19.1 parts by mass of cyclohexanone were added to 5.1 parts by mass of a ZrO₂ fine particles-containing hard coat agent (Desolight Z7404 [having a refractive index of 1.72, a solid concentration of 60% by mass, a content of zirconium oxide fine particles of 70% by mass (relative to solid fraction), a mean particle diameter of zirconium oxide fine particles of about 20 nm, a solvent composition of methyl isobutyl ketone/methyl ethyl ketone of 9/1, by JSR], and stirred. After fully stirred, the mixture was filtered through a polypropylene filter having a pore size of 0.4 micro meters to prepare a coating liquid A for middle refractive index layer.

[Preparation of Coating Liquid B for Middle Refractive Index Layer]

4.5 parts by mass of a mixture of dipentaerythritol pentaacrylate and dipentaerythritol hexaacrylate (DPHA), 0.14 parts by mass of a photopolymerization initiator (Irgacure 907, by Ciba Specialty Chemicals), 66.5 parts by mass of methyl ethyl ketone, 9.5 parts by mass of methyl isobutyl ketone and 19.0 parts by mass of cyclohexanone were stirred. After fully stirred, the mixture was filtered through a polypropylene filter having a pore size of 0.4 micro meters to prepare a coating liquid B for middle refractive index layer.

The coating liquid A for middle refractive index layer and the coating liquid B for middle refractive index layer were suitably mixed to give a coating liquid for middle refractive index layer capable of having a refractive index of 1.36 and capable of forming a layer having a thickness of 90 micro meters.

[Preparation of Coating Liquid for High Refractive Index Layer]

0.75 parts by mass of a mixture of dipentaerythritol pentaacrylate and dipentaerythritol hexaacrylate (DPHA), 62.0 parts by mass of methyl ethyl ketone, 3.4 parts by mass of methyl isobutyl ketone and 1.1 parts by mass of cyclohexanone were added to 14.4 parts by mass of a ZrO₂ fine particles-containing hard coat agent (Desolight Z7404 [having a refractive index of 1.72, a solid concentration of 60% by mass, a content of zirconium oxide fine particles of 70% by mass (relative to solid fraction), a mean particle diameter of zirconium oxide fine particles of about 20 nm, a solvent composition of methyl isobutyl ketone/methyl ethyl ketone of 9/1, and containing a photopolymerization initiator, by JSR], and stirred. After fully stirred, the mixture was filtered through a polypropylene filter having a pore size of 0.4 micro meters to prepare a coating liquid C for high refractive index layer.

[Preparation of Coating Liquid for Low Refractive Index Layer]

### (Synthesis of Perfluoro-Olefin Copolymer (1))

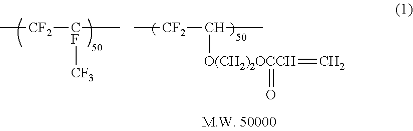

In the above structural formula, 50/50 is a ratio by mol.

40 ml of ethyl acetate, 14.7 g of hydroxyethyl vinyl ether and 0.55 g of dilauroyl peroxide were put into an autoclave having an inner capacity of 100 ml and equipped with a stainless stirrer, and the system was degassed and purged with nitrogen gas. Further, 25 g of hexafluoropropylene (HFP) was introduced into the autoclave and heated up to 65 degrees Celsius. The pressure when the temperature inside the autoclave reached 65 degrees Celsius was 0.53 MPa (5.4 kg/cm²). While kept at the temperature, the reaction was continued for 8 hours, and when the pressure reached 0.31 MPa (3.2 kg/cm²), the heating was stopped and the system was left cooled. After the inner temperature lowered to room temperature, the unreacted monomer was expelled away, and the autoclave was opened to take out the reaction liquid. The obtained reaction liquid was put into a large excessive amount of hexane, and the solvent was removed through decantation to thereby take out the precipitated polymer. Further, the polymer was dissolved in a small amount of ethyl acetate and reprecipitated twice from hexane to thereby completely remove the remaining monomer. After dried, 28 g of a polymer was obtained. Next, 20 g of the polymer was dissolved in 100 ml of N,N-dimethylacetamide, and with cooling with ice, 11.4 g of acrylic acid chloride was dropwise added thereto, and then stirred at room temperature for 10 hours. Ethyl acetate was added to the reaction liquid, then this was washed with water, and the organic layer was extracted out and concentrated. The resulting polymer was reprecipitated from hexane to give 19 g of a perfluoro-olefin copolymer (1). The refractive index of the thus-obtained polymer was 1.422, and the mass-average molecular weight thereof was 50000.

[Preparation of Hollow Silica Particles Dispersion A]

30 parts by mass of acryloyloxypropyltrimethoxysilane and 1.51 parts by mass of diisopropoxyaluminiumethyl acetate were added to and mixed with 500 parts by mass of a sol of hollow silica fine particles (isopropyl alcohol silica sol, Catalysts & Chemicals Industries' CS60-IPA, having a mean particle diameter of 60 nm, a shell thickness of 10 nm, a silica concentration of 20% by mass, a refractive index of silica particles of 1.31), and then 9 parts by mass of ion-exchanged water was added thereto. After reacted at 60 degrees Celsius for 8 hours, this was cooled to room temperature, then 1.8 parts by mass of acetylacetone was added thereto to prepare a dispersion. Subsequently, while cyclohexanone was added thereto until the silica content became almost constant, the system was processed for solvent substitution through reduced pressure distillation under a pressure of 30 Torr, thereby giving a dispersion A having a solid concentration of 18.2% by mass through final concentration control. The remaining IPA amount in the thus-obtained dispersion A was at most 0.5% by mass, as found through gas chromatography.

[Preparation of Coating Liquid A for Low Refractive Index Layer]

The following ingredients were mixed and dissolved in methyl ethyl ketone to prepare a coating liquid A for low refractive index layer having a solid concentration of 5% by mass. The amount of each ingredient shown below is the ratio of the solid content of each ingredient, in terms of % by mass relative to the total amount of the coating liquid.

| | |
|---|---|
| P-1: perfluoro-olefin copolymer (1) | 15% by mass |
| DPHA: mixture of dipentaerythritol pentaacrylate and | 7% by mass |
| dipentaerythritol hexaacrylate (by Nippon Kayaku) | |
| MF1: fluorine-containing unsaturated compound mentioned below, described in | 5% by mass |
| Examples in WO2003/022906 (having a weight-average molecular weight of 1600) | |
| M-1: Nippon Kayaku's KAYARAD DPHA | 20% by mass |
| Dispersion A: hollow silica particles dispersion A mentioned above (sol of hollow | 50% by mass |
| silica particles sueface-modified with acryloyloxypropyltrimethoxysilane, having | |
| a solid concentration of 18.2% | |
| Irg 127: photopolymerization initiator Irgacure 127 (by Ciba Speciality Chemicals) | 3% by mass |

Fluorine-Containing Unsaturated Compound:

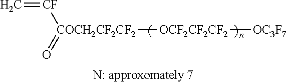

TD80UL (by FUJIFILM, having Re/Rth=2/40 at 550 nm) was used as a support A for surface film; and using a gravure coater, the hard coat layer coating liquid A having the composition mentioned above was applied onto the surface film support A. TD80UL contains a UV absorbent. This was dried at 100 degrees Celsius. While purged with nitrogen so that the atmosphere could have an oxygen concentration of not more than 1.0% by volume, the coating layer was cured through exposure to UV rays, using an air-cooled, 160 W/cm metal halide lamp (by Eye Graphics) at a lighting intensity of 400 mW/cm² and at a dose of 150 mJ/cm², thereby forming a hard coat layer A having a thickness of 12 micro meters.

Further, the middle refractive index layer coating liquid, the high refractive index layer coating liquid and the low refractive index layer coating liquid A were applied to the above, using a gravure coater. The drying condition for the middle refractive index layer was at 90 degrees Celsius and for 30 seconds. The UV curing condition was as follows: While purged with nitrogen so that the atmosphere could have an oxygen concentration of not more than 1.0% by volume, the coating layer was cured through exposure to UV rays, using an air-cooled, 180 W/cm metal halide lamp (by Eye Graphics) at a lighting intensity of 300 mW/cm2 and at a dose of 240 mJ/cm².

The drying condition for the high refractive index layer was at 90 degrees Celsius and for 30 seconds. The UV curing condition was as follows: While purged with nitrogen so that the atmosphere could have an oxygen concentration of not more than 1.0% by volume, the coating layer was cured through exposure to UV rays, using an air-cooled, 240 W/cm metal halide lamp (by Eye Graphics) at a lighting intensity of 300 mW/cm² and at a dose of 240 mJ/cm².

The drying condition for the low refractive index layer was at 90 degrees Celsius and for 30 seconds. The UV curing condition was as follows: While purged with nitrogen so that the atmosphere could have an oxygen concentration of not more than 0.1% by volume, the coating layer was cured through exposure to UV rays, using an air-cooled, 240 W/cm metal halide lamp (by Eye Graphics) at a lighting intensity of 600 mW/cm² and at a dose of 600 mJ/cm². Accordingly, a surface film A was produced.

### <Production of Optical Film A>

The TD80UL side of the surface film A produced in the above and the optically-anisotropic layer side of the patterned optically-anisotropic layer A were stuck together using an adhesive to produce an optical film A.

<Production of Polarizing plate A>

TD80UL (by FUJIFILM, having Re/Rth=2/40 at 550 nm) was used as a protective film A for polarizing plate A. Its surface was alkali-saponified. Briefly, the film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath at room temperature, and then dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using a 3% aqueous solution of polyvinyl alcohol (Kuraray's PVA-117H) as an adhesive, the alkali-saponified film TD80UL mentioned above and a retardation film for VA mode (by FUJIFILM, having Re/Rth=50/125 at 550 nm) that had been alkali-saponified in the same manner as above were stuck together via the polarizing film sandwiched therebetween in a manner so that the saponified surfaces of the two faced the polarizing film, thereby producing a polarizing plate A, in which the film TD80UL and the retardation film for VA-mode serve as the protective film for the polarizing film therein. The films were combined so that the slow axis of the VA-mode retardation film was perpendicular to the absorption axis of the polarizing film.

<Production of Polarizing plate A with Optical Film A>

The transparent support A side of the optical film A produced in the above and the TD80UL side of the polarizing plate A were stuck together using an adhesive, thereby producing a polarizing plate A with optical film A. In this, the films were combined so that the slow axis of the patterned optically-anisotropic layer was at an angle of ±45 degrees to the absorption axis of the polarizing film.

### <Production of 3D Display Device A>

The polarizer on the viewers' side was peeled from Nanao's FlexScan S2231W, and the VA-mode retardation film of the polarizing plate A with optical film A produced in the above was stuck to the LC cell using an adhesive. Subsequently, the polarizer on the light source side was peeled, and the VA-mode retardation film of the polarizing plate A was stuck to the LC cell using an adhesive. According to this process, a 3D display device A having the configuration as in FIG. 6(a) was produced. The direction of the absorption axis of the polarizing film is the same as in FIG. 3.

### Example 2

### Transparent Support B

TD80UL (by FUJIFILM) was prepared and used as a transparent support B. The thickness of TD80UL was 80 micro meters, retardation in-plane Re(550) thereof was 2 nm, and retardation along the thickness direction Rth(550) thereof was 40 nm.

### <Formation of Patterned Optically-Anisotropic Layer B>

A patterned optically-anisotropic layer B was produced in the same manner as in Example 1 except that the transparent support A was changed to the above-mentioned transparent support B and the formulation of the rubbing alignment layer coating liquid was changed to the following formulation. The thickness of the alignment layer was 0.5 micro meters and the thickness of the optically-anisotropic layer was 0.9 micro meters.

Formulation for Alignment Layer

| | | |
|---|---|---|
| Polymer material for alignment layer (PVA103, | 3.9 | parts by mass |
| Kuraray's polyvinyl alcohol) | | |
| Photo-acid-generating agent (I-33) | 0.1 | parts by mass |
| Methanol | 36 | parts by mass |
| Water | 60 | parts by mass |

Photo-acid-generating agent I-33:

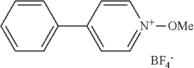

The first retardation domain and the second retardation domain of the thus-formed, patterned optically-anisotropic layer B were analyzed according to TOF-SIMS (time-of-flight secondary ion mass spectrometry with ION-TOF's TOF-SIMS V), which confirmed that the abundance ratio of the photo-acid-generating agent I-33 in the alignment layer corresponding to the first retardation domain and the second retardation domain was 10/90, or that is, in the first retardation domain, I-33 was almost decomposed. In addition, in the optically-anisotropic layer, it was also confirmed that the cation of the alignment layer interface aligning agent (II-1) and the anion BF₄⁻ of the acid HBF₄ generated from the photo-acid-generating agent I-33 existed in the air-side interface of the first retardation domain. In the air-side interface of the second retardation domain, these ions were not almost observed, from which it was found that the cation of II-1 and Br⁻ existed in the vicinity of the interface of the alignment layer. Regarding the abundance ratio of the ions in the air-side interface, the cation of II-1 was in a ratio of 93/7 and BF₄⁻ was in a ratio of 90/10. From this, it is understood that, in the second retardation domain, the alignment layer-side interface aligning agent (II-1) was localized in the alignment layer interface, but in the first retardation domain, the locality reduced and the aligning agent diffused also in the air-side interface, and that, through anion exchange between the generated acid HBF₄ and II-1, the diffusion of the II-1 cation was promoted in the first retardation domain.

(Evaluation of Optically-Anisotropic Layer B)

The formed optically-anisotropic layer B was peeled from the transparent support B, and then, in the same manner as in Example 1, the direction of the slow axis of the optically-anisotropic layer was determined. Table 1 shows the relationship between the slow axis of the optically-anisotropic layer and the rubbing direction of the alignment layer. The results shown in Table 1 confirm the following: When a PVA-base rubbing alignment layer containing a photo-acid-generating agent is mask-photoexposed in the presence of a pyridinium salt compound and a fluoroaliphatic group-containing copolymer, and then rubbed in one direction, and when a discotic liquid crystal is aligned on the thus-rubbed alignment layer, then a patterned optically-anisotropic layer is formed in which the liquid crystal is vertically aligned and which has a first retardation domain and a second retardation domain with their slow axes kept perpendicular to each other.

### <Production of Optical Film B>

On the surface of TD80UL of the patterned optically-anisotropic layer B, an antireflection film was formed according to the same method as in Example 1, thereby producing an optical film B.

<Production of Polarizing plate B with Optical Film B>

The patterned optically-anisotropic layer B side of the optical film B produced in the above and the TD80UL side of the polarizing plate A produced in Example 1 were stuck together using an adhesive, thereby producing a polarizing plate B with optical film B. In this, the films were combined so that the slow axis of the patterned optically-anisotropic layer B was at an angle of ±45 degrees to the absorption axis of the polarizing film.

### <Production of 3D Display Device B>

The polarizer on the viewers' side was peeled from Nanao's FlexScan S2231W, and the VA-mode retardation film of the polarizing plate B with optical film B produced in the above was stuck to the LC cell using an adhesive. Subsequently, the polarizer on the light source side was peeled, and the VA-mode retardation film of the polarizing plate A was stuck to the LC cell using an adhesive. According to this process, a 3D display device B having the configuration as in FIG. 6(b) was produced. The direction of the absorption axis of the polarizing film is the same as in FIG. 3.

### Example 3

### Production of Transparent Support C

The following ingredients were put into a mixing tank and dissolved by stirring under heat, thereby preparing a cellulose acylate solution.

Formulation of Cellulose Acylate Solution

| | |
|---|---|
| Cellulose acylate having a degree of | 100 parts by mass |
| acetylation of from 60.7 to 61.1% | |
| Triphenyl phosphate (plasticizer) | 7.8 parts by mass |
| Biphenyldiphenyl phosphate (plasticizer) | 3.9 parts by mass |
| Methylene chloride (first solvent) | 336 parts by mass |
| Methanol (second solvent) | 29 parts by mass |
| 1-Butanol (third solvent) | 11 parts by mass |

16 parts by mass of the retardation enhancer (A) mentioned below, 92 parts by mass of methylene chloride and 8 parts by mass of methanol were put into a different mixing tank and dissolved by stirring under heat, thereby preparing a retardation enhancer solution. 25 parts by mass of the retardation enhancer solution was mixed with 474 parts by mass of the cellulose acetate solution and fully stirred to prepare a dope. The amount of the retardation enhancer added was 6.0 parts by mass relative to 100 parts by mass of cellulose acetate.

### Retardation Enhancer (A):

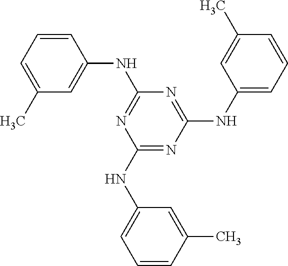 [SMILES: Cc1cccc(Nc2nc(Nc3cccc(C)c3)nc(Nc3cccc(C)c3)n2)c1]

The obtained dope was cast using a band stretcher. After the film surface temperature on the band reached 40 degrees Celsius, the film on the band was dried with hot air at 70 degrees Celsius for 1 minute and then dried with dry air at 140 degrees Celsius for 10 minutes, and then peeled to give a transparent support C having a residual solvent amount of 0.3% by mass.

The thickness of the obtained transparent support C was 80 micro meters. Retardation in-plane (Re) of the support was 8 nm and retardation along the thickness direction (Rth) thereof was 78 nm.

### <Formation of Patterned Optically-Anisotropic Layer C>

A patterned optically-anisotropic layer C was formed according to the same operation as in Example 1 except that the transparent support A was changed to the above-mentioned transparent support C and the optically-anisotropic layer coating liquid was changed to the following composition. The thickness of the optically-anisotropic layer was 0.9 micro meters.

Formulation of Coating Liquid for Optically-Anisotropic Layer

| | | |
|---|---|---|
| Discotic liquid crystal E-2 | 100 | parts by mass |
| Alignment layer-side interface aligning agent (II-1) | 3.0 | parts by mass |
| Air-side interface aligning agent (P-2) | 0.4 | parts by mass |
| Photopolymerization initiator (Irgacure 907, by Ciba Specialty Chemicals) | 3.0 | part by mass |
| Sensitizer (Kayacure DETX, by Nippon Kayaku) | 1.0 | part by mass |
| Methyl ethyl ketone | 400 | parts by mass |

Discotic Liquid Crystal E-2: 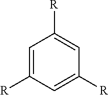 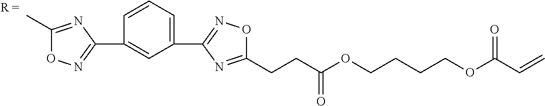 [SMILES: C=CC(=O)OCCCCOC(=O)CCc1nc(-c2cccc(-c3noc(C)n3)c2)no1]
Air-Side Interface Aligning Agent (P-2):

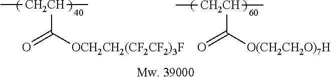

The first retardation domain and the second retardation domain of the thus-formed, patterned optically-anisotropic layer C were analyzed according to TOF-SIMS (time-of-flight secondary ion mass spectrometry with ION-TOF's TOF-SIMS V), which confirmed that the abundance ratio of the photo-acid-generating agent S-1 in the alignment layer corresponding to the first retardation domain and the second retardation domain was 8/92, or that is, in the first retardation domain, S-1 was almost decomposed. In addition, in the optically-anisotropic layer, it was also confirmed that the cation of II-1 and the anion BF₄⁻ of the acid HBF₄ generated from the photo-acid-generating agent S-1 existed in the air-side interface of the first retardation domain. In the air-side interface of the second retardation domain, these ions were not almost observed, from which it was found that the cation of the alignment layer-side interface aligning agent (II-1) and Br⁻ existed in the vicinity of the interface of the alignment layer. Regarding the abundance ratio of the ions in the air-side interface, the cation of II-1 was in a ratio of 93/7 and BF₄⁻ was in a ratio of 90/10. From this, it is understood that, in the second retardation domain, the alignment layer-side interface aligning agent (II-1) was localized in the alignment layer interface, but in the first retardation domain, the locality reduced and the aligning agent diffused also in the air-side interface, and that, through anion exchange between the generated acid HBF₄ and II-1, the diffusion of the II-1 cation was promoted in the first retardation domain.

(Evaluation of Optically-Anisotropic Layer)

The formed optically-anisotropic layer was peeled from the transparent support, and then, in the same manner as in Example 1, the direction of the slow axis of the optically-anisotropic layer was determined. Table 1 shows the relationship between the slow axis of the optically-anisotropic layer and the rubbing direction of the alignment layer. The results shown in Table 1 confirm the following: When a PVA-base rubbing alignment layer containing a photo-acid-generating agent is mask-photoexposed in the presence of a pyridinium salt compound and a fluoroaliphatic group-containing copolymer, and then rubbed in one direction, and when a discotic liquid crystal is aligned on the thus-rubbed alignment layer, then a patterned optically-anisotropic layer is formed in which the liquid crystal is vertically aligned and which has a first retardation domain and a second retardation domain with their slow axes kept perpendicular to each other.

<Production of Polarizing plate C>

A roll of polyvinyl alcohol film having a thickness of 80 micro meters was unrolled and continuously stretched by 5 times in an aqueous iodine solution and dried to give a polarizing film having a thickness of 20 micro meters. In the same manner as in Example 1, an alkali-saponified VA-mode retardation film (by FUJIFILM, having a ratio of Re/Rth=50/125 at 550 nm) and the transparent support C were stuck together with an adhesive via the polarizing film sandwiched therebetween, thereby producing a polarizing plate C, in which the VA-mode retardation film and the transparent support C serve as the protective film for the polarizing film therein. The films were combined so that the slow axis of the retardation film was perpendicular to the absorption axis of the polarizing film and the slow axis of the patterned optically-anisotropic layer C was at an angle of ±45 degrees to the absorption axis of the optically-anisotropic layer C.

<Production of Polarizing plate C with Surface-Film A>

The TD80UL side of the surface film A produced in Example 1 and the patterned optically-anisotropic layer C side of the polarizing plate C were stuck together using an adhesive, thereby producing a s polarizing plate C with surface-film A.

### <Production of 3D Display Device C>

The polarizer on the viewers' side was peeled from Nanao's FlexScan S2231W, and the VA-mode retardation film of the polarizing plate C with surface-film A produced in the above was stuck to the LC cell using an adhesive. Subsequently, the polarizer on the light source side was peeled, and the VA-mode retardation film of the polarizing plate A was stuck to the LC cell using an adhesive. According to this process, a 3D display device C having the configuration as in FIG. 6(c) was produced. The direction of the absorption axis of the polarizing film is the same as in FIG. 3.

### Example 4

### Production of Support with Rubbed Alignment Layer

Using a bar #12, an aqueous 4% solution of polyvinyl alcohol, Kuraray's “PVA103” was applied onto the saponified surface of the transparent support B produced in Example 1, and dried at 80 degrees Celsius for 5 minutes. Subsequently, this was rubbed once back and force in one direction at 400 rpm, thereby producing a transparent support with rubbed alignment layer.

### <Formation of Patterned Optically-Anisotropic Layer D>

The composition for optically-anisotropic layer mentioned below was prepared, and filtered through a polypropylene filter having a pore size of 0.2 micro meters, and this was used here as an optically-anisotropic layer coating liquid. The coating liquid was applied, and dried at a film surface temperature of 80 degrees Celsius for 1 minute to form a uniformly-aligned liquid-crystal phase state, and thereafter cooled to room temperature. Next, a stripe mask, in which the lateral stripe width of the transmitting part is 285 micro meters and the lateral stripe width of the blocking part is 285 micro meters, was set on the area coated with the optically-anisotropic layer coating liquid, in a manner so that the stripes of the stripe mask was parallel to the rubbing direction, and in air this was exposed to UV rays for 5 seconds, using an air-cooled metal halide lamp (by Eye Graphics) having a lighting intensity of 20 mW/cm², to thereby fix the alignment state to form a first retardation domain. Subsequently, this was heated up to a film surface temperature of 140 degrees Celsius so as to once form anisotropic phase, then cooled to 100 degrees Celsius, and kept heated at that temperature for 1 minute for uniform alignment. After cooled to room temperature, this was irradiated with 20 mW/cm² on the entire surface thereof for 20 seconds, to thereby fix the alignment state to form a second retardation domain. The slow axes of the first retardation domain and the second retardation domain are perpendicular to each other, and the thickness of the layer was 0.9 micro meters.

Formulation for Optically-Anisotropic Layer

| | | |
|---|---|---|
| Discotic liquid crystal E-2 | 100 | parts by mass |
| Alignment layer-side interface aligning agent (II-1) | 1.0 | part by mass |
| Air-side interface aligning agent (P-2) | 0.4 | parts by mass |
| Photopolymerization initiator (Irgacure 907, by Ciba Specialty Chemicals) | 3.0 | parts by mass |
| Sensitizer (Kayacure DETX, by Nippon Kayaku) | 1.0 | part by mass |
| Methyl ethyl ketone | 400 | parts by mass |

Discotic Liquid Crystal E-2: 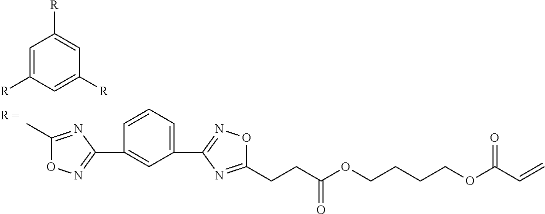
Alignment layer-Side Interface Aligning Agent (II-1): 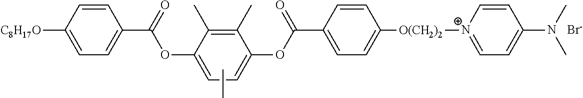
Air-Side Interface Aligning Agent (P-2):

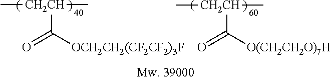

(Evaluation of Optically-Anisotropic Layer)

The formed optically-anisotropic layer was peeled from the transparent support B, and then, in the same manner as in Example 1, the direction of the slow axis of the optically-anisotropic layer was determined. Table 1 shows the relationship between the slow axis of the optically-anisotropic layer and the rubbing direction of the alignment layer. The results shown in Table 1 confirm the following: When a discotic liquid crystal is aligned on a PVA-base rubbing alignment layer that was rubbed in one direction in the presence of a pyridinium salt compound and a fluoroaliphatic group-containing copolymer, and then exposed to light with changing the heating temperature, then a patterned optically-anisotropic layer having a first retardation domain and a second retardation domain is formed in which the liquid crystal is vertically aligned and the slow axes of the two domains are perpendicular to each other.

### <Production of Optical Film D>

According to the same method as in Example 1, an antireflection film was formed on the surface of the transparent support B of the patterned optically-anisotropic layer D, thereby producing an optical film D.

<Production of Polarizing plate D>

TD80UL (by FUJIFILM, having Re/Rth=2/40 at 550 nm) was used as a protective film D for polarizing plate D. The surface of the film was alkali-saponified. The film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath, and dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using an aqueous 3% solution of polyvinyl alcohol (Kuraray's PVA-117H) as the adhesive, the saponified surface of the alkali-saponified TD80UL and the support surface of WV-EA (by FUJIFILM) that had been alkali-saponified in the same manner as above were stuck together via the polarizing film sandwiched therebetween, thereby producing a polarizing plate D.

<Production of Polarizing plate D with Optical Film D>

The patterned optically-anisotropic layer D side of the optical film D produced in the above and the TD80UL side of the polarizing plate D were stuck together with an adhesive, thereby producing a polarizing plate D with optical film D. In this, the films were combined so that the slow axis of the patterned optically-anisotropic layer D was at an angle of ±45 degrees to the absorption axis of the polarizing film.

### <Production of 3D Display Device D>

The patterned retardation plate and the front retardation plate were peeled from a circularly-polarized glasses-use 3D monitor (Zalman's TN-mode monitor), and the polarizer produced in the above was stuck thereto to thereby produce a 3D display device D having the configuration of FIG. 6(b). The direction of the absorption axis of the polarizing film is the same as in FIG. 2.

### Example 5

### Formation of Patterned Optically-Anisotropic Layer E

A patterned optically-anisotropic layer E was formed according to the same operation as in Example 4 except that the formulation of the optically-anisotropic layer coating liquid was changed to the following formulation. The thickness of the optically-anisotropic layer was 1.6 micro meters.

Formulation of Coating Liquid for Optically-Anisotropic Layer

| | | |
|---|---|---|
| Discotic liquid crystal E-3 | 100 | parts by mass |
| Alignment layer-side interface aligning agent (II-1) | 1.0 | part by mass |
| Air-side interface aligning agent (P-1) | 0.3 | parts by mass |
| Photopolymerization initiator (Irgacure 907, by Ciba | 3.0 | parts by mass |
| Specialty Chemicals) | | |
| Sensitizer (Kayacure DETX, by Nippon Kayaku) | 1.0 | part by mass |
| Ethylene oxide-modified trimethylolpropane triacrylate | 9.9 | parts by mass |
| (V#360, by Osaka Organic Chemical) | | |
| Methyl ethyl ketone | 400 | parts by mass |

Discotic Liquid Crystal E-3:

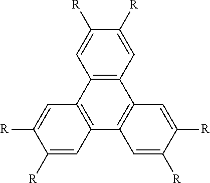

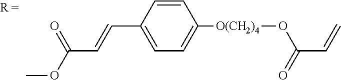

(Evaluation of Optically-Anisotropic Layer)

The formed optically-anisotropic layer was peeled from the transparent support B, and then, in the same manner as in Example 1, the direction of the slow axis of the optically-anisotropic layer was determined. Table 1 shows the relationship between the slow axis of the optically-anisotropic layer and the rubbing direction of the alignment layer. The results shown in Table 1 confirm the following: When a discotic liquid crystal is aligned on a PVA-base rubbing alignment layer that was rubbed in one direction in the presence of a pyridinium salt compound and a fluoroaliphatic group-containing copolymer, and then exposed to light with changing the heating temperature, then a patterned optically-anisotropic layer having a first retardation domain and a second retardation domain is formed in which the liquid crystal is vertically aligned and the slow axes of the two domains are perpendicular to each other.

### <Production of Optical Film E>

According to the same method as in Example 1, an antireflection film was formed on the surface of the transparent support B of the patterned optically-anisotropic layer E, thereby producing an optical film E.

<Production of Polarizing plate E with Optical Film E>

The patterned optically-anisotropic layer E side of the optical film E produced in the above and the TD80UL side of the polarizing plate D produced in Example 4 were stuck together with an adhesive, thereby producing a polarizing plate E with optical film E. In this, the films were combined so that the slow axis of the patterned optically-anisotropic layer E was at an angle of ±45 degrees to the absorption axis of the polarizing film.

### <Production of 3D Display Device E>

The patterned retardation plate and the front retardation plate were peeled from a circularly-polarized glasses-use 3D monitor (Zalman's TN-mode monitor), and the polarizing plate E produced in the above was stuck thereto to thereby produce a 3D display device E having the configuration of FIG. 6(b). The direction of the absorption axis of the polarizing film is the same as in FIG. 2.

### Example 6

### Production of Support with Rubbed Alignment Layer

### (1) Formation of Parallel Alignment Layer (First Alignment Layer):

Using a bar #12, a 4% water/methanol solution of polyvinyl alcohol, Kuraray's “PVA103” (prepared by dissolving PVA103 (4.0 g) in water (72 g) and methanol (24 g), and having a viscosity of 4.35 cp and a surface tension of 44.8 dyne) was applied to the saponified surface of the transparent support B produced in Example 2, and dried at 80 degrees Celsius for 5 minutes.

### (2) Formation of Patterned Vertical Alignment Layer (Second Alignment Layer):

2.0 g of Wako Pure Chemicals' polyacrylic acid (Mw 25000) was dissolved in triethylamine (2.52 g)/water (1.12 g)/propanol (5.09 g)/3-methoxy-1-butanol (5.09 g) to prepare a coating liquid.

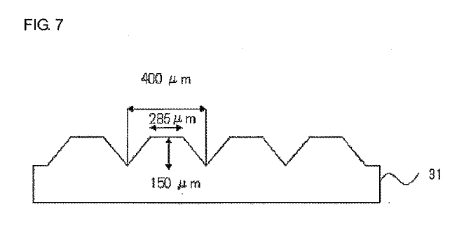

Next, a synthetic rubber flexographic plate having a patterned indented surface as in FIG. 7 was produced.

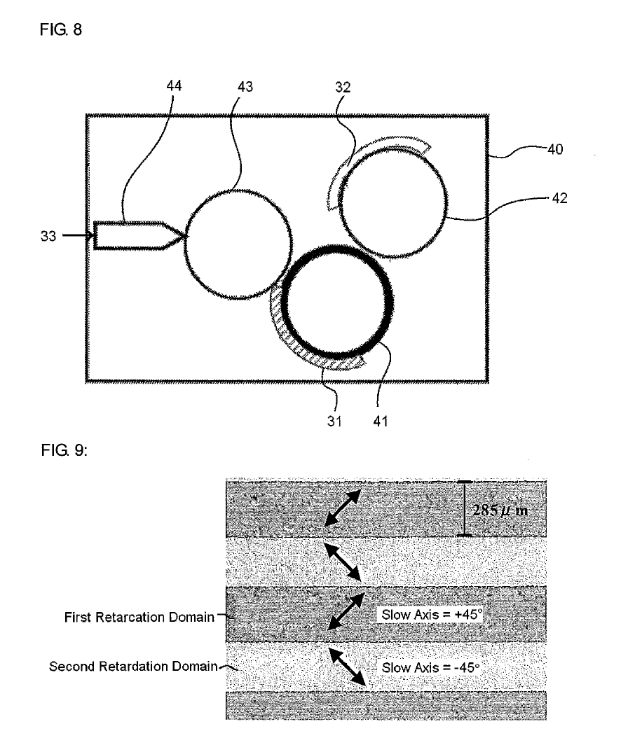

As a flexographic printing apparatus shown in FIG. 8, used was Flexiproof 100 (by RK Print Coat Instruments Ltd. UK). The anilox roller used here had a line screen of 400 cells/cm (capacity 3 cm3/m2). The flexographic plate was stuck to the impression cylinder of Flexiproof 100 using a pressure-sensitive tape. The parallel alignment layer was stuck to the pressure roller, the coating liquid for patterned vertical alignment layer was put into a doctor blade, and a vertical alignment layer was pattern-printed on the parallel alignment layer at a printing speed of 30 m/min.

### (3) Formation of Rubbed Alignment Layer:

After dried at 80 degrees Celsius for 5 minutes, the film was rubbed once back and force in the direction parallel to the stripe lines of the pattern, at 1000 rpm, thereby forming a rubbed alignment layer.

### <Formation of Patterned Optically-Anisotropic Layer F>

The coating liquid for optically-anisotropic layer prepared in Example 4 was applied, and dried at a film surface temperature of 110 degrees Celsius for 1 minute to form a liquid-crystal phase state, and thereafter cooled to 80 degrees Celsius, and in air this was exposed to UV rays, using a 160 W/cm, air-cooled metal halide lamp (by Eye Graphics), to thereby fix the alignment state to form a patterned optically-anisotropic layer F. The thickness of the optically-anisotropic layer was 0.9 micro meters.

### (Evaluation of Optically-Anisotropic Layer)

The formed optically-anisotropic layer was peeled from the transparent support B, and then, in the same manner as in Example 1, the direction of the slow axis of the optically-anisotropic layer was determined. Table 1 shows the relationship between the slow axis of the optically-anisotropic layer and the rubbing direction of the alignment layer. The results shown in Table 1 confirm the following: When a discotic liquid crystal is aligned and photoexposed on a PVA-base unidirectionally-rubbed alignment layer (first alignment layer)/polyacrylic acid-base rubbed alignment layer (second alignment layer) in the presence of a pyridinium salt compound and a fluoroaliphatic group-containing copolymer, then a patterned optically-anisotropic layer having a first retardation domain and a second retardation domain is formed in which the liquid crystal is vertically aligned and the slow axes of the two domains are perpendicular to each other.

### <Production of Optical Film F>

According to the same method as in Example 1, an antireflection film was formed on the surface of the transparent support B of the patterned optically-anisotropic layer F, thereby producing an optical film F.

<Production of Polarizing Plate F with Optical Film F>

TD80UL (by FUJIFILM, having Re/Rth=2/40 at 550 nm) was used as a protective film F for polarizing plate F. The surface of the film was alkali-saponified. The film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath, and dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using an aqueous 3% solution of polyvinyl alcohol (Kuraray's PVA-117H) as the adhesive, the saponified surface of the alkali-saponified TD80UL was stuck to one surface of the polarizing film in a manner so that the saponified surface faced the polarizing film side; and the patterned optically-anisotropic layer F side of the optical film F was stuck to the other side with the adhesive. Accordingly, a polarizing plate F was produced, having TD80UL and the optical film F both serving as a protective film for the polarizing therein. In this, the films were combined so that the slow axis of the patterned optically-anisotropic layer D was at an angle of ±45 degrees to the absorption axis of the polarizing film.

### <Production of 3D Display Device F>

The patterned retardation plate and the front retardation plate were peeled from a circularly-polarized glasses-use 3D monitor (Zalman's TN-mode monitor), and the polarizer produced in the above was stuck thereto to thereby produce a 3D display device F having the configuration of FIG. 6(d). The direction of the absorption axis of the polarizing film is the same as in FIG. 2.

### Example 7

### Production of Transparent Support with Rubbed Alignment Layer

Using a bar #12, an aqueous solution of 4% polyvinyl alcohol, Kuraray's “PVA103” was applied to the surface of a film, Teijin's Pure Ace having Re(550) of 138 nm and Rth(550) of 69 nm, and dried at 80 degrees Celsius for 5 minutes. Subsequently, this was rubbed once back and forth in the direction parallel to the slow axis of Pure Ace at 400 rpm, thereby producing a transparent support with rubbed alignment layer. The thickness of the alignment layer was 0.5 micro meters.

### <Formation of Patterned Optically-Anisotropic Layer G>

The composition for optically-anisotropic layer mentioned below was prepared, and filtered through a polypropylene filter having a pore size of 0.2 micro meters, and this was used here as a coating liquid for ½ wavelength layer. The coating liquid was applied, and dried at a film surface temperature of 80 degrees Celsius for 1 minute to form a uniformly-aligned liquid-crystal phase state, and thereafter cooled to room temperature. Next, a mask having a lateral stripe width of 285 micro meters was arranged on the substrate coated with the coating liquid for ½ wavelength layer, and in air this was exposed to UV rays for 5 seconds, using an air-cooled metal halide lamp (by Eye Graphics) having a lighting intensity of 20 mW/cm², to thereby fix the alignment state to form a first retardation domain. Subsequently, this was heated up to a film surface temperature of 140 degrees Celsius so as to once form anisotropic phase, then irradiated with 20 mW/cm² on the entire surface thereof for 20 seconds, to thereby fix the alignment state to form a second retardation domain. In that manner, a patterned ½ wavelength layer was formed. It was confirmed that thickness of the layer was 3.2 micro meters, and the tilt angle thereof was around 90°. Separately, the same optically-anisotropic layer was formed on a glass substrate, and Re thereof at a wavelength of 550 nm was measured. As a result, Re of the first retardation domain was 275 nm, the slow axis thereof was parallel to the slow axis of Pure Ace, and Re of the second retardation domain was 0 nm. The total of Re of the first retardation domain of the patterned optically-anisotropic layer G and Re of the transparent support was 413 nm, the total of Re of the second retardation domain and Re of the transparent support was 138 nm, and the slow axis of the first retardation domain was parallel to the slow axis of the second retardation domain.

Composition for Forming Optically-Anisotropic Layer

| | | |
|---|---|---|
| Discotic liquid crystal E-4 | 100 | parts by mass |
| Alignment layer-side interface aligning agent (II-1) | 1.0 | part by mass |
| Air-side interface aligning agent (P-1) | 0.3 | parts by mass |
| Photopolymerization initiator (Irgacure 907, by Ciba | 3.0 | parts by mass |
| Specialty Chemicals) | | |
| Sensitizer (Kayacure DETX, by Nippon Kayaku) | 1.0 | part by mass |
| Ethylene oxide-modified trimethylolpropane | 9.9 | parts by mass |
| triacrylate (V#360, by Osaka Organic Chemical) | | |
| Methyl ethyl ketone | 400 | parts by mass |

Discotic Liquid Crystal E-4:

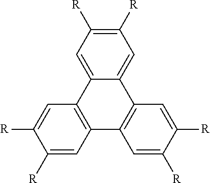

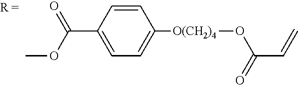

### <Production of Optical Film G>

The TD80UL side of the surface film A and the optically-anisotropic layer side of the patterned optically-anisotropic layer G were stuck together with an adhesive to produce an optical film G.

<Production of Polarizing plate G>

The support surface of WV-EA (by FUJIFILM) was alkali-saponified. Briefly, the film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath, and dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using an aqueous 3% solution of polyvinyl alcohol (Kuraray's PVA-117H) as the adhesive, the alkali-saponified WV-EA was stuck to one side of the polarizing film in a manner so that the saponified support side of the former faced the polarizing film side, and the support side of the optical film G was stuck to the other side of the polarizing film with the adhesive. Accordingly, a polarizing plate G was produced having WV-EA and the optical film G both serving as a protective film for the polarizing film therein. In this, the films were combined so that the slow axis of the patterned optically-anisotropic layer was at an angle of 45 degrees to the absorption axis of the polarizing film.

### <Production of 3D Display Device G>

The patterned retardation plate and the front polarizer were peeled from a circularly-polarized glasses-use 3D monitor W220S (by Hyundai), and the polarizer produced in the above was stuck thereto to thereby produce a 3D display device G having the configuration of FIG. 6(c).

### Example 8

### Formation of Patterned Optically-Anisotropic Layer J

A patterned optically-anisotropic layer J was prepared in the same manner as the patterned optically-anisotropic layer G except that the rubbing angle was adjusted so that the direction of the slow axis of the optically-anisotropic layer was at 45° with respect to the pattern and the angle in stacking with the support film (Teijin's Pure Ace) was changed by 45° from the stacking angle for the patterned optically-anisotropic layer G.

### <Production of Optical Film J>

The TD80UL side of the surface film A and the optically-anisotropic layer side of the patterned optically-anisotropic layer J were stuck together with an adhesive to produce an optical film J

<Production of Polarizing plate J>

A polarizing plate J was produced in the same manner as that for the polarizing plate G except that the optical film J was used in place of the optical film G and a VA-mode retardation film (by FUJIFILM, having Re/Rth=50/125 at 550 nm) was used in place of WW EA (by FUJIFILM).

### <Production of 3D Display Device J>

The viewers' side polarizer was peeled from Nanao's FlexScan S2231W, and the VA-mode retardation film of the polarizing plate J produced in the above was stuck to the LC cell using an adhesive. Subsequently, the light source side polarizer was peeled, and the VA-mode retardation film of the polarizing plate A was stuck to the LC cell using an adhesive. According to this process, a 3D display device J having the configuration as in FIG. 6(c) was produced. The direction of the absorption axis of the polarizing film is the same as in FIG. 3.

### Example 9

### Preparation of Hard Coat Layer Coating Liquid B

The following ingredients were put into a mixing tank and stirred to prepare a hard coat layer coating liquid B. 100 parts by mass of cyclohexanone, 750 parts by mass of a partially caprolactone-modified polyfunctional acrylate (DPCA-20, by

Nippon Kayaku), 200 parts by mass of silica sol (MIBK-ST, by Nissan Chemical), 50 parts by mass of a photopolymerization initiator (Irgacure 819, by Ciba Specialty Chemicals) and 100 parts by mass of a benzotriazole-type UV absorbent mentioned below (Tinuvin 384-2, by Ciba Japan) were added to 900 parts by mass of methyl ethyl ketone, and stirred. The mixture was filtered through a polypropylene filter having a pore size of 0.4 micro meters to prepare a coating liquid B for hard coat layer. UV Absorbent:

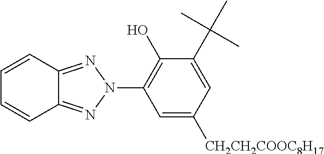

### <Preparation of Low Refractive Index Layer Coating Liquid B>

The following ingredients were mixed and dissolved in MEK to prepare a low refractive index layer coating liquid having a solid content of 5% by mass.

Formulation of Low Refractive Index Layer Coating Liquid B:

| | |
|---|---|
| Perfluoro-olefin copolymer mentioned below | 15 parts by mass |
| DPHA (mixture of dipentaerythritol pentaacrylate and dipentaerythritol | 7 parts by mass |
| hexaacrylate, by Nippon Kayaku) | |
| Defenser MCF-323 (fluorine-containing surfactant, by DIC) | 5 parts by mass |
| Fluorine-containing polymerizing compound mentioned below | 20 parts by mass |
| Hollow silica particles dispersion A (solid concentration 18.2% by mass) | 50 parts by mass |
| Irgacure 127 (photopolymerization initiator, by Ciba Japan) | 3 parts by mass |

Perfluoro-olefin Copolymer: 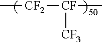 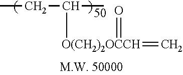
In the above structural formula, 50/50 is by mol.
Fluorine-Containing Polymerizing Compound:

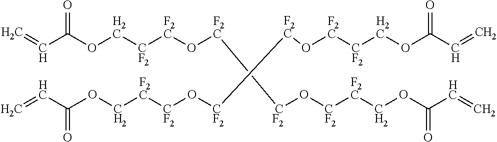 [SMILES: C=CC(=O)OCC(F)(F)C(F)(F)OC(F)(F)C(F)(F)OC(F)(F)C(F)(F)COC(=O)C=C ; C=CC(=O)OCC(F)(F)C(F)(F)OC(F)(F)C(F)(F)OC(F)(F)C(F)(F)COC(=O)C=C]

### <Formation of Hard Coat Layer>

Using a gravure coater, the hard coat layer coating liquid B was applied onto the optically-anisotropic layer side of the optically-anisotropic layer B formed in Example 2. This was dried at 100 degrees Celsius. While purged with nitrogen so that the atmosphere had an oxygen concentration of not more than 1.0% by volume, the coating layer was cured through exposure to UV rays, using an air-cooled, 160 W/cm metal halide lamp (by Eye Graphics) at a lighting intensity of 400 mW/cm² and at a dose of 150 mJ/cm², thereby forming a hard coat layer B having a thickness of 12 micro meters.

### <Formation of Low Refractive Index Layer>

Using a gravure coater, the above-mentioned, low refractive index layer coating liquid B was applied onto the hard coat layer B. The drying condition was at 90 degrees Celsius and for 30 seconds. The UV curing condition was as follows: While purged with nitrogen so that the atmosphere had an oxygen concentration of not more than 0.1% by volume, the coating layer was cured through exposure to UV rays, using an air-cooled, 240 W/cm metal halide lamp (by Eye Graphics) at a lighting intensity of 600 mW/cm² and at a dose of 600 mJ/cm². The refractive index of the low refractive index layer was 1.36, and the thickness thereof was 90 nm.

As in the above, the hard coat layer B and the low refractive index layer were laminated on the optically-anisotropic layer B, thereby producing an optical film K.

<Production of Polarizing plate K with Optical Film K>

The transparent support B side of the optical film K produced in the above and the TD80UL side of the polarizing plate A produced in Example 1 were stuck together using an adhesive, thereby producing a polarizing plate K with optical film K. In this, the films were combined so that the slow axis of the patterned optically-anisotropic layer B was at an angle of ±45 degrees to the absorption axis of the polarizing film.

### <Production of 3D Display Device K>

The polarizer on the viewers' side was peeled from Nanao's FlexScan S2231W, and the VA-mode retardation film of the polarizing plate K with optical film K produced in the above was stuck to the LC cell using an adhesive. Subsequently, the polarizer on the light source side was peeled, and the VA-mode retardation film of the polarizing plate A was stuck to the LC cell using an adhesive. According to this process, a 3D display device K having the configuration as in FIG. 6(e) was produced. The direction of the absorption axis of the polarizing film is the same as in FIG. 3.

### Example 10

### Production of Surface Film

### (Preparation of Sol a)

120 parts by mass of methyl ethyl ketone, 100 parts by mass of acryloyloxypropyltrimethoxysilane (KBM-5103, by Shin-etsu Chemical Industry) and 3 parts by mass of diisopropoxyaluminiumethyl acetacetate were put into a reactor equipped with a stirrer and a reflux condenser, and mixed therein. Subsequently, 30 parts by mass of ion-exchanged water was added thereto and reacted at 60 degrees Celsius for 4 hours, and then cooled to room temperature to give a sol a. The mass-average molecular weight of the sol was 1600, and of the oligomer and higher ingredients of the sol, those having a molecular weight of from 1000 to 20000 accounted for 100%. Gas chromatography of the sol confirmed the absence of the starting material, acryloyloxypropyltrimethoxysilane.

(Preparation of Antiglare Layer Coating Liquid E)

31 g of a mixture of pentaerythritol triacrylate and pentaerythritol tetraacrylate (PET-30, by Nippon Kayaku) was diluted with 38 g of methyl isobutyl ketone. Further, 1.5 g of a polymerization initiator (Irgacure 184, by Ciba Specialty Chemicals) was added thereto, and mixed and stirred. Subsequently, 0.04 g of a fluorine-containing surface modifier (FP-149) and 6.2 g of a silane coupling agent (KBM-5103, by Shin-etsu Chemical Industry) were added thereto. The refractive index of the coating film formed by applying the solution followed by UV-curing it was 1.520. Finally, 39.0 g of a 30% cyclohexanone dispersion of crosslinked poly(acryl-styrene) particles (copolymerization ratio=50/50, refractive index 1.540) having a mean particle size of 3.5 micro meters, which had been dispersed at 10000 rpm for 20 minutes using a polytron disperser, was added to the solution thereby preparing a finished solution. The mixture was filtered through a polypropylene filter having a pore size of 30 micro meters to prepare an antiglare layer coating liquid E.

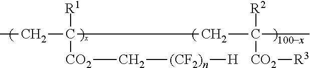

| | x | R¹ | n | R² | R³ | Mw |
|---|---|---|---|---|---|---|
| FP-148 | 80 | H | 4 | CH₃ | CH₃ | 11000 |

(Preparation of Low Refractive Index Layer Coating Liquid A)

13 g of a thermally-crosslinkable fluoropolymer containing polysiloxane and hydroxyl group and having a refractive index of 1.44 (JTA113, having a solid concentration of 6%, by JSR), 1.3 g of a colloidal silica dispersion MEK-ST-L (trade name of Nissan Chemical, having a mean particle size of 45 nm and a solid concentration of 30%), 0.6 g of the above-mentioned sol a, 5 g of methyl ethyl ketone and 0.6 g of cyclohexanone were stirred, and the mixture was filtered through a polypropylene filter having a pore size of 1 micro meter to prepare a low refractive index layer coating liquid A. The refractive index of the layer formed of the coating liquid was 1.45.

(1) Formation of Antiglare Layer:

A roll of a triacetyl cellulose film having a thickness of 80 micro meters (TAC-TD80U, by FUJIFILM, having Re/Rth=2/40) was unrolled, and according to the die coating method, for which the apparatus configuration and the coating condition are descried in JP-A 2007-41495, [0172], the antiglare layer coating liquid E was applied onto the film, dried at 30 degrees Celsius for 15 seconds and then at 90 degrees Celsius for 20 seconds, and thereafter irradiated with UV rays using a 160 W/cm, air-cooled metal halide lamp (by Eye Graphics) at a dose of 90 mJ/cm² under purging with nitrogen, thereby curing the coating layer to form an antiglare layer having a thickness of 6 micro meters.

(2) Formation of Low Refractive Index Layer:

The roll of triacetate film coated with the antiglare layer of the above-mentioned antiglare layer coating liquid E was again unrolled, and the above-mentioned, low refractive index layer coating liquid A was applied thereon under the basic condition described in JP-A 2007-41495, [0172], and then dried at 120 degrees Celsius for 150 seconds and further at 140 degrees Celsius for 8 minutes, and thereafter the coating layer was irradiated with UV rays using a 240 W/cm, air-cooled metal halide lamp (by Eye Graphics) at a dose of 900 mJ/cm² in an atmosphere having an oxygen concentration of at most 0.1% by volume with purging with nitrogen, thereby forming a low refractive index layer having a thickness of 100 nm to produce a surface film.

The surface of the optically-anisotropic layer formed in Example 1 (the surface having the patterned optically-anisotropic layer formed thereon) and the back of the surface film formed in the above (the side on which the antiglare layer and the low refractive index layer were not formed) were optically stuck together, using an isotropic adhesive (Soken Chemical's SK-2057). Accordingly, an optical film L was produced, having the adhesive layer, the support, the antiglare layer and the low refractive index layer laminated on the optically-anisotropic layer A.

<Production of Polarizing plate L>

A roll of polyvinyl alcohol film having a thickness of 80 micro meters was unrolled and continuously stretched by 5 times in an aqueous iodine solution and dried to give a polarizing film having a thickness of 20 micro meters. According to the same method as in Example 1, an alkali-saponified VA-mode retardation film (by FUJIFILM, having Re/Rth=50/125 at 550 nm) and the transparent support A side of the optical film L were stuck together with an adhesive via the polarizing film sandwiched therebetween, thereby producing a polarizing plate L in which the VA-mode retardation film and the transparent support A of the optical film L both serve as the protective film for the polarizing film therein. In this, the films were combined so that the slow axis of the retardation film was at an angle of 45 degrees to the absorption axis of the polarizing film.

### <Production of 3D Display Device L>

The polarizer on the viewers' side was peeled from Nanao's FlexScan S2231W, and the VA-mode retardation film of the optical film L produced in the above was stuck to the LC cell using an adhesive. Subsequently, the polarizer on the light source side was peeled, and the VA-mode retardation film of the polarizing plate A was stuck to the LC cell using an adhesive. According to this process, a 3D display device L having the configuration as in FIG. 6(c) was produced. The direction of the absorption axis of the polarizing film is the same as in FIG. 3.

### Example 11

Formation of Optically-Anisotropic Layer with Antiglare Layer>

Using a gravure coater, the above-mentioned antiglare layer coating liquid E of Example 10 was applied onto the transparent support B of the optically-anisotropic layer B formed in Example 2, and dried at 30 degrees Celsius for 15 seconds and further at 90 degrees Celsius for 20 seconds, and thereafter the coating layer was irradiated with UV rays using a 160 W/cm, air-cooled metal halide lamp (by Eye Graphics) at a dose of 90 mJ/cm2 with purging with nitrogen, and cured to form an antiglare, optically-anisotropic layer having a thickness of 6 micro meters.

### <Formation of Low Refractive Index Layer>

Using a gravure coater, the above-mentioned, low refractive index layer coating liquid B was applied onto the optically-anisotropic layer with antiglare layer. The drying condition was at 90 degrees Celsius and for 30 seconds. The UV curing condition was as follows: While purged with nitrogen so that the atmosphere had an oxygen concentration of not more than 0.1% by volume, the coating layer was cured through exposure to UV rays, using an air-cooled, 240 W/cm metal halide lamp (by Eye Graphics) at a lighting intensity of 600 mW/cm2 and at a dose of 600 mJ/cm². The refractive index of the low refractive index layer was 1.36, and the thickness thereof was 90 nm.

As in the above, the antiglare layer and the low refractive index layer were laminated on the transparent support of the optically-anisotropic layer B, thereby producing an optical film M.

<Production of Polarizing Plate M with Optical Film M>

The patterned optically-anisotropic layer B of the optical film M produced in the above and the TD80UL side of the polarizing plate A produced in Example 1 were stuck together using an adhesive, thereby producing a polarizing plate M with optical film M. In this, the films were combined so that the slow axis of the patterned optically-anisotropic layer B was at an angle of ±45 degrees to the absorption axis of the polarizing film.

### <Production of 3D Display Device M>

The polarizer on the viewers' side was peeled from Nanao's FlexScan S2231W, and the VA-mode retardation film of the polarizing plate M with optical film M produced in the above was stuck to the LC cell using an adhesive. Subsequently, the polarizer on the light source side was peeled, and the VA-mode retardation film of the polarizing plate A was stuck to the LC cell using an adhesive. According to this process, a 3D display device M having the configuration as in FIG. 6(b) was produced. The direction of the absorption axis of the polarizing film is the same as in FIG. 3.

### Example 12

An optical film N was produced in the same manner as in Example 1 except that ZEONOR-ZF14 (by Nippon Zeon) was used in place of the transparent support A in Example 1. The thickness of ZEONOR-ZF14 was 100 micro meters, retardation in-plane Re(550) thereof was 2 nm and retardation along the thickness direction Rth(550) thereof was 8 nm.

<Production of Polarizing plate N with Optical Film N>

The transparent support of the optical film N produced in the above and the TD80UL side of the polarizing plate A produced in Example 1 were stuck together using an adhesive, thereby producing a polarizing plate N with Optical film N. In this, the films were combined so that the slow axis of the patterned optically-anisotropic layer A was at an angle of ±45 degrees to the absorption axis of the polarizing film.

### <Production of 3D Display Device N>

The polarizer on the viewers' side was peeled from Nanao's FlexScan S2231W, and the VA-mode retardation film of the polarizing plate N with optical film N produced in the above was stuck to the LC cell using an adhesive. Subsequently, the polarizer on the light source side was peeled, and the VA-mode retardation film of the polarizing plate A was stuck to the LC cell using an adhesive. According to this process, a 3D display device N having the configuration as in FIG. 6(e) was produced. The direction of the absorption axis of the polarizing film is the same as in FIG. 3.

### Comparative Example 1

### Production of Transparent Support A with Optically-Anisotropic Layer

A 3D display device H was produced, using the rod-shaped liquid crystal and the alignment layer described in WO2010/090429.

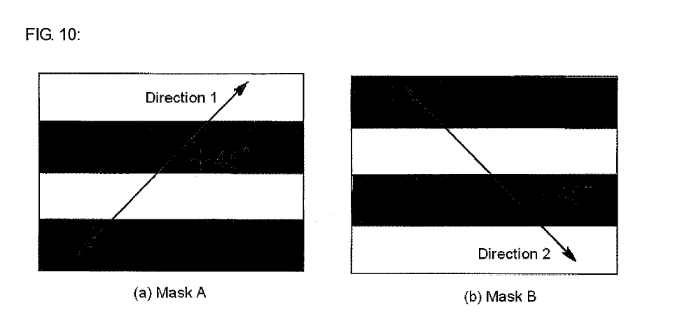

An aqueous 1% solution of an optically-aligning material E-1 having the structure mentioned below was applied onto the saponified surface of the transparent substrate A produced in Example 1, and dried at 100 degrees Celsius for 1 minute. The formed coating film was irradiated with UV rays in air, using an air-cooled metal halide lamp (by Eye Graphics) having a lighting intensity of 160 W/cm². In this step, a wire grid polarizing element (Moxtek's ProFlux PPL02) was set in the direction 1 as shown in FIG. 10(a), and the layer was photoexposed via the mask A (stripe mask having a lateral stripe width in the transmitting part of 285 micro meters and a lateral stripe width in the blocking part of 285 micro meters). Subsequently, the wire grid polarizing element was set in the direction 2 as in FIG. 10(b), and the layer was photoexposed via the mask B (stripe mask having a lateral stripe width in the transmitting part of 285 micro meters and a lateral stripe width in the blocking part of 285 micro meters). The distance between the photoexposure mask and the photo-alignment layer was 200 micro meters. The lighting intensity of UV rays used in the case was 100 mW/cm² in the UV-A region (integration at a wavelength of from 380 nm to 320 nm), and the irradiation dose was 1000 mJ/cm² in the UV-A region.

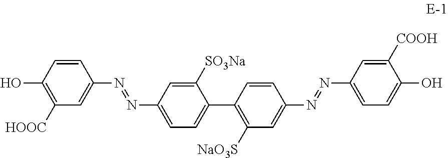

### <Formation of Patterned Optically-Anisotropic Layer H>

The composition for optically-anisotropic layer mentioned below was prepared, and filtered through a polypropylene filter having a pore size of 0.2 micro meters to prepare a coating liquid for use herein. The coating liquid was applied onto the transparent support A with optically-anisotropic layer, and dried at a film surface temperature of 105 degrees Celsius for 2 minutes to form a liquid-crystal phase state, and thereafter cooled to 75 degrees Celsius. In air, this was exposed to UV rays, using an air-cooled metal halide lamp (by Eye Graphics) having a lighting intensity of 160 W/cm², to thereby fix the alignment state to form a patterned optically-anisotropic layer G. The thickness of the optically-anisotropic layer was 1.3 micro meters.

Composition for Optically-Anisotropic Layer

| | | |
|---|---|---|
| Rod-shaped liquid crystal (LC242, by BASF) | 100 | parts by mass |
| Horizontally aligning agent A | 0.3 | parts by mass |
| Photopolymerization initiator (Irgacure 907, by Ciba Specialty Chemicals) | 3.3 | parts by mass |
| Sensitizer (Kayacure DETX, by Nippon Kayaku) | 1.1 | parts by mass |
| Methyl ethyl ketone | 300 | parts by mass |

Rod-Shaped Liquid Crystal LC242: rod-shaped liquid crystal described in
WO2010/090429A2: 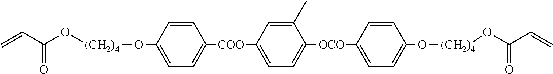
Horizontally-Aligning Agent A:

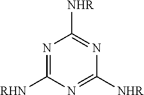

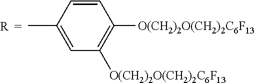

(Evaluation of Optically-Anisotropic Layer)

The formed optically-anisotropic layer was peeled from the transparent support A, and then, in the same manner as in Example 1, the direction of the slow axis of the optically-anisotropic layer was determined. Table 1 shows the relationship between the slow axis of the optically-anisotropic layer and the photoexposure direction of the alignment layer. The results shown in Table 1 confirm the following: When a rod-shaped liquid crystal is aligned and photoexposed on a photo-alignment layer, then a patterned optically-anisotropic layer having a first retardation domain and a second retardation domain is formed in which the liquid crystal is horizontally aligned and the slow axes of the two domains are perpendicular to each other.

### <Production of Optical Film H>

According to the same method as in Example 1, an antireflection film was formed on the surface of the transparent support A of the patterned optically-anisotropic layer H, thereby producing an optical film H.

<Production of Polarizing plate A with Optical Film H>

The patterned optically-anisotropic layer H side of the optical film H produced in the above and the TD80UL side of the polarizing plate A produced in Example 1 were stuck together with an adhesive, thereby producing a polarizing plate A with optical film H. In this, the films were combined so that the slow axis of the patterned optically-anisotropic layer H was at an angle of ±45 degrees to the absorption axis of the polarizing film.

### <Production of 3D Display Device H>

The polarizer on the viewers' side was peeled from Nanao's FlexScan S2231W, and the VA-mode retardation film of the polarizing plate A with optical film H produced in the above was stuck to the LC cell using an adhesive. Subsequently, the polarizer on the light source side was peeled, and the VA-mode retardation film of the polarizing plate A was stuck to the LC cell using an adhesive. According to this process, a 3D display device H having the configuration as in FIG. 6(b) was produced. The direction of the absorption axis of the polarizing film is the same as in FIG. 3.

### Comparative Example 2

### Production of Transparent Support B with Photo-Alignment Layer

The saponified surface of the transparent support B was processed according to the same method as in Comparative Example 1, thereby producing a transparent support B with photo-alignment layer.

### <Formation of Patterned Optically-Anisotropic Layer I>

A patterned optically-anisotropic layer I was formed on a transparent support B in the same manner as the patterned optically-anisotropic layer H, except that a wire-grid polarizing element of which angle was different from that of the wire grid polarizing element used in preparing the patterned optically-anisotropic layer H by 45° when being photo-exposed via the mask. The thickness of the optically-anisotropic layer was 1.3 micro meters.

### <Production of Optical Film I>

The TD80UL side of the surface film A produced in Example 1 and the optically-anisotropic layer side of the patterned optically-anisotropic layer I were stuck together with an adhesive to produce an optical film I.

<Production of Polarizing plate I>

TD80UL (by FUJIFILM, having Re/Rth=2/40 at 550 nm) and WV-EA (by FUJIFILM) were used as a protective film I for polarizing plate I. Their surfaces were alkali-saponified. Briefly, the film was dipped in an aqueous 1.5 N sodium hydroxide solution at 55 degrees Celsius for 2 minutes, then washed in a water-washing bath at room temperature, and neutralized with 0.1 N sulfuric acid at 30 degrees Celsius. Again this was washed in a water-washing bath and then dried with hot air at 100 degrees Celsius.

Subsequently, a roll of polyvinyl alcohol film having a thickness of 80 micro meters was unrolled and continuously stretched by 5 times in an aqueous iodine solution and dried to give a polarizing film having a thickness of 20 micro meters. Using an aqueous 3% solution of polyvinyl alcohol (Kuraray's PVA-117H) as the adhesive, the alkali-saponified WV-EA was stuck to the support side of the alkali-saponified TD80UL with the polarizing film kept sandwiched therebetween in a manner so that the saponified surfaces faced the polarizing film, thereby producing a polarizing plate I in which TD80UL and WV-EA both serve as a protective film for the polarizing film therein.

<Production of Polarizing plate I with Optical Film I>

The transparent support B side of the optical film I produced in the above and the TD80UL side of the polarizing plate I were stuck together with an adhesive to produce a polarizing plate I with optical film. In this, the films were combined so that the slow axis of the patterned optically-anisotropic layer was at an angle of ±45 degrees to the absorption axis of the polarizing film.

### <Production of 3D Display Device I>

The patterned retardation plate and the front retardation plate were peeled from a circularly-polarized glasses-use 3D monitor (Zalman's TN-mode monitor), and the polarizing plate I produced in the above was stuck thereto to thereby produce a 3D display device I having the configuration of FIG. 6(a). The direction of the absorption axis of the polarizing film is the same as in FIG. 2.

### Example 13

### Formation of Un-Patterned Optically-Anisotropic Layer O

### <<Alkali Saponification Treatment>>

The transparent support B was made to pass through dielectric heating rolls at a temperature of 60 degrees Celsius to thereby elevate the film surface temperature up to 40 degrees Celsius, and then using a bar coater, an alkali solution having the formulation mentioned below was applied onto one surface of the film in a coating amount of 14 ml/m². Then, this was heated at 110 degrees Celsius and conveyed below a steam-type far IR heater made by Noritake Company Ltd., for 10 seconds. Subsequently, also using a bar coater, pure water was applied to the film in an amount of 3 ml/m². Next, this was washed with water using a fountain coater, and then dewatered using an air knife, and this operation was repeated three times. Subsequently, the film was conveyed in a drying zone at 70 degrees Celsius for 10 seconds, and dried therein thereby giving an alkali-saponified transparent support B.

Formulation of Alkali Solution (part by mass)

| | |
|---|---|
| Potassium hydroxide | 4.7 parts by mass |
| Water | 15.8 parts by mass |
| Isopropanol | 63.7 parts by mass |
| Surfactant SF-1: C₁₄H₂₉O(CH₂CH₂O)₂₀H | 1.0 part by mass |
| Propylene glycol | 14.8 parts by mass |

### <Formation of Alignment Layer>

Using a wire bar #14, an alignment layer coating liquid having the formulation mentioned below was continuously applied onto the saponified surface of the previously-produced support. This was dried with hot air at 60 degrees Celsius for 60 seconds and then with hot air at 100 degrees Celsius for 120 seconds, thereby forming an alignment layer.

Formulation for Alignment layer Forming Coating Liquid

| | | |
|---|---|---|
| Modified polyvinyl alcohol described below | 10 | parts by mass |
| Water | 371 | parts by mass |
| Methanol | 119 | parts by mass |
| Glutaraldehyde | 0.5 | parts by mass |
| Photo-polymerization initiator (Irgacure 2959, | 0.3 | parts by mass |
| by Ciba Japan) | | |

Modified polyvinyl alcohol

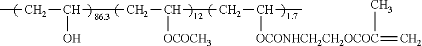

(Formation of Optically-Anisotropic Layer Containing Discotic Liquid Crystal Compound)

The obtained alignment layer was subjected to a rubbing treatment continuously. In the treatment, the conveying direction was along the long axis of the long transparent film, and the rotation axis of the rubbing roll was along the direction at 45° in a counterclockwise direction.

A coating liquid O having the following formulation containing a discotic liquid crystal compound was continuously applied to a surface of the alignment layer by using a wire-bar. The transportation velocity (V) of the film was 36 m/min. The layer of the coating liquid was heated by a warm air at 120 degrees Celsius for 90 seconds for drying the liquid and maturing the alignment of the liquid crystal compound. Subsequently, irradiation with UV ray was carried out at 80 degrees Celsius to fix the alignment of the liquid crystal compound. The thickness of the obtained layer was 1.6 micro meters, and an un-patterned optically-anisotropic layer O was obtained.

Formulation of Optically-Anisotropic Layer Coating Liquid (O)

| | | |
|---|---|---|
| Discotic liquid crystal E-4 | 91 | parts by mass |
| Acrylate monomer described below | 5 | parts by mass |
| Photopolymerization initiator (Irgacure 907, by Ciba Specialty Chemicals) | 3 | parts by mass |
| Sensitizer (Kayacure DETX, by Nippon Kayaku) | 1 | part by mass |
| Pyridinium salt described below | 0.5 | parts by mass |
| Fluorine-base polymer (FP1) described below | 0.2 | parts by mass |
| Fluorine-base polymer (FP3) described below | 0.1 | parts by mass |
| Methyl ethyl ketone | 189 | parts by mass |

Acrylate monomer:
Ethylene oxide-modified trimethylolpropane triacrylate (V#360, by Osaka
Organic Chemical)
Pyridinium salt 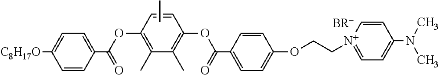
Fluorine-base polymer (FP1) 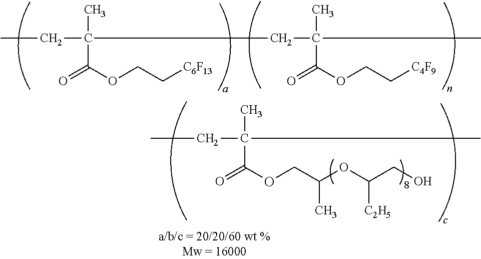
Fluorine-base polymer (FP3)

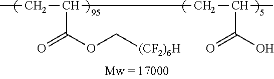

The slow axis of the un-patterned optically-anisotropic layer O was orthogonal to the rotation axis of the rubbing roll. Namely, the slow axis was along the direction at 45° in a counterclockwise direction. The mean tilt angle of the disk-planes of discotic liquid crystal molecules with respect to the film-plane was 90°, and therefore it was confirmed that the discotic liquid crystal was aligned vertically with respect to the film-plane

### <Formation of Patterned Optically-Anisotropic Layer O>

A patterned optically-anisotropic layer O was formed by using the rod-like liquid crystal compound and the alignment layer which were same as those used in forming the patterned optically-anisotropic layer H.

A glass plate was prepared, and an aqueous 1% solution of an optically-aligning material E-1 which was same as that used in preparing the patterned optically-anisotropic layer H was applied to the surface of the glass plate, and then dried at 100 degrees Celsius for a minute. The formed coating film was irradiated with UV rays in air, using an air-cooled metal halide lamp (by Eye Graphics) having a lighting intensity of 160 W/cm².

In this step, a mask (stripe mask having a lateral stripe width in the transmitting part of 530 micro meters and a lateral stripe width in the blocking part of 530 micro meters) was set in the configuration as shown in FIG. 10(a), and the layer was irradiated with a non-polarized light via the mask. Subsequently, the wire grid polarizing element was set in the direction 2 as shown in FIG. 10(b), and the layer was photoexposed via a mask (stripe mask having a lateral stripe width in the transmitting part of 530 micro meters and a lateral stripe width in the blocking part of 530 micro meters). The distance between the photoexposure mask and the photo-alignment layer was 200 micro meters. The lighting intensity of UV rays used in the case was 100 mW/cm² in the UV-A region (integration at a wavelength of from 380 nm to 320 nm), and the irradiation dose was 1000 mJ/cm² in the UV-A region.

A composition having the formulation which was same as that of the composition used in preparing the optically-anisotropic layer H was prepared, and then filtered through a polypropylene filter having a pore size of 0.2 micro meters to prepare a coating liquid for use herein. The coating liquid was applied onto the transparent support with photo-alignment layer, and dried at a film surface temperature of 105 degrees Celsius for 2 minutes to form a liquid-crystal phase state, and thereafter cooled to 75 degrees Celsius. In air, this was exposed to UV rays, using an air-cooled metal halide lamp (by Eye Graphics) having a lighting intensity of 160 W/cm², to thereby fix the alignment state to form a patterned optically-anisotropic layer O. The thickness of the optically-anisotropic layer was 2.3 micro meters.

Composition for Optically-Anisotropic Layer

| | |
|---|---|
| Rod-shaped liquid crystal (LC242, by BASF) | 100 parts by mass |
| Horizontally aligning agent A | 0.3 parts by mass |
| Photopolymerization initiator (Irgacure 907, | 3.3 parts by mass |
| by Ciba Specialty Chemicals) | |
| Sensitizer (Kayacure DETX, by Nippon Kayaku) | 1.1 parts by mass |
| Methyl ethyl ketone | 300 parts by mass |

(Evaluation of Optically-Anisotropic Layer)

Table 1 shows the relationship between the slow axis of the optically-anisotropic layer O and the photoexposure direction of the alignment layer. The results shown in Table 1 confirm the following: When a rod-shaped liquid crystal is aligned and photoexposed on a photo-alignment layer, then a patterned optically-anisotropic layer having a second retardation domain in which the liquid crystal is horizontally aligned and a first retardation domain having no retardation is formed.

<Production of Polarizing Plate O with Optical Film O>

A polyvinyl alcohol (PVA) film having a thickness of 80 micro meters was immersed in an aqueous solution of iodine having a concentration of iodine of 0.05% by mass at 30 degrees Celsius for 60 seconds to be dyed, then immersed in an aqueous solution of boric acid having a concentration of boric acid of 4% by mass for 60 seconds while being stretched at a fivefold ratio, and then dried at 50 degrees Celsius for 4 minutes to give a polarizing film having a thickness of 20 micro meters.

A retardation film for VA-mode was prepared by taking it out from “LC-46XF3” manufactured by SHARP. On the surfaces of the polarizing film, the retardation film for VA-mode and the un-patterned optically-anisotropic layer O were stacked and bonded respectively, to give a polarizing plate O with un-patterned optically-anisotropic layer O. The surface of the un-patterned optically-anisotropic layer O was bonded to the surface of the polarizing film via an adhesion agent. The slow axis of the un-patterned optically-anisotropic layer O was along the direction at 45° with respect to the absorption axis of the polarizing film.

### <Production of 3D Display Device O>

The visual-side polarizing plate was removed from “LC-46XF3” manufactured by SHARP, and the polarizing plate with un-patterned optically-anisotropic layer O was integrated in place of the removed polarizing plate so that the surface of the retardation film for VA mode in the polarizing plate O was bonded to the surface of the LC cell via an adhesion agent. Furthermore, the patterned optically-anisotropic layer O was bonded to the un-patterned optically-anisotropic layer O of the polarizing plate O so that the glass plate was disposed at the visual side. In this way, a 3D display device O was produced. The patterned optically-anisotropic layer O and the un-patterned optically-anisotropic layer O were bonded each other so that the slow axis of the un-patterned optically-anisotropic layer O was orthogonal to the slow axis of the second domain of the patterned optically-anisotropic layer O. The direction of the absorption axis of the polarizing film is the same as in FIG. 3.

### Comparative Example 3

### Formation of Patterned Optically-Anisotropic Layer P

A patterned optically-anisotropic layer P was prepared in the same manner as the patterned optically-anisotropic layer H except that a transparent support B was used in place of the transparent support A.

### <Production of Optical Film P>

An antireflective layer was formed on the surface of the transparent support B of the optically-anisotropic layer P in the same manner as Example 1. In this way, an optical film P was produced.

<Production of Polarizing Plate P with Optical Film P>

The surface of the patterned optically-anisotropic layer P of the optical film P produced in the above and the surface of TD80UL of the polarizing plate A were bonded to each other via an adhesion agent, thereby producing a polarizing plate P with optical film P. In this, the films were combined so that the slow axis of the patterned optically-anisotropic layer P was at an angle of ±45 degrees to the absorption axis of the polarizing film.

### <Production of 3D Display Device P>

A 3D display device P was produced in the same manner as the 3D display device H except that the polarizing plate P with optical film P was used in place of the polarizing plate A with optical film H. The direction of the absorption axis of the polarizing film is the same as in FIG. 3.

### Comparative Example 4

### Formation of Un-patterned Optically-Anisotropic Layer Q

A commercially-available norbornene-base polymer film, “ZEONOR ZF14” (manufactured by OPTES INC.), was subjected to a free-end-uniaxial stretching treatment at 156 degrees Celsius at a stretching ratio of 43%, to give an un-patterned optically anisotropic layer Q. And Re(550) and Rth(550) of the un-patterned optically anisotropic layer Q were 125 nm and 66 nm respectively.

<Production of Polarizing Plate Q with Un-patterned Optically-Anisotropic Layer Q>

A polarizing plate Q with un-patterned optically-anisotropic layer Q was produced in the same manner as the polarizing plate with un-patterned optically-anisotropic layer O except that the un-patterned optically-anisotropic layer Q was used in place of the un-patterned optically-anisotropic layer O. The slow axis of the un-patterned optically-anisotropic layer Q was along the direction at 45° with respect to the absorption axis of the polarizing film.

### <Production of 3D Display Device Q>

A 3D display device Q was produced in the same manner as the 3D display device O except that the polarizing plate Q with optical film Q was used in place of the polarizing plate O with optical film O.

Table 1 collectively shows the physical data of the patterned optically-anisotropic layers in Examples 1 to 13 (according to Example 13, the optically-anisotropic layer has a lamination of the un-patterned optically-anisotropic layer of the vertical alignment of the discotic liquid crystal E-4 and the patterned optically-anisotropic layer of the horizontal alignment of the rod-like liquid crystal LC242; and in the following table, the data of the patterned optically anisotropic layer of the horizontal alignment of the rod-like liquid crystal LC242 are shown) and Comparative Examples 1 to 4; and Table 2 collectively shows the retardation data of the members arranged on the viewing side than the polarizing film.

TABLE 1

| | | | | Alignment Layer | | Air-Side Interface | |
|---|---|---|---|---|---|---|---|
| | | | | Aligning Agent | | Aligning Agent | |
| | Liquid | | Photo-acid- | | amount added | | amount added |
| | Crystal | Alignment layer | generating agent | material | (% by mass) | material | (% by mass) |
| Example 1 | E-1 | PVA103 | S-2 | II-1 | 3.0 | P-1 | 0.4 |
| Example 2 | E-1 | PVA103 | I-33 | II-1 | 3.0 | P-1 | 0.4 |
| Example 3 | E-2 | PVA103 | S-2 | II-1 | 3.0 | P-2 | 0.4 |
| Example 8 | E-4 | PVA103 | none | II-1 | 1.0 | P-1 | 0.3 |
| Comparative | LC242 | E-1 | none | none | none | none | none |
| Example 1 | | | | | | | |
| Example 4 | E-2 | PVA103 | none | II-1 | 1.0 | P-2 | 0.4 |
| Example 5 | E-3 | PVA103 | none | II-1 | 1.0 | P-1 | 0.3 |
| Example 6 | E-2 | PVA103 | none | II-1 | 1.0 | P-2 | 0.4 |
| | | polyacrylic acid | | | | | |
| Example 7 | E-4 | PVA103 | none | II-1 | 1.0 | P-1 | 0.3 |
| Comparative | LC242 | E-1 | none | none | none | none | none |
| Example 2 | | | | | | | |
| Example 9 | E-1 | PVA103 | I-33 | II-1 | 3.0 | P-1 | 0.4 |
| Example 10 | E-1 | PVA103 | S-2 | II-1 | 3.0 | P-1 | 0.4 |
| Example 11 | E-1 | PVA103 | I-33 | II-1 | 3.0 | P-1 | 0.4 |
| Example 12 | E-1 | PVA103 | S-2 | II-1 | 3.0 | P-1 | 0.4 |
| Comparative | LC242 | E-1 | none | none | none | none | none |
| Example 3 | | | | | | | |
| Example 13 | LC242 | E-1 | none | none | none | none | none |
| Comparative | LC242 | E-1 | none | none | none | none | none |
| Example 4 | | | | | | | |

| | | | | | | Optical Characteristics | |
|---|---|---|---|---|---|---|---|
| | | | Direction of | | | of Optically- | |
| | Patterning | | Slow Axis | Tilt Angle | | Anisotropic Layer | |
| | heating | | (relative | alignment | air-side | Re | Rth |
| | ° C. | photoexposure | to stripe) | layer side | interface | (nm) | (nm) |
| Example 1 | — | yes | +45° | vertical | vertical | 130 | −65 |
| | | no | −45° | vertical | vertical | 130 | −65 |
| Example 2 | — | yes | +45° | vertical | vertical | 130 | −65 |
| | | no | −45° | vertical | vertical | 130 | −65 |
| Example 3 | — | yes | +45° | vertical | vertical | 130 | −65 |
| | | no | −45° | vertical | vertical | 130 | −65 |
| Example 8 | 80° C. | — | +45° | vertical | vertical | 275 | −137 |
| | 140° C. | | — | — | — | 0 | 0 |
| Comparative | — | FIG. 10a | −45° | horizontal | horizontal | 130 | 65 |
| Example 1 | | FIG. 10b | +45° | horizontal | horizontal | 130 | 65 |
| Example 4 | 80° C. | — | +90° | vertical | vertical | 130 | −65 |
| | 140° C. | | 0° | vertical | vertical | 130 | −65 |
| Example 5 | 80° C. | — | +90° | vertical | vertical | 130 | −65 |
| | 140° C. | | 0° | vertical | vertical | 130 | −65 |
| Example 6 | 110° C. | — | 0° | vertical | vertical | 130 | −65 |
| | 110° C. | | +90° | vertical | vertical | 130 | −65 |
| Example 7 | 80° C. | — | 0° | vertical | vertical | 275 | −137 |
| | 140° C. | | — | — | — | 0 | 0 |
| Comparative | — | FIG. 10a | −45° | horizontal | horizontal | 130 | 65 |
| Example 2 | | FIG. 10b | +45° | horizontal | horizontal | 130 | 65 |
| Example 9 | — | yes | +45° | vertical | vertical | 130 | −65 |
| | | no | −45° | vertical | vertical | 130 | −65 |
| Example 10 | — | yes | +45° | vertical | vertical | 130 | −65 |
| | | no | −45° | vertical | vertical | 130 | −65 |
| Example 11 | — | yes | +45° | vertical | vertical | 130 | −65 |
| | | no | −45° | vertical | vertical | 130 | −65 |
| Example 12 | — | yes | +45° | vertical | vertical | 130 | −65 |
| | | no | −45° | vertical | vertical | 130 | −65 |
| Comparative | — | FIG. 10a | −45° | horizontal | horizontal | 130 | 65 |
| Example 3 | | FIG. 10b | +45° | horizontal | horizontal | 130 | 65 |
| Example 13 | — | — | — | — | — | 0 | 0 |
| | | — | +45° | horizontal | horizontal | 250 | 125 |
| Comparative | — | — | — | — | — | 0 | 0 |
| Example 4 | | FIG. 10b | +45° | horizontal | horizontal | 250 | 125 |

TABLE 2

| | Re(nm) | | | | | |
|---|---|---|---|---|---|---|
| | | Transparent | Patterned Optically- | Surface Film | | Rth(nm) |
| | Protective Film | Support | Anisotropic Layer | Support | Total | Protective Film |
| Example 1 | 2 | 0 | 130/130 | 2 | 130/130 | 40 |
| Example 2 | 2 | 2 | 130/130 | — | 130/130 | 40 |
| Example 3 | — | 8 | 130/130 | 2 | 131/131 | — |
| Example 8 | — | 138 | 275/0 | 2 | 413/138 | — |
| Example 9 | 2 | 2 | 130/130 | — | 130/130 | 40 |
| Example 10 | — | 0 | 130/130 | 2 | 130/130 | — |
| Example 11 | 2 | 2 | 130/130 | — | 130/130 | 40 |
| Example 12 | 2 | 2 | 130/130 | 2 | 130/130 | 40 |
| Comparative | 2 | 0 | 130/130 | — | 130/130 | — |
| Example 1 | | | | | | |
| Example 4 | 2 | 2 | 130/130 | — | 130/130 | 40 |
| Example 5 | 2 | 2 | 130/130 | — | 130/130 | 40 |
| Example 6 | — | 2 | 130/130 | — | 130/130 | — |
| Example 7 | — | 138 | 275/0 | 2 | 413/138 | — |
| Comparative | 2 | 2 | 130/130 | 2 | 130/130 | 40 |
| Example 2 | | | | | | |
| Comparative | 2 | 2 | 130/130 | 2 | 130/130 | 40 |
| Example 3 | | | | | | |

| | Rth(nm) | | | | | |
|---|---|---|---|---|---|---|
| | Transparent | Patterned Optically- | Surface Film | | | |
| | Support | Anisotropic Layer | Support | Total 1 | Total 2 | Mode |
| Example 1 | 12.3 | −65/−65 | 40 | 27.3/27.3 | −25/−25 | VA |
| Example 2 | 40 | −65/−65 | — | 15/15 | −25/−25 | VA |
| Example 3 | 78 | −65/−65 | 40 | 53/53 | −25/−25 | VA |
| Example 8 | 69 | −137/0 | 40 | −28/109 | −97/40 | VA |
| Example 9 | 40 | −65/−65 | — | 15/15 | −65/−65 | VA |
| Example 10 | 12.3 | −65/−65 | 40 | −12.7/−12.7 | −25/−25 | VA |
| Example 11 | 40 | −65/−65 | — | 15/15 | −25/−25 | VA |
| Example 12 | 8 | −65/−65 | 40 | 23/23 | −25/−25 | VA |
| Comparative | 12.3 | +65/+65 | — | 77.3/77.3 | 77.3/77.3 | VA |
| Example 1 | | | | | | |
| Example 4 | 40 | −65/−65 | — | 15/15 | −25/−25 | TN |
| Example 5 | 40 | −65/−65 | — | 15/15 | −25/−25 | TN |
| Example 6 | 40 | −65/−65 | — | −25/−25 | −25/−25 | TN |
| Example 7 | 69 | −137/0 | 40 | −28/109 | −97/40 | TN |
| Comparative | 40 | +65/+65 | 40 | 185/185 | 105/105 | TN |
| Example 2 | | | | | | |
| Comparative | 40 | +65/+65 | — | 145/145 | 105/105 | VA |
| Example 3 | | | | | | |

| | Re(nm) | | | | | Rth(nm) |
|---|---|---|---|---|---|---|
| | Protective Film | | | | | Protective Film |
| | Un-patterned | | | | | Un-Patterned |
| | Optically- | Transparent | Patterned Optically- | Transparent | | Optically- |
| | Anisotropic Layer | Support | Anisotropic Layer | Support | Total | Anisotropic Layer |
| Example 13 | 125 | 2 | 250/0 | — | 125/125 | −63 |
| Comparative | 125 | — | 250/0 | — | 125/125 | 66 |
| Example 4 | | | | | | |

| | Rth(nm) | | | | | |
|---|---|---|---|---|---|---|
| | Protective Film | | | | | |
| | Transparent | Patterned Optically- | Transparent | | | |
| | Support | anisotropic Layer | Support | Total 1 | Total 2 | Mode |
| Example 13 | 40 | 125/0 | — | 102/−23 | 102/−23 | VA |
| Comparative | — | 125/0 | — | 191/66 | 191/66 | VA |
| Example 4 | | | | | | |

* The columns of “patterned optically-anisotropic layer”, “total”, “total 1” and “total 2” each show “first retardation domain/second retardation domain”.
** “Total” shows Re obtained by measuring Re of all the members as a whole at the same time disposed at the visual side than the polarizing film; “Total 1” shows Rth obtained by measuring Rth of all the members as a whole at the same time disposed at the visual side than the polarizing film; “total 2” shows Rth obtained by measuring Rth of the optically-anisotropic layer and all the members as a whole at the same time disposed at the visual side than the optically-anisotropic layer.

### Evaluation

### Evaluation of 3D Display Device

For each of the VA-mode liquid crystal display devices, using 3D glasses attached to “GD-463D10” (product of JVC), the produced 3D display devices were evaluated as follows; and for each of the TN-mode liquid crystal display device, using 3D glasses attached to “W220S” (product of Hyundai), the produced 3D display devices were evaluated as follows. The evaluation was performed through both of the left-eye and the right-eye of the 3D glasses, and on the basis of the averaged value, the evaluation was carried out. The 3D display device P of Comparative Example 3 is the standard configuration (control) of VA-mode liquid-crystal display devices (Examples 1-3 and 8-12); the 3D display device Q of Comparative Example 4 is the standard configuration (control) of Example 13; and the 3D display device I of Comparative Example 2 is the standard configuration (control) of TN-mode liquid-crystal display devices. The results are shown in Table 3.

### (1) Measurement of Front Brightness Ratio and Front Mean Brightness Ratio:

3D glasses and an indicator (BM-5A, by Topcon) were disposed at the front of the liquid-crystal display device that displays a stripe image of white and black stripes alternately aligned in the vertical direction, and the indicator was set on the side of the glass through which the white stripes could be visualized, and the front brightness A in the white state was measured. Subsequently, a stripe image in which the white and black stripes were reversed was displayed, and similarly, the indicator was set on the side of the glass through which the white stripes could be visualized, and the front brightness B was measured. The mean value of the front brightness A and the front brightness B is the front brightness of the 3D display device.

### (1-a) Front Brightness Ratio:

The front brightness ratio is a relative value of the front brightness in a case where the 3D glasses are parallel to the ground surface, and is computed according to the following formula.

Front Brightness Ratio of 3D Display Device (%)=front brightness of 3D display device/front brightness of the standard configuration

### (1-b) Front Mean Brightness Ratio:

The front mean brightness ratio is a relative value of the front brightness mean value in a case where the 3D glasses are rotated, and is computed according to the following formula.

Front Mean Brightness Ratio of 3D Display Device (%)=front brightness mean value of 3D display device/front brightness mean value of the standard configuration

### (2) Measurement of Viewing Angle Brightness Ratio and Viewing Angle Mean Brightness Ratio:

3D glasses and an indicator (BM-5A, by Topcon) were dispose at an azimuth angle of 0 degree and at a polar angle of 60 degrees to the liquid-crystal display device that displays a stripe image of white and black stripes alternately aligned in the vertical direction, and the indicator was set on the side of the glass through which the white stripes could be visualized, and the viewing angle brightness C in the white state was measured. Subsequently, a stripe image in which the white and black stripes were reversed was displayed, and similarly, the indicator was set on the side of the glass through which the white stripes could be visualized, and the viewing angle brightness D was measured. Further, the 3D glasses and the indicator were set at an azimuth angle of 180 degrees and at a polar angle of 60 degrees to the liquid-crystal display device, and the viewing angle brightness E and the viewing angle brightness F were measured also in the same manner as above. The mean value of the viewing angle brightness data C to F is the viewing angle brightness of the 3D display device.

### (2-a) Viewing Angle Brightness Ratio:

The viewing angle brightness ratio is a relative value of the viewing angle brightness in a case where the 3D glasses are parallel to the ground surface, and is computed according to the following formula.

Viewing Angle Brightness Ratio of 3D Display Device (%)=viewing angle brightness of 3D display device/viewing angle brightness of the standard configuration control

### (2-b) Viewing Angle Mean Brightness Ratio:

The viewing angle mean brightness ratio is a relative value of the viewing angle brightness mean value in a case where the 3D glasses are rotated, and is computed according to the following formula.

Viewing Angle Mean Brightness Ratio of 3D Display Device (%)=viewing angle brightness mean value of 3D display device/viewing angle brightness mean value of the standard configuration

### (3) Lightfastness:

Using a lightfastness tester (Superxenon Weather Meter SX120 Model (long-life xenon lamp), by Suga Test Instruments), the display device was tested at a radiation dose of 100±25 W/m2 (wavelength, 310 nm to 400 nm), at a temperature in chamber of 35±5 degrees Celsius, at a black panel temperature of 50±5 degrees Celsius, and at a relative humidity of 65±15%, according to JIS K 5600-7-5 for a lightfastness test time of 25 hours. Before and after the test, the change in the polarization of the polarizer was checked. Tested devices of which the change ratio is within 10% are good; but those of which the change ratio is more than it are not good.

TABLE 3

| | | Front | Viewing | Viewing | |
|---|---|---|---|---|---|
| | Front | Mean | Angle | Angle Mean | |
| | Brightness | Brightness | Brightness | Brightness | Light- |
| | Ratio | Ratio | Ratio | Ratio | fastness |
| Example 1 | 100 | 100 | 107 | 108 | good |
| Example 2 | 100 | 100 | 107 | 108 | good |
| Example 3 | 100 | 100 | 107 | 108 | good |
| Example 8 | 100 | 100 | 107 | 108 | good |
| Comparative | 100 | 100 | 102 | 102 | not |
| Example 1 | | | | | good |
| Example 4 | 100 | 100 | 124 | 127 | good |
| Example 5 | 100 | 100 | 124 | 127 | good |
| Example 6 | 100 | 100 | 125 | 128 | good |
| Example 7 | 100 | 100 | 119 | 121 | good |
| Comparative | 100 | 100 | 100 | 100 | good |
| Example 2 | | | | | |
| Example 9 | 100 | 100 | 107 | 108 | good |
| Example 10 | 100 | 100 | 107 | 108 | good |
| Example 11 | 100 | 100 | 107 | 108 | good |
| Example 12 | 100 | 100 | 107 | 108 | good |
| Comparative | 100 | 100 | 100 | 100 | good |
| Example3 | | | | | |
| Example 13 | 100 | 100 | 105 | 105 | good |
| Comparative | 100 | 100 | 100 | 100 | good |
| Example 4 | | | | | |

From the data shown in above Tables, it is understandable that the total of Rth in Comparative Example 1, Comparative Example 3 and Comparative Example 2 using a rod-shaped liquid crystal (especially Comparative Example 2) is large and the viewing angle brightness reduction is larger than in Examples. And the devices having larger brightness ratio are more excellent in 3D-visibility quality with smaller cross-talk between the left and right directions.

In addition, it is also understandable that the 3D display devices of Examples 1 to 13 and Comparative Examples 2 to 4 in which UV absorbent-containing TD80UL is disposed on the visual side than the polarizing film have good lightfastness of the polarizing film, but according to Comparative Example 1, the lightfastness, in which the transparent support A does not contain UV absorbent, is not good. Accordingly, it is understandable that, since Rth of the rod-shaped liquid crystal is large, the device using the rod-shaped liquid crystal could hardly satisfy both display performance and lightfastness.

1. An optical film for 3D image display devices, comprising:
at least an optically-anisotropic layer formed of a composition that comprises, as the main ingredient thereof, a discotic liquid crystal having at least one polymerizable group, wherein:
the optically-anisotropic layer is a patterned optically-anisotropic layer which comprises a first retardation domain and a second retardation domain differing from each other in at least one of the in-plane slow axis direction and retardation in-plane thereof and in which the first and second retardation domains are alternately arranged in plane, and the total value of retardation in-plane at a wavelength of 550 nm, Re(550), of all of the members including the optically-anisotropic layer disposed on one face of the polarizing film is from 110 to 160 nm.

2. The optical film according to claim 1, wherein the discotic liquid crystal is fixed in a vertically aligned state.

3. The optical film according to claim 1, further comprising a polarizing film, wherein the in-plane axes of the first and second retardation domains and the absorption axis of the polarizing film are at an angle of ±45° respectively.

4. The optical film according to claim 3, wherein the total value of retardation along the thickness direction at a wavelength of 550 nm, Rth(550), of all of the members including the optically-anisotropic layer disposed on one face of the polarizing film is from −140 to 140 nm.

5. The optical film according to claim 3, wherein the total value of retardation along the thickness direction Rth(550) at a wavelength of 550 nm of the optically-anisotropic layer and all the members disposed on the surface of the optically-anisotropic layer opposite to the surface on which the polarizing film is disposed is from −104 to 104 nm.

6. The optical film according to claim 1, comprising a transparent support containing an UV absorbent on one surface of the optically-anisotropic layer.

7. The optical film according to claim 1, further comprising a hard coat layer.

8. The optical film according to claim 7, wherein the hard coat layer comprises a UV absorbent.

9. The optical film according to claim 1, further comprising an antireflection layer.

10. The optical film according to claim 1, further comprising an antiglare layer.

11. A 3D image display device comprising at least:
a display panel to be driven on the basis of an image signal, and
an optical film of claim 1 to disposed on the viewing side of the display panel.

12. The 3D image display device according to claim 11, wherein the display panel comprises a liquid-crystal cell.

13. The 3D image display device according to claim 12, wherein the optical film is an optical film for 3D image display devices, comprising:
at least an optionally-anisotropic layer formed of a composition that comprises, as the main ingredient thereof, a discotic liquid crystal having at least one polymerizable group, wherein:
the optically-anisotropic layer is a patterned optically-anisotropic layer which comprises a first retardation domain and a second retardation domain differing from each other in at least one of the in-plane slow axis direction and retardation in-plane thereof and in which the first and second retardation domains are alternately arranged in plane, and the total value of retardation in-plane at a wavelength of 550 nm, Re(550), of all of the members including the optically-anisotropic layer disposed on one face of the polarizing film is from 110 to 160 nm, and
a polarizing film, wherein the in-plane axes of the first and second retardation domains and the absorption axis of the polarizing film are at an angle of ±45° respectively
wherein the total value of retardation along the thickness direction Rth(550) at a wavelength of 550 nm of the optically-anisotropic layer and all the members disposed on the surface of the optically-anisotropic layer opposite to the surface on which the polarizing film is disposed is from −104 to 104 nm, and
wherein the liquid-crystal cell is a TN-mode cell.

14. The 3D image display device according to claim 12, wherein the optical film is an optical film for 3D image display devices, comprising:
at least an optically-anisotropic layer formed of a composition that comprises, as the main ingredient thereof, a discotic liquid crystal having at least one polymerizable group, wherein:
the optically-anisotropic layer is a patterned optically-anisotropic layer which comprises a first retardation domain and a second retardation domain differing from each other in at least one of the in-plane slow axis direction and retardation in-plane thereof and in which the first and second retardation domains are alternately arranged in plane, and the total value of retardation in-plane at a wavelength of 550 nm, Re(550), of all of the members including the optically-anisotropic layer disposed on one face of the polarizing film is from 110 to 160 nm, and
a transparent support containing an UV absorbent on one surface of the optically-anisotropic layer, and
wherein the liquid-crystal cell is a VA-mode or IPS-mode cell.

15. A 3D image display system comprises at least:
a 3D image display device of claim 11, and
a polarizer disposed on the viewing side of the 3D image display device, which visualizes a 3D image through the polarizer.
